(19) United States
(12) Patent Application Publication
(10) Pub. No.: US 2014/0207723 A1
(43) Pub. Date: Jul. 24, 2014

(54) Method and Apparatus for Predicting Joint Quantum States of Subjects modulo an Underlying Proposition based on a Quantum Representation

(71) Applicant: INVENT.LY LLC, Woodside, CA (US)

(72) Inventors: Marek Alboszta, Montara, CA (US); Stephen J. Brown, Woodside, CA (US)

(73) Assignee: INVENT.LY LLC, Woodside, CA (US)

(21) Appl. No.: 14/224,041

(22) Filed: Mar. 24, 2014

(51) Int. Cl. G06N 5/04; G06N 99/00

(52) U.S. Cl. CPC G06N 5/04; G06N 99/002
USPC 706/46

(57) ABSTRACT

The present invention presents methods and apparatus for predicting a joint quantum state of subjects, such as human beings, modulo an underlying proposition that revolves about an object, a subject or an experience while deploying a quantum representation of the situation. The joint quantum state is built from a transmit subject qubit |Tx [symbol] assigned to a transmitting subject that broadcasts a measurable indication and also a receive subject qubit |Rx [symbol] that is assigned to a receiving subject that is capable of receiving the measurable indication. The subjects share a common internal space represented by a Hilbert space [symbol] ^{(TR)}. The joint quantum states admit of representation by symmetric and anti-symmetric wave functions depending on the quantum statistics (Bose-Einstein or Fermi-Dirac) corresponding to consensus and anti-consensus forming types exhibited by the qubits when considered modulo the proposition.

### RELATED APPLICATIONS

This application is related to U.S. patent application Ser. No. 14/128,821 entitled “Method and Apparatus for Predicting Subject Responses to a Proposition based on a Quantum Representation of the Subject's Internal State and of the Proposition”, filed on Feb. 17, 2014 and incorporated herein by reference in its entirety.

### FIELD OF THE INVENTION

The present invention relates to a method and an apparatus for predicting the possible joint quantum states of subjects, such as two human beings that share a common internal space, with respect to an underlying proposition presenting in a certain context. The model adopts a quantum mechanical representation of the subjects and of the proposition while admitting assignment of subjects to entities called quantum bits (qubits) based on quantum states that exhibit Fermi-Dirac (F-D) statistics, termed anti-consensus statistic, or Bose-Einstein (B-E) statistics, termed consensus statistic modulo the underlying proposition.

### BACKGROUND OF THE INVENTION

### 1. Preliminary Overview

The insights into the workings of nature at micro-scale were captured by quantum mechanics over a century ago. These new realizations have since precipitated fundamental revisions to our picture of reality. A particularly difficult to accept change involves the inherently statistical aspects of quantum theory. Many preceding centuries of progress rooted in logical and positivist extensions of the ideas of materialism had certainly biased the human mind against the implications of the new theory. After all, it is difficult to relinquish strong notions about the existence of as-yet-undiscovered and more fundamental fully predictive description(s) of microscopic phenomena in favor of quantum's intrinsically statistical model for the emergence of measurable quantities.

Perhaps unsurprisingly, the empirically driven transition from classical to quantum thinking has provoked strong reactions among numerous groups. Many have spent considerable effort in unsuccessful attempts to attribute the statistical nature of quantum mechanics to its incompleteness. Others still attempt to interpret or reconcile it with entrenched classical intuitions rooted in Newtonian physics. However, the deep desire to contextualize quantum mechanics within a larger and more “intuitive” or even quasi-classical framework has resulted in few works of practical significance.

Meanwhile, quantum mechanics, given its exceptional agreement with fact and its explanatory power, has managed to defy all struggles at a classical reinterpretation. Today, quantum mechanics and the consequent quantum theory of fields (its extension and partial integration with relativity theory) have proven to be humanity's best fundamental theories of nature. Sub-atomic, atomic and many molecular phenomena are now studied based on quantum or at least quasi-quantum models of reality.

In a radical departure from classical assumption of perpetually existing and measurable quantities, quantum representation of reality posits new entities called wavefunctions or state vectors. These unobservable components of the new model of reality are prior to the emergence of measured quantities or facts. More precisely, state vectors are related to distributions of probabilities for observing any one of a range of possible experimental results. A telltale sign of the “non-physical” status of a state vector is captured in the language of mathematics, where typical state vectors are expressed as imaginary-valued objects. Further, the space spanned by such state vectors is not classical (i.e., it is not our familiar Euclidean space or even any classical configuration space such as phase space). Instead, state vectors inhabit a Hilbert space of square-integrable functions.

Given that state vectors represent complex probability amplitudes, it may appear surprising that their behavior is rather easily reconciled with previously developed physics formalisms. Indeed, after some revisions the tools of Lagrangian and Hamiltonian mechanics as well as many long-standing physical principles, such as the Principle of Least Action, are found to apply directly to state vectors and their evolution. The stark difference, of course, is that state vectors themselves represent relative propensities for observing certain measurable values associated with the objects of study, rather than these measurable quantities themselves. In other words, whereas the classical formulations, including Hamiltonian or Lagrangian mechanics, were originally devised to describe the evolution of “real” entities, their quantum mechanical equivalents apply to the evolution of probability amplitudes. Apart from that jarring fact, when left unobserved the state vectors prove to be rather well-behaved. Indeed, their continuous and unitary evolution in Hilbert space is not entirely unlike propagation of real waves in plain Euclidean space. Thus, some of our intuitions about classical wave mechanics are useful in grasping the behavior of quantum waves.

Of course, our intuitive notions about wave mechanics ultimately break down because quantum waves are not physical waves. This becomes especially clear when considering superpositions of two or more such complex-valued objects. In fact, considering such superpositions helps to bring out several unexpected aspects of quantum mechanics.

For example, quantum wave interference predicts the emergence of probability interference patterns that lead to unexpected distributions of measureable entities in real space, even when dealing with well-known particles and their trajectories. This effect is probably best illustrated by the famous Young's double slit experiment. Here, the complex phase differences between quantum mechanical waves propagating from different space points, namely the two slits where the particle wave was forced to bifurcate, manifest in a measurable effect on the path followed by the physical particle. Specifically, the particle is predicted to exhibit a type of self-interference that prevents it from reaching certain places that lie manifestly along classically computed particle trajectories. These quantum effects are confirmed by fact.

Although surprising, wave superpositions and interference patterns are ultimately not the novel aspects that challenged human intuition most. Far more mysterious is the nature of measurement during which a real value of an observable attribute of an element of reality is actually observed.

While the underlying model of pre-emerged reality constructed of quantum waves governed by differential wave equations (e.g., the Schroedinger equation) and boundary conditions may be at least partly intuitive, measurement itself defies attempts at non-probabilistic description. According to quantum theory, the act of measurement forces the full state vector or wave packet of all possibilities to “collapse” or choose just one of the possibilities. In other words, measurement forces the normally compound wave function (i.e., a superposition of possible wave solutions to the governing differential equation) to transition discontinuously and manifest as just one of its constituents. Still differently put, measurement reduces the wave packet and selects only one component wave from the full packet that represents the superposition of all component waves contained in the state vector.

In order to properly evaluate the state of the prior art and to contextualize the contributions of the present invention, it will be necessary to review a number of important concepts from quantum mechanics, quantum information theory (e.g., the quantum version of bits also called “qubits” by skilled artisans) and several related fields. For the sake of brevity, only the most pertinent issues will be presented herein. For a more thorough review of quantum information theory the reader is referred to course materials for John P. Preskill, “Quantum Information and Computation”, Lecture Notes Ph219/CS219, Chapters 2&3, California Institute of Technology, 2013 and references cited therein. Excellent reviews of the fundamentals of quantum mechanics are found in standard textbooks starting with P.A.M. Dirac, “The Principles of Quantum Mechanics”, Oxford University Press, 4^{th} Edition, 1958; L. D. Landau and E.M. Lifshitz, “Quantum Mechanics (Non-relativistic Theory)”, Institute of Physical Problems, USSR Academy of Sciences, Butterworth Heinemann, 3^{rd} Edition, 1962; Cohen-Tannoudji et al., “Quantum Mechanics”, John Wiley & Sons, 1977, and many others including the more in-depth and modern treatments such as J. J. Sakurai, “Modern Quantum Mechanics”, Addison-Wesley, 2011.

### 2. A Brief Review of Quantum Mechanics Fundamentals

In most practical applications of quantum models, the process of measurement is succinctly and elegantly described in the language of linear algebra or matrix mechanics (frequently referred to as the Heisenberg picture). Since all those skilled in the art are familiar with linear algebra, many of its fundamental theorems and corollaries will not be reviewed herein. In the language of linear algebra, a quantum wave ψ is represented in a suitable eigenvector basis by a state vector |ψ [symbol] . To provide a more rigorous definition, we will take advantage of the formal bra-ket notation used in the art.

In keeping with Dirac's bra-ket convention, a column vector α is written as |α [symbol] and its corresponding row vector (dual vector) is written as [symbol] α|. Additionally, because of the complex-valuedness of quantum state vectors, flipping any bra vector to its dual ket vector and vice versa implicitly includes the step of complex conjugation. After initial introduction, most textbooks do not expressly call out this step (i.e., [symbol] α| is really [symbol] α*| where the asterisk denotes complex conjugation). The reader is cautioned that many simple errors can be avoided by recalling this fundamental rule of complex conjugation.

We now recall that a measure of norm or the dot product (which is related to a measure of length and is a scalar quantity) for a standard vector \vec{x} is normally represented as a multiplication of its row vector form by its column vector form as follows: d=\vec{x}^{T}\vec{x}. This way of determining norm carries over to the bra-ket formulation. In fact, the norm of any state vector carries a special significance in quantum mechanics.

Expressed by the bra-ket [symbol] α|α [symbol] , we note that this formulation of the norm is always positive definite and real-valued for any non-zero state vector. That condition is assured by the step of complex conjugation when switching between bra and ket vectors. Now, state vectors describe probability amplitudes while their norms correspond to probabilities. The latter are real-valued and by convention mapped to a range between 0 and 1 (with 1 representing a probability of 1 or 100% certainty). Correspondingly, all state vectors are typically normalized such that their inner product (a generalization of the dot product) is equal to one, or simply put: [symbol] α|α [symbol] = [symbol] β|β [symbol] = . . . =1. This normalization enforces conservation of probability on objects composed of quantum mechanical state vectors.

Using the above notation, we can represent any state vector |ψ [symbol] in its ket form as a sum of basis ket vectors |εⱼ [symbol] that span the Hilbert space [symbol] of state vector |ψ [symbol] . In this expansion, the basis ket vectors |εⱼ [symbol] are multiplied by their correspondent complex coefficients cⱼ. In other words, state vector |ψ [symbol] decomposes into a linear combination as follows:

|ψ [symbol] =Σⱼ₌₁ⁿcⱼ|εⱼ [symbol] Eq. 1

where n is the number of vectors in the chosen basis. This type of decomposition of state vector |ψ [symbol] is sometimes referred to as its spectral decomposition by those skilled in the art.

Of course, any given state vector |ψ [symbol] can be composed from a linear combination of vectors in different bases thus yielding different spectra. However, the normalization of state vector |ψ [symbol] is equal to one irrespective of its spectral decomposition. In other words, bra-ket [symbol] ψ|ψ [symbol] =1 in any basis. From this condition we learn that the complex coefficients cⱼ of any expansion have to satisfy:

pₜₒₜ=1=Σⱼ₌₁ⁿcⱼ*cⱼ Eq. 2

where pₜₒₜ is the total probability. This ensures the conservation of probability, as already mentioned above. Furthermore, it indicates that the probability pⱼ associated with any given eigenvector |εⱼ [symbol] in the decomposition of |ψ [symbol] is the norm of the complex coefficient cⱼ, or simply put:

pⱼ=cⱼ*cⱼ Eq. 3

In view of the above, it is not surprising that undisturbed evolution of any state vector |ψ [symbol] in time is found to be unitary or norm preserving. In other words, the evolution is such that the norms cⱼ*cⱼ do not change with time.

To better understand the last point, we use the polar representation of complex numbers by their modulus r and phase angle θ. Thus, we rewrite complex coefficient cⱼ as:

cⱼ=rⱼe^{iθ}^{ⱼ} Eq. 4a

where i=\sqrt{−1} (we use i rather than j for the imaginary number). In this form, complex conjugate of complex coefficient cⱼ* is just:

cⱼ*=rⱼe^{-iθ}^{ⱼ} Eq. 4b

and the norm becomes:

cⱼ*cⱼ=rⱼe^{-θ}^{ⱼ}rⱼe^{iθ}^{ⱼ}=rⱼ² Eq. 4c

The step of complex conjugation thus makes the complex phase angle drop out of the product (since e^{-iθ}e^{iθ}=e^{i(θ-θ)}=e⁰=1). This means that the complex phase of coefficient cⱼ does not have any measurable effects on the real-valued probability p₁ associated with the corresponding eigenvector |εⱼ [symbol] . Note, however, that relative phases between different components of the decomposition will introduce measurable effects (e.g., when measuring in a different basis).

In view of the above insight about complex phases, it is perhaps unsurprising that temporal evolution of state vector |ψ [symbol] corresponds to the evolution of phase angles of complex coefficients cⱼ in its spectral decomposition (see Eq. 1). In other words, evolution of state vector |ψ [symbol] in time is associated with a time-dependence of angles θⱼ of each complex coefficient cⱼ. The complex phase thus exhibits a time dependence e^{iθ}^{ⱼ}=e^{iω}^{ⱼ}^{t}, where the j-th angular frequency ωⱼ is associated with the j-th eigenvector |εⱼ [symbol] and t stands for time. For completeness, it should be pointed out that ωⱼ is related to the energy level of the correspondent eigenvector |εⱼ [symbol] by the famous Planck relation:

Eⱼ=ωⱼ, Eq. 5

where stands for the reduced Planck's constant h, namely:

$$ℏ = \frac{h}{2 π} .$$

Correspondingly, evolution of state vector |ψ [symbol] is encoded in a unitary matrix U that acts on state vector |ψ [symbol] in such a way that it only affects the complex phases of the eigenvectors in its spectral decomposition. The unitary nature of evolution of state vectors ensures the fundamental conservation of probability.

In contrast to the unitary evolution of state vectors that affects the complex phases of all eigenvectors of the state vector's spectral decomposition, the act of measurement picks out just one of the eigenvectors. Differently put, the act of measurement is related to a projection of the full state vector |ψ [symbol] onto the subspace defined by just one of eigenvectors |εⱼ [symbol] in the vector's spectral decomposition (see Eq. 1). Based on the laws of quantum mechanics, the projection obeys the laws of probability. More precisely, each eigenvector |εⱼ [symbol] has the probability pⱼ dictated by the norm cⱼ*cⱼ (see Eq. 3) of being picked for the projection induced by the act of measurement. Besides the rules of probability, there are no hidden variables or any other constructs involved in predicting the projection. This situation is reminiscent of a probabilistic game such as a toss of a coin or the throw of a die. It is also the reason why Einstein felt uncomfortable with quantum mechanics and proclaimed that he did not believe that God would “play dice with the universe”.

No experiments to date have been able to validate Einstein's position by discovering hidden variables or other predictive mechanisms behind the choice. In fact, experiments based on the famous Bell inequality and many other investigations have confirmed that the above understanding encapsulated in the projection postulate of quantum mechanics is complete. Furthermore, once the projection occurs due to the act of measurement, the emergent element of reality that is observed, i.e., the measurable quantity, is the eigenvalue λⱼ associated with eigenvector |εⱼ [symbol] selected by the projection.

Projection is a linear operation represented by a projection matrix P that can be derived from knowledge of the basis vectors. The simplest state vectors decompose into just two distinct eigenvectors in any given basis. These vectors describe the spin states of spin ½ particles such as electrons and other spinors. The quantum states of twistors, such as photons, also decompose into just two eigenvectors. In the present case, we will refer to spinors for reasons of convenience.

It is customary to define the state space of a spinor by eigenvectors of spin along the z-axis. The first, |ε_{z+} [symbol] is aligned along the positive z-axis and the second, |ε_{z-} [symbol] is aligned along the negative z-axis. Thus, from standard rules of linear algebra, the projection along the positive z-axis (z+) can be obtained from constructing the projection matrix or, in the language of quantum mechanics the projection operator P_{z+} from the z+ eigenvector |ε_{z+} [symbol] as follows:

$${P}_{z +} = \vert {ɛ}_{z +} 〉 〈 {ɛ}_{z +} \vert = {[ \begin{matrix}1 \\ 0\end{matrix} ] [ \begin{matrix}1 & 0\end{matrix} ]}^{*} = [ \begin{matrix}1 & 0 \\ 0 & 0\end{matrix} ] , \qquad Eq . 6$$

where the asterisk denotes complex conjugation, as above (no change here because vector components of |ε_{z+} [symbol] are not complex in this example). Note that in Dirac notation obtaining the projection operator is analogous to performing an outer product in standard linear algebra. There, for a vector \vec{x} we get the projection matrix onto it through the outer product, namely: Pₓ=\vec{x}\vec{x}^{T}.

### 3. A Brief Introduction to Qubits

We have just seen that the simplest quantum state vector |ψ [symbol] corresponds to a pre-emerged quantum entity that can yield one of two distinct observables under measurement. These measures are the two eigenvalues λ₁, λ₂ of the correspondent two eigenvectors |εₜ [symbol] , |ε₂ [symbol] in the chosen spectral decomposition. The relative occurrence of the eigenvalues will obey the probabilistic rule laid down by the projection postulate. In particular, eigenvalue λ₁ will be observed with probability p₁ (see Eq. 3) equal to the probability of projection onto eigenvector |ε₁ [symbol] . Eigenvalue λ₂ will be seen with probability p₂ equal to the probability of projection onto eigenvector |ε₂ [symbol] .

Because of the simplicity of the two-state quantum system represented by such two-state vector |ψ [symbol] , it has been selected in the field of quantum information theory and quantum computation as the fundamental unit of information. In analogy to the choice made in computer science, this system is commonly referred to as a qubit and so the two-state vector becomes the qubit: |qb [symbol] =|ψ [symbol] . Operations on one or more qubits are of great interest in the field of quantum information theory and its practical applications. Since the detailed description will rely extensively on qubits and their behavior, we will now introduce them with a certain amount of rigor.

From the above preliminary introduction it is perhaps not surprising to find that the simplest two-state qubit, just like a simple spinor or twistor on which it is based, can be conveniently described in 2-dimensional complex space called [symbol] ². The description finds a more intuitive translation to our 3-dimensional space, [symbol] ³, with the aid of the Bloch or Poincare Sphere. This concept is introduced by FIG. 1A, in which the Bloch Sphere 10 is shown centered on the origin of orthogonal coordinates indicated by axes X, Y, Z.

Before allowing oneself to formulate an intuitive view of qubits by looking at Bloch sphere 10, the reader is cautioned that the representation of qubits inhabiting [symbol] ² by mapping them to a ball in [symbol] ³ is a useful tool. The actual mapping is not one-to-one. Formally, the representation of spinors by the group of transformations defined by SO(3) (Special Orthogonal matrices in [symbol] ²) is double-covered by the group of transformations defined by SU(2) (Special Unitary matrices in [symbol] ²).

In the Bloch representation, a qubit 12 represented by a ray in [symbol] ² is spectrally decomposed into the two z-basis eigenvectors. These eigenvectors include the z-up or |+ [symbol] _{z} eigenvector, and the z-down or |− [symbol] _{z} eigenvector. The spectral decomposition theorem assures us that any state of qubit 12 can be decomposed in the z-basis as long as we use the appropriate complex coefficients. In other words, any state of qubit 12 in the z-basis can be described by:

|ψ [symbol] _{z}=|qb [symbol] _{z}=α|+ [symbol] _{z}+ε|− [symbol] _{z}, Eq. 7

where α and β are the corresponding complex coefficients. In quantum information theory, basis state |+ [symbol] _{z} is frequently mapped to logical “yes” or to the value “1”, while basis state |− [symbol] _{z} is frequently mapped to logical “no” or to the value “0”.

In FIG. 1A basis states |+ [symbol] _{z} and |− [symbol] _{z} are shown as vectors and are written out in full form for clarity of explanation. (It is worth remarking that although basis states |+ [symbol] _{z} and |− [symbol] _{z} are indeed orthogonal in [symbol] ², they fall on the same axis (Z axis) in the Bloch sphere representation in [symbol] ³. That is because the mapping is not one-to-one, as already mentioned above.) Further, in our chosen representation of qubit 12 in the z-basis, the X axis corresponds to the real axis and is thus also labeled by Re. Meanwhile, the Y axis corresponds to the imaginary axis and is additionally labeled by Im.

To appreciate why complex coefficients α and β contain sufficient information to encode qubit 12 pointed anywhere within Bloch sphere 10 we now refer to FIG. 1B. Here the complex plane 14 spanned by real and imaginary axes Re, Im that are orthogonal to the Z axis and thus orthogonal to eigenvectors |+ [symbol] _{z} and |− [symbol] _{z} of our chosen z-basis is hatched for better visualization. Note that eigenvectors for the x-basis |+ [symbol] ₓ, |− [symbol] ₓ as well as eigenvectors for the y-basis |+ [symbol] _{y}, |− [symbol] _{y} are in complex plane 14. Most importantly, note that each one of the alternative basis vectors in the two alternative basis choices we could have made finds a representation using the eigenvectors in the chosen z-basis. As shown in FIG. 1B, the following linear combinations of eigenvectors |+ [symbol] _{z}, and | [symbol] _{z} describe vectors |+ [symbol] ₓ, |− [symbol] ₓ and |+ [symbol] _{y}, |− [symbol] _{y}:

$$\begin{matrix}{\vert + 〉}_{x} = \frac{1}{\sqrt{2}} {\vert + 〉}_{z} + \frac{1}{\sqrt{2}} {\vert - 〉}_{z} , & Eq . 8 a \\ {\vert - 〉}_{x} = \frac{1}{\sqrt{2}} {\vert + 〉}_{z} - \frac{1}{\sqrt{2}} {\vert - 〉}_{z} , & Eq . 8 b \\ {\vert + 〉}_{y} = \frac{1}{\sqrt{2}} {\vert + 〉}_{z} + \frac{i}{\sqrt{2}} {\vert - 〉}_{z} , & Eq . 8 c \\ {\vert - 〉}_{y} = \frac{1}{\sqrt{2}} {\vert + 〉}_{z} - \frac{i}{\sqrt{2}} {\vert - 〉}_{z} . & Eq . 8 d\end{matrix}$$

Clearly, admission of complex coefficients α and β permits a complete description of qubit 12 anywhere within Bloch sphere 10 thus furnishing the desired map from [symbol] ² to [symbol] ² for this representation. The representation is compact and leads directly to the introduction of Pauli matrices.

FIG. 1C shows the three Pauli matrices σ₁, σ₂, σ₃ (sometimes also referred to as σₓ, σ_{y}, σ_{z}) that represent the matrices corresponding to three different measurements that can be performed on spinors. Specifically, Pauli matrix σ₁ corresponds to measurement of spin along the X axis (or the real axis Re). Pauli matrix σ₂ corresponds to measurement of spin along the Y axis (or the imaginary axis Im). Finally, Pauli matrix σ₃ corresponds to measurement of spin along the Z axis (which coincides with measurements in the z-basis that we have selected). The measurement of spin along any of these three orthogonal axes will force projection of qubit 12 to one of the eigenvectors of the corresponding Pauli matrix. Correspondingly, the measurable value will be the eigenvalue that is associated with the eigenvector.

To appreciate the possible outcomes of measurement we notice that all Pauli matrices σ₁, σ₂, σ₃ share the same two orthogonal eigenvectors, namely |ε₁ [symbol] =[1,0] and |ε₂ [symbol] =[0,1]. Further, Pauli matrices are Hermitian (an analogue of real-valued symmetric matrices) such that:

σₖ=σₖ^{t} Eq. 9

for k=1,2,3 (for all Pauli matrices). These properties ensure that the eigenvalues λ₁, λ₂, λ₃ of Pauli matrices are real and the same for each Pauli matrix. In particular, for spin particles such as electrons, the Pauli matrices are multiplied by a factor of /2 to obtain the corresponding spin angular momentum matrices Sₖ. Hence, the eigenvalues are shifted to

$${λ}_{1} = \frac{ℏ}{2}$$

$$and$$

$${λ}_{2} = - \frac{ℏ}{2}$$

(where is the reduced Planck's constant already defined above). Here we also notice that Pauli matrices σ₁, σ₂, σ₃ are constructed to apply to spinors, which change their sign under a 2π rotation and require a rotation by 4π to return to initial state (formally, an operator S is a spinor if S(θ+2π)=−S(θ)).

As previously pointed out, in quantum information theory and its applications the physical aspect of spinors becomes unimportant and thus the multiplying factor of /2 is dropped. Pauli matrices σ₁, σ₂, σ₃ are used in unmodified form with corresponded eigenvalues λ₁=1 and λ₂=−1 mapped to two opposite logical values, such as “yes” and “no”. For the sake of rigor and completeness, one should state that the Pauli marices are traceless, each of them squares to the Identity matrix I, their determinants are −1 and they are involutory. A more thorough introduction to their importance and properties can be found in the many foundational texts on Quantum Mechanics, including the above mentioned textbook by P.A.M. Dirac, “The Principles of Quantum Mechanics”, Oxford University Press, 4^{th} Edition, 1958 in the section on the spin of the electron.

Based on these preliminaries, the probabilistic aspect of quantum mechanics encoded in qubit 12 can be re-stated more precisely. In particular, we have already remarked that the probability of projecting onto an eigenvector of a measurement operator is proportional to the norm of the complex coefficient multiplying that eigenvector in the spectral decomposition of the full state vector. This rather abstract statement can now be recast as a complex linear algebra prescription for computing an expectation value [symbol] O [symbol] of an operator matrix O for a given quantum state |ψ [symbol] as follows:

[symbol]

O [symbol] _{ψ}= [symbol] ψ|O|ψ [symbol] , Eq. 10a

where the reader is reminded of the implicit complex conjugation between the bra vector [symbol] ψ| and the dual ket vector |ψ [symbol] . The expectation value [symbol] O [symbol] _{ψ} is a number that corresponds to the average result of the measurement obtained by operating with matrix O on a system described by state vector |ψ [symbol] . For better understanding, FIG. 1C visualizes the expectation value [symbol] σ₃ [symbol] for qubit 12 whose ket in the z-basis is written as |qb [symbol] _{z} for a measurement along the Z axis represented by Pauli matrix σ₃ (note that the subscript on the expectation value is left out, since we know what state vector is being measured).

Although the drawing may suggests that expectation value [symbol] σ₃ [symbol] is a projection of qubit 12 onto the Z axis, the value of this projection is not the observable. Instead, the value [symbol] σ₃ [symbol] is the expectation value of collapse of qubit 12 represented by ket vector |qb [symbol] _{z}, in other words, a value that can range anywhere between 1 and −1 (“yes” and “no”) and will be found upon collecting the results of a large number of actual measurements.

In the present case, since operator σ₃ has a complete set of eigenvectors (namely |+ [symbol] _{z} and |− [symbol] _{z}) and since the qubit |qb [symbol] _{z} we are interested in is described in the same z-basis, the probabilities are easy to compute. The expression follows directly from Eq. 10a:

[symbol]

σ₃ [symbol] _{ψ}=Σⱼλⱼ| [symbol] ψ|εⱼ [symbol] |², Eq. 10b

where λⱼ are the eigenvalues (or the “yes” and “no” outcomes of the experiment) and the norms | [symbol] ψ|εⱼ [symbol] |² are the probabilities that these outcomes will occur. Eq. 10b is thus more useful for elucidating how the expectation value of an operator brings out the probabilities of collapse to respective eigenvectors |εⱼ [symbol] that will obtain when a large number of measurements are performed in practice.

For the specific case in FIG. 1C, we show the probabilities from Eq. 10b can be found explicitly in terms of the complex coefficients α and β. Their values are computed from the definition of quantum mechanical probabilities already introduced above (see Eqs. 2 and 3):

p₁=p_{“yes”}=| [symbol] qb|ε₁ [symbol] |²=|(α* [symbol] +|+β* [symbol] −|)|+ [symbol] _{z}|²=α*α

p₂=p_{“no”}=| [symbol] qb|ε₂ [symbol] |²=|(α* [symbol] +|+β* [symbol] −|)|− [symbol] _{z}|²=β*β

p₁+p₂=p_{“yes”}+p_{“no”}=α*α+β*β=1

These two probabilities are indicated by visual aids at the antipodes of Bloch sphere 10 for clarification. The sizes of the circles that indicate them denote their relative values. In the present case p_{“yes”}>p_{“no”} given the exemplary orientation of qubit 12.

Representation of qubit 12 in Bloch sphere 10 brings out an additional and very useful aspect to the study, namely a more intuitive polar representation. This representation will also make it easier to point out several important aspects of quantum mechanical states that will be pertinent to the present invention.

FIG. 1D illustrates qubit 12 by deploying polar angle θ and azimuthal angle φ routinely used to parameterize the surface of a sphere in [symbol] ³. Qubit 12 described by state vector |qb [symbol] _{z} has the property that its vector representation in Bloch sphere 10 intersects the sphere's surface at point 16. That is apparent from the fact that the norm of state vector |qb [symbol] _{z} is equal to one and the radius of Bloch sphere 10 is also one. Still differently put, qubit 12 is represented by quantum state |qb [symbol] _{z} that is pure; i.e., it is considered in isolation from the environment and from any other qubits for the time being. Pure state |qb [symbol] _{z} is represented with polar and azimuth angles θ, φ of the Bloch representation as follows:

$${\vert qb 〉}_{z} = cos \frac{θ}{2} {\vert + 〉}_{z} + {e}^{iφ} sin \frac{θ}{2} {\vert - 〉}_{z} , \qquad Eq . 11$$

where the half-angles are due to the state being a spinor (see definition above). The advantage of this description becomes even more clear in comparing the form of Eq. 11 with Eq. 7. State |qb [symbol] _{z} is insensitive to any overall phase or overall sign thus permitting several alternative formulations.

Additionally, we note that the Bloch representation of qubit 12 also provides an easy parameterization of point 16 in terms of {x,y,z} coordinates directly from polar and azimuth angles θ, φ. In particular, the coordinates of point 16 are just:

{x,y,z}={ sin θ cos φ, sin θ sin φ, cos θ}, Eq. 12

in agreement with standard transformation between polar and Cartesian coordinates.

We now return to the question of measurement equipped with some basic tools and a useful representation of qubit 12 as a unit vector terminating at the surface of Bloch sphere 10 at point 16 (whose coordinates {x,y,z} are found from Eq. 12) and pointing in some direction characterized by angles θ, φ. The three Pauli matrices σ₁, σ₂, σ₃ can be seen as associating with measurements along the three orthogonal axes X, Y, Z in real 3-dimensional space [symbol] ³.

A measurement represented by a direction in [symbol] ³ can be constructed from the Pauli matrices. This is done with the aid of a unit vector û pointing along a proposed measurement direction, as shown in FIG. 1D. Using the dot-product rule, we now compose the desired operator σᵤ using unit vector û and the Pauli matrices as follows:

σᵤ=û· σ̅=uₓσ₁+u_{y}σ₂+u_{z}σ₃. Eq. 13

Having thus built up a representation of quantum mechanical state vectors, we are in a position to understand a few facts about the pure state of qubit 12. Namely, an ideal or pure state of qubit 12 is represented by a Bloch vector of unit norm pointing along a well-defined direction. It can also be expressed by Cartesian coordinates {x,y,z} of point 16. Unit vector û defining any desired direction of measurement can also be defined in Cartesian coordinates {x,y,z} of its point of intersection 18 with Bloch sphere 10.

When the direction of measurement coincides with the direction of the state vector of qubit 12, or rather when the Bloch vector is aligned with unit vector û, the result of the quantum measurement will not be probabilistic. In other words, the measurement will yield the result |+ [symbol] ᵤ with certainty (probability equal to 1 as may be confirmed by applying Eq. 10b), where the subscript u here indicates the basis vector along unit vector û. Progressive misalignment between the direction of measurement and qubit 12 will result in an increasing probability of measuring the opposite state, |− [symbol] ᵤ.

The realization that it is possible to predict the value of qubit 12 with certainty under above-mentioned circumstances suggests we ask the opposite question. When do we encounter the least certainty about the outcome of measuring qubit 12? With the aid of FIG. 1E, we see that in the Bloch representation this occurs when we pick a direction of measurement along a unit vector \hat{v} that is in a plane 20 perpendicular to unit vector û after establishing the state |+ [symbol] ᵤ (or in the state |− [symbol] ᵤ) by measuring qubit 12 eigenvalue “yes” along û (or “no” opposite to û). Note that establishing a certain state in this manner is frequently called “preparing the state” by those skilled in the art. Specifically, measurement of qubit 12 along vector \hat{v} will produce outcomes |+ [symbol] ᵥ and |− [symbol] ᵥ with equal probabilities (50/50).

Indeed, we see that this same condition holds among all three orthogonal measurements encoded in the Pauli matrices. To wit, preparing a certain measurement along Z by application of matrix σ₃ to qubit 12 makes its subsequent measurement along X or Y axes maximally uncertain (see also plane 14 in FIG. 1B). This suggests some underlying relationship between Pauli matrices σ₁, σ₂, σ₃ that encodes for this indeterminacy. Even based on standard linear algebra we expect that since the order of application of matrix operations usually matters (since any two matrices A and B typically do not commute) the lack of commutation between Pauli matrices could be signaling a fundamental limit to the simultaneous observation of multiple orthogonal components of spin or, by extension, of qubit 12.

In fact, we find that the commutation relations for the Pauli matrices, here explicitly rewritten with the x,y,z indices rather than 1,2,3, are as follows:

[σₓ,σ_{y}]=iσ_{z};[σ_{y};σ_{z}]=iσₓ;[σ_{z};σₓ]=iσ_{y}. Eq. 14

The square brackets denote the traditional commutator defined between any two matrices A, B as [A,B]=AB−BA. When actual quantities rather than qubits are under study, this relationship leads directly to the famous Heisenberg Uncertainty Principle that prevents the simultaneous measurement of incompatible observables and places a bound related to Planck's constant h or on the commutator. This happens because matrices encoding real observables bring in a factor of Planck's constant h or and the commutator thus acquires this familiar bound.

The above finding is general and extends beyond the commutation relations between Pauli matrices. According to quantum mechanics, the measurement of two or more incompatible observables is always associated with matrices that do not commute. Another way to understand this new limitation on our ability to simultaneously discern separate elements of reality, is to note that the matrices for incompatible elements of reality cannot be simultaneously diagonalized. Differently still, matrices for incompatible elements of reality do not share the same eigenvectors. Given this fact of nature, it is clear why modern day applications strive to classify quantum systems with as many commuting observables as possible up to the famous Complete Set of Commuting Observables (CSCO).

### 4. A Basic Measurement Arrangement

In practice, pure states are rare due to interactions between individual qubits as well as their coupling to the environment. All such interactions lead to a loss of quantum state coherency, also referred to as decoherence, and the consequent emergence of “classical” statistics. Thus, many additional tools have been devised for practical applications of quantum models under typical conditions. However, under conditions where the experimenter has access to entities exhibiting relatively pure quantum states many aspects of the quantum mechanical description can be recovered from appropriately devised measurements.

To recover the desired quantum state information it is important to start with collections of states that are large. This situation is illustrated by FIG. 1F, where an experimental apparatus 22 is set up to perform a measurement of spin along the Z axis. Apparatus 22 has two magnets 24A, 24B for separating a stream of quantum systems 26 (e.g., electrons) according to spin. The spin states of systems 26 are treated as qubits 12a, 12b, . . . , 12n for the purposes of the experiment. The eigenvectors and eigenvalues are as before, but the subscript “z” that was there to remind us of the z-basis decomposition, which is now implicitly assumed, has been dropped.

Apparatus 22 has detectors 28A, 28B that intercept systems 26 after separation to measure and amplify the readings. It is important to realize that the act of measurement is performed during the interaction between the field created between magnets 24A, 24B and systems 26. Therefore, detectors 28A, 28B are merely providing the ability to record and amplify the measurements for human use. These operations remain consistent with the original result of quantum measurements. Hence, their operation can be treated classically. (The careful reader will discover a more in-depth explanation of how measurement can be understood as entanglement that preserves consistency between measured events given an already completed micro-level measurement. By contrast, the naïve interpretation allowing amplification to lead to macro-level superpositions and quantum interference is incompatible with the consistency requirement. A detailed analysis of these fine points is found in any of the previously mentioned foundational texts on quantum mechanics.)

For systems 26 prepared in various pure states that are unknown to the experimenter, the measurements along Z will not be sufficient to deduce these original states. Consider that each system 26 is described by Eq. 7. Thus, each system 26 passing through apparatus 22 will be deflected according to its own distinct probabilities p_{|+} [symbol] =α*α (or p_{“yes”}) and p_{|-} [symbol] =β*β (or p_{“no”}). Thus, other than knowing the state of each system 26 with certainty after its measurement, general information about the preparation of systems 26 prior to measurement will be very difficult to deduce.

FIG. 1G shows the more common situation, where systems 26 are all prepared in the same, albeit unknown pure state (for “state preparation” see section 3 above). Under these circumstances, apparatus 22 can be used to deduce more about the original pure state that is unknown to the experimenter. In particular, a large number of measurements of |+ [symbol] (“yes”) and |− [symbol] (“no”) outcomes, for example N such measurements assuming all qubits 12a through 12n are properly measured, can be analyzed probabilistically. Thus, the number n_{|+} [symbol] of |+ [symbol] measurements divided by the total number of qubits 12, namely N, has to equal α*α. Similarly, the number n_{|-} of |− [symbol] measurements divided by N has to equal β*β. From this information the experimenter can recover the projection of the unknown pure state onto the Z axis. In FIG. 1G this projection 26′ is shown as an orbit on which the state vector can be surmised to lie. Without any additional measurements, this is all the information that can be easily gleaned from a pure Z axis measurement with apparatus 22.

### 5. Wave Function Symmetry, and the Statistics of Bose-Einstein (B-E) and Fermi-Dirac (F-D) Under Exchange of Indistinguishable Entities

By now it will have become apparent to the reader that the quantum mechanical underpinnings of qubits is considerably more complicated than the physics of regular bits. In light of the invention, a very particular set of still more abstract non-classical features exhibited by wave functions requires a closer review. The first one of these features has to do with two different types of permissible wave function behaviors. The first type is exhibited by symmetric wave functions and the second type is exhibited by anti-symmetric wave functions.

To appreciate the origins of these behavioral differences we now turn to the diagram of FIG. 1H in which a particular qubit 12j is shown in a physical context 28. Context 28 is parameterized by a Cartesian coordinate system 30 that deploys standard coordinate axes (X_{w}, Y_{w}, Z_{w}), which we will sometimes refer to as world coordinates. From the drawing we see that qubit 12j is modeled or derived from an entity 32 that is more complex. The quantum state description of entity 32 is presented by wave function ψ(x,y,z;σ). Wave function ψ(x,y,z;σ) associating to entity 32 prescribes a location at (x,y,z) in world coordinates 30. In addition, entity 32 has an intrinsic spin that is indicated by σ.

Spin σ is any single component of spin, since more than one component cannot be simultaneously known due to the Uncertainty Principle. Thus, spin σ in the general case is taken as the one measurable spin component along a direction u (defined by unit vector û) measurable by spin operator σᵤ composed of the Pauli matrices in accordance with Eq. 13. In many typical applications of quantum mechanics and for the sake of simplicity, spin is defined along the Z-axis and is hence associated with the Pauli matrix σ₃ (also sometimes designated as σ_{z}).

The position of entity 32 at (x,y,z) does not have its usual status of a precise and perpetually existing attribute of entity 32. This, of course, is also due to the Uncertainty Principle. According to it, when measuring observables incompatible with position parameters (x,y,z) (e.g., the momenta pₓ, p_{y} and p_{z}), we find that they are never found to coexist with position parameters (x,y,z) to arbitrary levels of precision. We discover instead, that the products of positions and momenta (x and pₓ, y and p_{y}, z and p_{z}) are roughly equal to Planck's constant h (ΔxΔpₓ≈h). Given this demotion of stable classical parameters to “smeared out” observables, the model of entity 32 has to be adjusted accordingly.

By position or location we now mean a volume dVⱼ centered on (x,y,z) within which entity 32 is most likely to be found during a position measurement at the given level of experimental precision. To simplify the notation, we introduce a vector rⱼ from the origin of world coordinates 30 to the center of volume dVⱼ. Further, we rewrite the wave function of entity 32 as ψ(rⱼ;σ).

A crucial aspect of the quantum mechanical description has to do with observables that are compatible with each other. Such observables can be measured simultaneously without affecting each other. Consequently, specifying the wave function in such observables permits us to split it into the corresponding parameters and treat them separately. Indeed, it is this very idea of separability of certain aspects of the quantum mechanical description that permits the practitioners of quantum information theory to divorce the qubit aspect of a quantum entity from the remainder of its physical embodiment.

In keeping with this approach, our description of entity 32 has two separable properties, namely position rⱼ and spin σ. To indicate that we can consider them separately we use the semicolon in the wave function ψ(rⱼ;σ) of entity 32 between these separate arguments. A more formal way to understand separability of the two wave function arguments is to realize that the Hilbert space of position [symbol] ᵣ of entity 32 does not overlap with the Hilbert space of its spin [symbol] _{σ}. This means that any operator acting on one of these arguments, e.g., the spin operator σ₃ acting on the spin of entity 32, does not act on the other argument, i.e., the position of entity 32. A person skilled in the would say that an operator acting in one of these Hilbert spaces acts as the identity operator in the other Hilbert space. Differently put, the spin operator acting on entity 32 should really be thought of as a composite operator σ₃ [symbol] 1 with its spin part σ₃ acting as a proper spin operator in [symbol] _{σ} but behaving just as the identity matrix 1 in [symbol] ᵣ.

In view of the above, we now proceed with justification to considering only the spin portion of entity's 32 more complete wave function ψ(rⱼ;σ). To simplify further, we follow the standard conventions in the art and focus on the z-component of spin. Hence, our wave function reduces to just ψ(σ₃). In FIG. 1H we find that world coordinate axis Z_{w} is parallel to axis Z of entity 32 (sometimes also referred to as object axis Z of object coordinates). In general, such alignment may not exist and a corresponding coordinate transformation from world coordinates to object coordinates may be required. Such transformation is well-known to those skilled in the art and will not be described herein. For details on coordinate transformations see, e.g., G. B. Arfken and H. J. Weber, “Mathematical Methods for Physicists”, Harcourt Academic Press, 5^{th} Edition, 2001.

We now focus on the enlarged view of entity 32 in volume dVⱼ as shown in the lower right portion of FIG. 1H. Here we see that entity 32 has a well-defined component of spin σ₃ along object Z axis. Our knowledge of this z-spin component is guaranteed by selecting qubit 12j from among systems 26 that yielded this known projection value upon repeated measurements as shown in FIG. 1G. Of course, our qubit 12j is selected from systems 26 that have not yet been subjected to measurement. Such act would collapse wave function ψ(σ₃) that we wish to study (recall that measurement yields one of two possibilities for z-spin: up or down). Thus, without actually subjecting qubit 12j to any measurement, we infer its wave function ψ(σ₃) because of the fact that all qubits 12a-12n derived from systems 26 are identically prepared.

As already hinted at in FIG. 1G, knowledge of z-spin component of wave function ψ(σ₃), however, does not tell us where it is along an orbit 34 that corresponds to projection 26′ (also see FIG. 1G). It is the behavior of wave function ψ(σ₃) as it progresses along orbit 34 that gives rise to the first of the features we need to understand to properly contextualize the present invention.

Precession of wave function ψ(σ₃) along orbit 34 about object Z axis can be attributed to the action of a rotation operator O. This operator is constructed from the identity operator 1 combined with rotation by an infinitesimal part δφ of azimuthal angle φ as follows:

O=1+iδφ·σ₃. Eq. 15

Successive application of operator O will allow wave function ψ(σ₃) to complete a full cycle about orbit 34. In other words, a full rotation by azimuthal angle φ=2π will be produced by many successive applications of operator O to state ψ(σ₃). (The diligent reader may wish to consult the aforementioned references to learn more about the rotation group and its generators at this time, as these will not be discussed herein.)

Knowing operator O, we can now describe the effects of rotation about object Z axis for any finite value of azimuthal angle φ. Thus, for a wave function ψ′(σ₃) representing the original wave function ψ(σ₃) rotated by a certain azimuthal angle φ we obtain:

ψ′(σ₃)=e^{iσ}^{₃}^{φ}ψ(σ₃) Eq. 16

This expression already presages that the complex nature of wave function ψ(σ₃) and of Hilbert space [symbol] _{σ} it inhabits will permit the emergence of a classically unexpected behavior. This new behavior manifests due to the inherent spin value s of entity 32. From experimental evidence we know that spin σ (measured along any u) can exhibit spin values ranging from −s to +s in unit increments (s, s−1, s−2 . . . , −s). It is thus the choice of spin value s for entity 32 on which our qubit 12j is based that will materially affect its behavior.

When our qubit 12j is obtained from an entity 32 such as an electron, whose intrinsic spin value s is ½ (i.e., s=½) we find that upon precession by φ=2π the factor e^{iσ}^{₃}^{φ}=e^{2πiσ}^{₃} is equal to −1. In other words, since 2σ is always the same parity as 2s, the multiplying factor in Eq. 16 is (−1)^{2s} and it is −1 for s=½ (Planck's constant is here normalized to 1 and omitted). Therefore, when the coordinates are completely rotated about Z axis (and indeed about any axis u) the wave functions of entity 32 with half-integral spin will flip its sign. It will take another full rotation by φ=2π for a total azimuthal angle change of φ=4π in order for rotated wave function ψ′(σ₃) to return to original wave function ψ(σ₃) (also see discussion of spinor above). This type of new and classically unexpected behavior is associated with all entities, including complex or composite entities made up of two or more constituent entities that have a net half-integral spin value s. Such entities are called fermions.

By contrast, entities manifesting integral spin s do not change sign upon rotation by φ=2π. This is also true of complex or composite entities with net integral spin. Such entities are called bosons. In our case, a rotation by φ=2π of electron 32, which is the fermion on which qubit 12j is based, would cause a flip in sign, spin s=½→ψ′(σ₃)=−ψ(σ₃) for φ=2π. Wave functions with this property are called anti-symmetric. Meanwhile, for the same rotation, had our entity 32 been a spin value s=1 boson, we would not witness a sign flip, spin s=1→ψ′(σ₃)=ψ(σ₃) for φ=2π. For this reason, wave functions of bosons are referred to as symmetric.

Note that the anti-symmetric and symmetric behaviors of fermionic and bosonic wave functions are experimentally confirmed. In other words, within non-relativistic quantum mechanics, the correlation between the spin of the particle and the statistics such a particle obeys (called the spin-statistics relation or theorem) is found to be an empirical law. However, it is one of the fundamental results of relativistic quantum mechanics that the spin-statistics correlation follows from the principles of special relativity, quantum mechanics, and the positivity of energy. For a formal introduction the reader may wish to consult a textbook on Quantum Field Theory, which is founded on special relativity. Among the many excellent references are the popular standards such as: Peskin, M. E. and Schroeder, D. V., “An Introduction to Quantum Field Theory”, Perseus Books Publishing, Reading, Mass., 1995; Weinberg, S. “The Quantum Theory of Fields”, Cambridge University Press, Third Printing, 2009 and many other references including Srednicki, M., “Quantum Field Theory”, University of California, Santa Barbara, 2006 found online at: http://www.physics.ucsb.edu/˜marek/qft.html.

For the sake of completeness, the reader is advised that other statistics can be exhibited by entities with fractional spin values s. They are classified as Abelian and non-Abelian anyons by those skilled in the art. Anyons of the first type are known to produce observable effects such as the fractional quantum Hall effect. Non-abelian anyons have not been definitively detected, but remain an important field of research due to their potential value to topological quantum computing. Intuition about such entities and their behaviors is beyond the scope of the present invention and the cursory review presented herein. The very diligent reader may, however, glean some of their properties after a review of the mathematics of complex spaces and Riemann surfaces.

We now return to the next set of quantum features not anticipated by classical physics. These are attributed to the indistinguishable nature of similar particles, be they fermions or bosons. Once again, this feature follows from the Uncertainty Principle, which does not allow us to label individual particles and keep them apart by tracking their paths. The fact that the classical concept of path or trajectory is lost in quantum mechanics is apparent from the “smearing out” of observables associated with entity 32 as discussed above in conjunction with the spatial argument ψ(x,y,z)=ψ(rⱼ) of wave function ψ(x,y,z;σ) associated with qubit 12j. When dealing with two or more indistinguishable entities 32, localizing and numbering them at some time will not help us identify them at some later instant. For example, if after labeling we manage to localize one of the two or more entities 32 at some future time at a given point in space, we cannot say which of the several entities 32 it is that has arrived at this point.

To examine first the new behavior due to the indistinguishable nature of similar entities embodied by bosons we turn to FIG. 1I. This drawing is also presented in context 28 parameterized by Cartesian coordinate system 30 or world coordinates (X_{w}, Y_{w}, Z_{w}). Here, context 28 is found within specialized low-temperature laboratory (not shown) equipped with a condensate container 36 and a cooling apparatus 38. In the present embodiment apparatus 38 is instantiated by a laser system that emits radiation 40 incident on condensate container 36. Radiation 40 is designed to cool the contents of container 36 to temperatures within a small fraction of a degree near absolute zero.

Container 36 holds a pool 42 of bosons in the form of a dilute gas. When cooled to temperatures near zero by cooling apparatus 38, the bosons condense into a state of matter known as the Bose-Einstein Condensate (BEC). In FIG. 1I a center portion 42′ of pool 42 has reached the requisite low temperature and transitioned to the BEC state. The enlarged view of pool portion 42′ visualizes a number of bosons 44a, 44b, . . . , 44n that are in the BEC phase. It is noted that all of these participate in the BEC phase and have to be treated in accord with Bose-Einstein statistics.

To understand the interchange or swap of identical bosons in the BEC phase we will just concentrate on two bosons 44j, 44k. These are enlarged and lifted out of pool portion 42′ for better viewing. Their spatial locations are indicated by vectors rⱼ and rₖ, respectively and in accordance with the above-established rules. Their spatial separation rⱼₖ is obtained by vector subtraction (rⱼₖ=rⱼ−rₖ). To stay mindful of the fact that bosons 44j, 44k are the underlying physical entities giving rise to qubits 12j, 12k the corresponding references are included in FIG. 1I.

Since pool portion 42′ is in BEC phase, spatial separation rⱼₖ between bosons 44j and 44k has reached a minimum value. Further, bosons 44j and 44k each have integral spin value s=1. Their wave functions thus have a spatial argument indicated by rⱼ and rₖ, and the separable spin argument σ. In other words, the wave functions associated with bosons 44j, 44k are:

ψ(rⱼ;σ)=ψ(ξⱼ) and ψ(rₖ;σ)=ψ(ξₖ), Eq. 17

where the ξ's stand for the three position parameters (x,y,z) in world coordinates 30 and for the spin projection σ of each boson. An alternative representation using Dirac's kets and formal tensor product notation is shown in FIG. 1I.

At this point we are ready to construct the combined wave function of bosons 44j, 44k. In doing so we note first that despite being indistinguishable bosons 44j, 44k do have a stable identity irrespectively of which one is being considered. Thus, the quantum states obtained by combining them into a composite wave function have to remain physically equivalent under interchange. For the two possible permutations we thus have:

Ψⱼₖ=ψ(ξⱼ)φ(ξₖ) and Ψₖⱼ=ψ(ξₖ)ψ(ξⱼ). Eq. 18

As we already know from above, physically measurable attributes or observables of wave functions are unaffected by an overall phase (or sign). Therefore, we deduce that the interchange or swap of bosons 44j, 44k can only be reflected in their composite wave function by just such a phase factor. This permits one swap, denoted in FIG. 1I by “swap 1” to be limited to the following expression:

Ψₖⱼ=e^{iγ}Ψⱼₖ, Eq. 19

where γ is some real constant. Repeating the interchange by performing “swap 2” we evidently must return to the original state. At the same time, the phase factor e^{iγ} gets doubled to e^{2iγ} during this return swap. We have seen this pattern before when discussing the nature of spinors. Therefore, we anticipate that the correct phase factor for “swap 1” must be either +1 or −1. For bosons the swap rule is that the phase factor is e^{iγ}=1 and thus, obviously, e^{2iγ}=1 for any half-integral or integral value of real constant γ. Hence, no sign change for first swap and any subsequent swap. The total boson wave function is therefore symmetric.

The total Hilbert space [symbol] ^{(N)} containing all n interchangeable bosons 44a, 44b, . . . , 44n is a tensor space:

[symbol]

^{(N)}= [symbol] ₍ₐ₎ [symbol] [symbol] ₍ₐ₎ [symbol] . . . [symbol] ₍ₙ₎. Eq. 20

All possible individual or single boson states that can be occupied by bosons 44 in BEC 42′ are ψ₁, ψ₂, . . . , ψ_{N}. These can be combined to form the correspondent tensor product basis for total Hilbert space [symbol] ^{(N)} to describe the total boson wave function Ψₜₒₜ for bosons 44 in BEC 42′. Both weakly interacting and interacting bosons 44 can be treated in this total Hilbert space [symbol] ^{(N)} using Bose-Einstein statistics. For our system of bosons 44, or indeed any system of bosons, the Bose-Einstein statistics then dictate the form of the total wave function Ψₜₒₜ in the tensor product basis. In particular, it is obtained from a sum of products, where each product has the form:

ψₐ(ξ₁)ψ_{b}(ξ₂) . . . ψ_{N}(ξ_{N}), Eq. 21

with all possible permutations of the different suffixes for different bosons swapped over all the possible states ξ₁, ξ₂ . . . , ξ_{N} that they can occupy. Conservation of probability requires a normalization of the final total wave function Ψₜₒₜ.

In the case of just the two bosons 44j, 44k lifted out for study in FIG. 1I, we examine the two particle wave function Ψ when 44j≠44k (i.e., we are considering different but indistinguishable particles). In observance of Bose-Einstein statistics, from now on abbreviated as B-E statistics for reasons of convenience, such two-boson wave function becomes:

Ψ(ξⱼ,ξₖ)=1/\sqrt{2}[ψⱼ(ξ₁)ψₖ(ξ₂)+ψⱼ(ξ₂)ψₖ(ξ₁)], Eq. 22

where the factor of 1/\sqrt{2} is introduced for the aforementioned purposes of normalization. Note the symmetric nature of Ψ(ξⱼ,ξₖ) by considering what happens to it under multiplication by its complex conjugate Ψ*(ξⱼ,ξₖ).

FIG. 1J illustrates the behavior of fermions. In this example we again focus on just two indistinguishable fermions embodied by electrons 32k₁ and 32k₂. Electrons 32k₁, 32k₂ exist in context 28 of an atomic orbital 46k-l₁ belonging to a gas atom 48k. A nucleus 50k is located at the center of gas atom 48k. Its location in world coordinates 30 is described by vector rₖ.

Nucleus 50k is at least three orders of magnitude heavier than any electrons belonging to gas atom 48k. It is therefore customary and entirely justified to consider nucleus 50k as stationary from the point of view of all electrons. In that sense, vector rₖ and the volume enclosing all filled atomic orbitals around it describes the position of gas atom 48k.

For comparison, FIG. 1J also depicts select atomic orbitals belonging to atoms 48j, 48m and 48n with their nuclei 50j, 50m, 50n localized at rⱼ, rₘ, rₙ, respectively. In particular, the drawing shows a p-orbital referenced by 46j-l₁ belonging to atom 48j and having the same angular momentum quantum number, namely l=1, as atomic orbital 46k-l₁. FIG. 1J also shows the spherically symmetric s-orbital 46k-l₀ in atom 48m corresponding to angular momentum quantum number l=0. The s-orbital is always available to be filled by electrons, since it exists for the lowest-valued principal quantum number: n=1. Meanwhile, a d-orbital referenced by 46k-l₂ and belonging to atom 48n is only available when the principal quantum number is n=3 or larger. A more thorough background on the orbital angular momentum L operator, its eigenvalues l and their relation to principal quantum number n as well as the rules of atomic orbital filling order (e.g., Hund's rule) are found in introductory level textbooks on atomic physics as well as quantum chemistry and they will not be addressed herein.

Our main motivation for reviewing the atomic orbitals and learning how they are filled by successive electrons 32 is to understand fermion behavior. Eq. 19 offered two choices for the value of phase factor e^{iγ}. Since bosons chose e^{iγ}=1, the remaining alternative for fermions is e^{iγ}=−1. In fact, we do find experimentally that the correct phase factor for “swap 1” is −1 for fermions (such as electrons 32k₁ and 32k₂). Thus, any composite fermion wave function must be anti-symmetric. These wave functions are said to obey Fermi-Dirac statistics (or F-D statistics for short). Given the behavior of spinors explained in reference to FIG. 1H the reader may find this result unsurprising.

A set of fermions in a total Hilbert space [symbol] ^{(N)} spanned by the tensor product basis states derived in the same manner as for the bosons, have a total fermion wave function Ψₜₒₜ. We find that such total wave function Ψₜₒₜ is an anti-symmetrical combination of the products of the individual states. Mathematically, it is convenient to take advantage of the definition of the determinant from linear algebra (sometimes called the Slater determinant by those skilled in the art) to write the normalized combination as follows:

$${Ψ}_{tot} = \frac{1}{\sqrt{N !}} [ \begin{matrix}{ψ}_{1} ( {ξ}_{1} ) & … & {ψ}_{1} ( {ξ}_{N} ) \\ ⋮ & ⋱ & ⋮ \\ {ψ}_{N} ( {ξ}_{1} ) & … & {ψ}_{N} ( {ξ}_{N} )\end{matrix} ] . \qquad Eq . 23$$

Here the interchange or swap of two fermions, such as electrons 32k₁ and 32k₂, corresponds to an interchange of two columns of the determinant. The result of this, as is well known from linear algebra, will cause a change in sign (see for a simple 2×2 matrix). For our simple system of just two electrons 32k₁ and 32k₂ we obtain the two-particle wave function:

Ψ(ξ_{k,1},ξ_{k,2})=1/\sqrt{2}[ψₚ₁(ξ_{k,1})ψₚ₂(ξ_{k,2})−ψₚ₁(ξ_{k,2})ψₚ₂(ξ_{k,1})], Eq. 24

where p₁ stands for electron 32k₁ and p₂ stands for electron 32k₂.

As a consequence of the anti-symmetric nature of fermionic wave functions, if any two fermions are in the same state, i.e., if p₁=p₂, then two rows of the determinant are the same. Therefore the determinant vanishes identically. The determinant will not be zero only when numbers p₁ and p₂ are different. Thus, in any system consisting of identical fermions no two (or more) of them can occupy the same quantum state at the same time. This very fundamental rule is called Pauli's Exclusion Principle by those skilled in the art.

In our simple example of filling of atomic orbital 46k-l₁ by electrons 32 this means that if first electron 32k₁ is described by the wave function |ξ_{k,1} [symbol] =|rₖ; 2,1,1,+ [symbol] , then second electron 32k₂ cannot assume the same state and must therefore be described by distinct wave function |ξ_{k,2} [symbol] =|rₖ;2,1,1,− [symbol] . The only other permissible quantum state is the reverse. The quantum numbers used in these kets correspond to |ξ_{k,q} [symbol] =|rₖ;n,l,mₗ,mₛ [symbol] , where n is the principal quantum number and l is the angular momentum quantum number. Observable mₗ corresponds to the projection of l along the Z-axis, and mₛ is the projection of intrinsic electron spin σ along the Z-axis (i.e., the value found by applying σ₃ multiplied by ½).

From the above introduction to the nature of F-D and B-E statistics, we see that entities falling into those two fundamental categories exhibit vastly different behaviors. While bosons are likely to occupy the same quantum state, fermions cannot do so. Sometimes boson behavior is classified as “bunching-type” and that of fermions is referred to as “repulsive”. Still, the statistics due to the symmetric or anti-symmetric nature of wave functions cannot be properly attributed to a force. In the traditional sense still retained in the contemporary descriptions used by those skilled in the art, forces act on fully emerged elements of reality.

Another important point about bosons and fermions hinted at above is that they may be composite or elementary entities. Electrons 32 used in the above example are fermions constituted by elementary particles, but composites or complexes can also be fermionic. This will be true, according to the spin statistics theorem, when the combined spin of all constituents is half-integral. Similarly, in additional to fundamental particles such as the photon (spin s=1 gauge boson and mediator of the electro-magnetic force), bosons can also be composites. The spin statistics theorem simply requires that the total spin of a composite boson be integral.

Of course, when a composite boson is made up of say two fermions (thus clearly satisfying the spin statistics theorem) it will retain its bosonic character for as long as the interactions in question do not reach energy levels or scales that test the boson's component fermions. Once this happens, the justification for using the symmetric composite wave function disappears. To get the correct answers we have to give up the composite description and consider the behavior of the two fermions.

Those skilled in the art sometimes distinguish between wave functions exhibiting F-D statistics and B-E statistics by using a different greek letters. Most commonly, we designate wave functions of both fundamental and composite bosons by the greek letter Φ. The greek letter Ψ is used to designate fermion wave functions. We shall adopt this convention in the context of the present invention.

We have thus exposed a few key aspects of the complex nature of the underlying physical entities from which qubits are derived. This being given, the reader is likely to have developed by now a certain sense of caution. Specifically, it should be apparent by now that a naïve and simplistic adaptation or mapping of quantum mechanical concepts to quantum information theory is not possible. It is therefore incumbent on those wishing to deploy qubits for computation to also study their underlying physical embodiments.

Besides this issue, there are many other practical limitations to the application of quantum mechanical models in settings beyond the traditional microscopic realms where quantum mechanical tools are routinely deployed. Some of these limitations, including decoherence and the necessity to use the density matrix approach, are outlined in U.S. patent application Ser. No. 14/128,821 entitled “Method and Apparatus for Predicting Subject Responses to a Proposition based on Quantum Representation of the Subject's Internal State and of the Proposition”, filed on Feb. 17, 2014. Still others will be found in the technical references cited above. Taken together, these form a set of fundamental obstacles that thwart the deployment of quantum mechanical methods in practical situations of interest. The problems are exacerbated when attempting to extend the applicability of quantum methods to other realms (e.g., at larger scales). These render a systematic study of our reality with quantum models and the development of a “full picture” beyond current human capabilities.

### 6. Prior Art Applications of Quantum Theory to Subject States

Since the advent of quantum mechanics, many have realized that some of its non-classical features may better reflect the state of affairs at the human grade of existence. In particular, the fact that state vectors inherently encode incompatible measurement outcomes and the probabilistic nature of measurement do seem quite intuitive upon contemplation. Thus, many of the fathers of quantum mechanics did speculate on the meaning and applicability of quantum mechanics to human existence. Of course, the fact that rampant quantum decoherence above microscopic levels tends to destroy any underlying traces of coherent quantum states was never helpful. Based on the conclusion of the prior section, one can immediately surmise that such extension of quantum mechanical models in a rigorous manner during the early days of quantum mechanics could not even be legitimately contemplated.

Nevertheless, among the more notable early attempts at applying quantum techniques to characterize human states are those of C. G. Jung and Wolfgang Pauli. Although they did not meet with success, their bold move to export quantum formalisms to large scale realms without too much concern for justifying such procedures paved the way others. More recently, the textbook by physicist David Bohm, “Quantum Theory”, Prentice Hall, 1979 ISBN 0-486-65969-0, pp. 169-172 also indicates a motivation for exporting quantum mechanical concepts to applications on human subjects. More specifically, Bohm speculates about employing aspects of the quantum description to characterize human thoughts and feelings.

In a review article published online by J. Summers, “Thought and the Uncertainty Principle”, http://www.jasonsummers.org/thought-and-the-uncertainty-principle/, 2013 the author suggests that a number of close analogies between quantum processes and our inner experience and through processes could be more than mere coincidence. The author shows that this suggestion is in line with certain thoughts on the subject expressed by Niels Bohr, one of the fathers of quantum mechanics. Bohr's suggestion involves the idea that certain key points controlling the mechanism in the brain are so sensitive and delicately balanced that they must be described in an essentially quantum-mechanical way. Still, Summers recognizes that the absence of any experimental data on these issues prevents the establishment of any formal mapping between quantum mechanics and human subject states.

The early attempts at lifting quantum mechanics from their micro-scale realm to describe human states cast new light on the already known problem with standard classical logic, typically expressed by Bayesian models. In particular, it had long been known that Bayesian models are not sufficient or even incompatible with properties observed in human decision-making. The mathematical nature of these properties, which are quite different from Bayesian probabilities, were later investigated in quantum information science by Vedral, V., “Introduction to quantum information science”, New York: Oxford University Press 2006.

Taking the early attempts and more recent related motivations into account, it is perhaps not surprising that an increasing number of authors argue that the basic framework of quantum theory can be somehow extrapolated from the micro-domain to find useful applications in the cognitive domain. Some of the most notable contributions are found in: Aerts, D., Czachor, M., & D'Hooghe, B. (2005), “Do we think and communicate in quantum ways? On the presence of quantum structures in language”, In N. Gontier, J. P. V. Bendegem, & D. Aerts (Eds.), Evolutionary epistemology, language and culture. Studies in language, companion series. Amsterdam: John Benjamins Publishing Company; Atmanspacher, H., RoÅNmer, H., & Walach, H. (2002), “Weak quantum theory: Complementarity and entanglement in physics and beyond”, Foundations of Physics, 32, pp. 379-406; Blutner, R. (2009), “Concepts and bounded rationality: An application of Niestegge's approach to conditional quantum probabilities”, In Accardi, L. et al. (Eds.), Foundations of probability and physics-5, American institute of physics conference proceedings, New York (pp. 302-310); Busemeyer, J. R., Wang, Z., & Townsend, J. T. (2006), “Quantum dynamics of human decision-making”, Journal of Mathematical Psychology, 50, pp. 220-241; Franco, R. (2007), “Quantum mechanics and rational ignorance”, Arxiv preprint physics/0702163; Khrennikov, A. Y., “Quantum-like formalism for cognitive measurements”, BioSystems, 2003, Vol. 70, pp. 211-233; Pothos, E. M., & Busemeyer, J. R. (2009), “A quantum probability explanation for violations of ‘rational’ decision theory”, Proceedings of the Royal Society B: Biological Sciences, 276. Recently, Gabora, L., Rosch, E., & Aerts, D. (2008), “Toward an ecological theory of concepts”, Ecological Psychology, 20, pp. 84-116 have even demonstrated how this framework can account for the creative, context-sensitive manner in which concepts are used, and they have discussed empirical data supporting their view.

An exciting direction for the application of quantum theory to the modeling of inner states of subjects was provided by the paper of R. Blutner and E. Hochnadel, “Two qubits for C. G. Jung's theory of personality”, Cognitive Systems Research, Elsevier, Vol. 11, 2010, pp. 243-259. The authors propose a formalization of C. G. Jung's theory of personality using a four-dimensional Hilbert space for representation of two qubits. This approach makes a certain assumption about the relationship of the first qubit assigned to psychological functions (Thinking, Feeling, Sensing and iNtuiting) and the second qubit representing the two perspectives (Introversion and Extroversion). The mapping of the psychological functions and perspectives presumes certain relationships between incompatible observables as well as the state of entanglement between the qubits that does not appear to be borne out in practice, as admitted by the authors. Despite this insufficiency, the paper is of great value and marks an important contribution to techniques for mapping problems regarding the behaviors and states of human subjects to qubits using standard tools and models afforded by quantum mechanics.

Thus, attempts at applying quantum mechanics to phenomena involving subjects at macro-levels have been mostly unsuccessful. A main and admitted source of problems lies in the translation of quantum mechanical models to human situations. More precisely, it is not at all clear how to map subject states as well as subject actions or reactions to quantum states. In fact, it is not even clear what is the correct correspondence between subject states, subject reactions and measurements of these quantities, as well as the unitary evolution of these states when not subject to measurement.

Furthermore, many questions about measurement given the issues of decoherence and the formal problems that came into focus at the end of technical sub-section 4 of the present Background description remain difficult to address. Finally, the prior art does not provide for a quantum informed approach to gathering data. Instead, the state of the art for development of predictive personality models based on “big data” collected on the web is ostensibly limited to classical data collection and classification approaches. Some of the most representative descriptions of these are provided by: D. Markvikj et al., “Mining Facebook Data for Predictive Personality Modeling”, Association for the Advancement of Artificial Intelligence, www.aaai.org, 2013; G. Chittaranjan et al., “Who's Who with Big-Five: Analyzing and Classifying Personality Traits with Smartphones”, Idiap Research Institute, 2011, pp. 1-8; B. Verhoeven et al., “Ensemble Methods for Personality Recognition”, CLiPS, University of Antwerp, Association for the Advancement of Artificial Intelligence, Technical Report WS-13-01, www.aaai.org, 2013; M. Komisin et al., “Identifying Personality Types Using Document Classification Methods”, Dept. of Computer Science, Proceedings of the Twenty-Fifth International Florida Artificial Intelligence Research Society Conference, 2012, pp. 232-237.

### OBJECTS AND ADVANTAGES

In view of the shortcomings of the prior art, it is an object of the present invention to provide for providing a quantum mechanical representation of possible states between subjects, e.g., human beings, modulo an underlying proposition presented in a particular context. In particular, it is an object of the invention to interpret the effects of Bose-Einstein (B-E) and Fermi-Dirac (F-D) statistics in the assignment of qubits and of possible joint states of such qubits.

Still another object of the invention is to extend the quantum mechanical representation informed by B-E and F-D statistics in subject-subject relationships to social networks and their representations in various forms including graphs.

Still other objects and advantages of the invention will become apparent upon reading the detailed specification and reviewing the accompanying drawing figures.

### SUMMARY OF THE INVENTION

The present invention relates to a method and an apparatus for predicting a joint quantum state modulo an underlying proposition that revolves about an object, a subject or an experience that is made or lived by a subject. The joint quantum state involves a transmitting subject that broadcasts a measurable indication modulo the underlying proposition and a receiving subject that is capable of receiving the measurable indication. Typically, the method of the invention is practiced in the context of a communications network or a social network where the subjects are interconnected and communicating freely while producing electronic records that can be collected and evaluated. Consequently, the apparatus of the invention is typically deployed in a computer network and may involve a computer cluster. However, purely off-line interactions between subjects can also be included. This is done provided that sufficient data about off-line activities is available to execute the necessary steps by the corresponding modules and units of the apparatus of invention.

In accordance with the invention, a mapping module is used to find a common internal space that is shared by the transmitting subject and the receiving subject. An assignment module assigns a transmit subject qubit |Tx [symbol] to the transmitting subject and a receive subject qubit |Rx [symbol] to the receiving subject. Given the commonality of the internal space, both the transmit subject and receive subject qubits |Tx [symbol] , |Rx [symbol] are taken to share a Hilbert space or a state space [symbol] ^{(TR)}. A statistics module assigns a quantum statistic modulo the underlying proposition to both the transmit subject qubit |Tx [symbol] and to the receive subject qubit |Rx [symbol] . The quantum statistic is preferably selected from the two common statistics that include the Bose-Einstein statistics exhibited by integral spin entities and Fermi-Direct statistics exhibited by half-integer spin entities. These two statistics are referred to herein as a consensus statistic B-E and an anti-consensus statistic F-D, respectively. The joint quantum state of the transmit subject qubit |Tx [symbol] and receive subject qubit |Rx [symbol] in the common state space [symbol] ^{(TR)} is determined based on the quantum statistics. This function is performed by a prediction module but it can also be implemented in a simulation engine or in conjunction with such a simulation engine, depending on the embodiment.

Typically, the measurable indication belongs to a set of at least two mutually exclusive responses a, b given a context or a setting within which the underlying proposition presents itself. Given that there is an inherent difference in how the transmit subject and the receive subject may contextualize a given underlying proposition, a distinction is made between them. Thus, the underlying proposition is presented in a transmit subject context that is associated in accordance with quantum mechanical rules with a transmit subject proposition matrix PR_{Tx}. The at least two mutually exclusive responses a, b by the transmit subject are thus made to correspond to the at least two eigenvalues of transmit subject proposition matrix PR_{Tx}.

In a similar vein, the underlying proposition is also presented in a receive subject context that is associated with a receive subject proposition matrix PR_{Rx}. Now, the at least two mutually exclusive responses a, b that can be exhibited by the receive subject correspond to the at least two eigenvalues of receive subject proposition matrix PR_{Rx}. Of course, if both the transmit and receive subjects contextualize the underlying proposition in the same manner, then their proposition matrices will tend to match and so will the meaning of their possible two or more mutually exclusive responses. On the other hand, if their contextualization rules adopted by the transmit and receive subjects are very different, up to fundamentally incompatible, then their proposition matrices will have a larger commutator values up to a maximum value. Such matrices will be far from sharing the same eigenvectors and will encode for correspondingly incompatible ways of contextualizing the underlying proposition. Therefore, the same indication or response, say a=“YES”, will mean something very different in these two fundamentally incompatible contexts built around the exact same underlying proposition.

Of course, the space of possible ways in which transmit and receive subjects can contextualize and interact about any underlying proposition that both of them register can be large. Therefore, it is preferable to determine by deploying a network behavior monitoring unit a set of available quantum states for the transmit qubit |Tx [symbol] and the receive qubit |Rx [symbol] . Once the space of possible states is known, it is easier to predict the joint quantum state. In general, the joint quantum state can be either a symmetric quantum state Φ, or an anti-symmetric quantum state Ψ.

Of course, it is also possible that transmit and receive subject qubits |Tx [symbol] , |Rx [symbol] experience a nil coupling [symbol] ₀. This corresponds to situations where the broadcast does not bridge the gap between the transmitting and receiving subjects and/or, even though they may share a common internal space, they fail to establish any connection in practice.

When coupling occurs between the subjects in the common internal space that is quantum mechanically represented by shared Hilbert space [symbol] ^{(TR)}, it is advantageous to estimate a quantum exchange between transmit subject qubit |Tx [symbol] and the receive subject qubit |Rx [symbol] . It is noted that this estimation should not be construed as a strict application of the quantum mechanical concepts of exchange coupling, but rather a more qualitative estimate that may even be initially curated by a human curator with requisite experience. The task can be implemented in the apparatus of the invention by a quantum exchange monitor. Since such monitor should be aware of the network interactions, it may conveniently be integrated with the network behavior monitoring unit, but it can also be a separate module. The assignments made by the statistics module can be adjusted based on any quantum exchange energy that is discovered by the quantum exchange monitor.

In one particularly advantageous embodiment of the invention, a graph corresponding to an adjacency matrix, a hash table or even a complete incidence matrix is deployed to keep track of subject-subject interactions. Here, transmit subject qubit |Tx [symbol] is embedded at a first vertex in the graph. The receive subject qubit |Rx [symbol] is embedded at a second vertex in the graph. Then, the quantum statistic modulo the underlying proposition, i.e., F-D or B-E statistic, is assigned to an edge of the graph that joins the first and second vertices. Obviously, such graph can be extended to an entire social network in which there is an entire group of transmitting subject members Txᵢ of which transmitting subject represented by transmit subject qubit |Tx [symbol] is only a single member. Similarly, the social group will typically contain an entire group of receiving subject members Rxⱼ of which receiving subject represented by receive subject qubit |Rx [symbol] is just a single member.

In applying the quantum model of the present invention, it is clear that all transmitting and receiving subject members Txᵢ, Rxⱼ of the social group should be assigned correspondent qubits by the assignment module. Furthermore, for those that exhibit no coupling modulo the underlying proposition a nil coupling [symbol] ₀ is entered. Conveniently, when dealing with an entire social group, the graph should be expanded to create an adjacency matrix AM_{Tx}_{ᵢ}_{Rx}_{ⱼ} between all transmitting subject members Txᵢ and receiving subject members Rxᵢ of the social network. Of course, bidirectional communications can be included in any bidirectional representations of the graph edges, as is well known to those skilled in the art. Furthermore, the adjacency matrix AM_{Tx}_{ᵢ}_{Rx}_{ⱼ} is clearly based on a context in which the underlying proposition is presented. Therefore, the matrix may change when the context is altered and should be re-computed correspondingly under change of context/framing of the underlying proposition as presented to the social network.

Preferably, when the subjects are considered as part of their whole social network, the interactions between a number of members of the social network, and ideally even all of them, if practicable, are monitored by the network behavior monitoring unit. Thus, the quantum statistic module the underlying proposition can be updated based on the monitoring step. This is particularly useful when dealing with similar subjects whose statistics modulo the underlying proposition are the same, as such additional data will greatly enhance the performance of the overall model based on the quantum mechanical representation adopted herein.

Although the apparatus of invention can be implemented on various types of computer systems, it is preferably deployed in a computer cluster. Thus, the modules and the units that perform the outlined steps are implemented in one or in many nodes of the computer cluster. The resources required for practicing the invention, such as any non-volatile memory units for storing important data related to the quantum mechanical representations taught herein, can be conveniently embodied by local or distributed memory resources of the computer cluster in such embodiments.

The present invention, including the preferred embodiment, will now be described in detail in the below detailed description with reference to the attached drawing figures.

### BRIEF DESCRIPTION OF THE DRAWING FIGURES

FIG. 1A (Prior Art) is a diagram illustrating the basic aspects of a quantum bit or qubit.

FIG. 1B (Prior Art) is a diagram illustrating the set of orthogonal basis vectors in the complex plane of the qubit shown in FIG. 1A.

FIG. 1C (Prior Art) is a diagram illustrating the qubit of FIG. 1A in more detail and the three Pauli matrices associated with measurements.

FIG. 1D (Prior Art) is a diagram illustrating the polar representation of the qubit of FIG. 1A.

FIG. 1E (Prior Art) is a diagram illustrating the plane orthogonal to a state vector in an eigenstate along the u-axis (indicated by unit vector 12).

FIG. 1F (Prior Art) is a diagram illustrating a simple measuring apparatus for measuring two-state quantum systems such as electron spins (spinors).

FIG. 1G (Prior Art) is a diagram illustrating the fundamental limitations to finding the state vector of an identically prepared ensemble of spinors with single-axis measurements.

FIG. 1H (Prior Art) is a diagram showing a physical context of a spinor and its fermion behavior in contrast with the behavior of a boson.

FIG. 1I (Prior Art) is a diagram illustrating the behavior of a number of indistinguishable bosons in a Bose-Einstein Condensate (BEC).

FIG. 1J (Prior Art) is a diagram illustrating the behavior of two selected fermions embodied by electrons among a number of electrons inhabiting atomic orbitals.

FIG. 2 is a diagram illustrating the most important parts and modules of a computer system in a basic configuration.

FIG. 3A is a diagram showing how an underlying proposition to a transmitting subject is translated into a quantum mechanical representation of the underlying proposition in the context perceived by the transmitting subject and how the transmitting subject is assigned a transmitting subject qubit.

FIG. 3B is a diagram showing how the same underlying proposition as presented to the transmitting subject in FIG. 3A is perceived by a receiving subject in light of transmitting subject's broadcast.

FIG. 3C is a diagram illustrating how the mapping module discovers the common internal space between the transmitting and receiving subjects.

FIG. 3D is a diagram showing a joint quantum state between the transmitting and receiving subjects described by a anti-symmetric wave function obeying F-D statistics.

FIG. 3E-G are diagrams showing joint quantum states between transmitting and receiving subjects described by symmetric wave functions obeying B-E statistics.

FIG. 4 is a diagram illustrating a different embodiment of a portion of the computer system of FIG. 2 in which the mapping module makes chooses objects, subjects and experiences for underlying proposition from an inventory.

FIG. 5A is a diagram illustrating three subjects being confronted by the same proposition.

FIG. 5B is a diagram illustrating two subjects that contextualize the proposition in the same manner exhibit the phenomenon of mimetic desire.

FIG. 5C is a diagram depicting a self-interaction of the same subject with respect to the same proposition but at different times.

FIG. 6A is a diagram illustrating the use of an adjacency matrix by the prediction module

FIG. 6B is a diagram graphically indicating the situation encoded by the adjacency matrix of FIG. 6A when the first subject is the transmitting subject (corresponding to the first row in the adjacency matrix).

FIG. 7 is a diagram showing the application of large scale B-E statistics to crowds of subjects.

### DETAILED DESCRIPTION

The drawing figures and the following description relate to preferred embodiments of the present invention by way of illustration only. It should be noted that from the following discussion, alternative embodiments of the methods and systems disclosed herein will be readily recognized as viable options that may be employed without straying from the principles of the claimed invention. Likewise, the figures depict embodiments of the present invention for purposes of illustration only. One skilled in the art will readily recognize from the following description that alternative embodiments of the methods and systems illustrated herein may be employed without departing from the principles of the invention described herein.

Prior to describing the embodiments of the apparatus and methods of the present invention it is important to articulate what this invention is not attempting to imply or teach. This invention does not take any ideological positions on the nature of the human mind, nor does it attempt to answer any philosophical questions related to epistemology or ontology. The instant invention does not attempt, nor does it presume to be able to follow up on the suggestions of Niels Bohr and actually find which particular processes or mechanisms in the brain need or should be modeled with the tools of quantum mechanics. This work is also not a formalization of the theory of personality based on a correspondent qubit representation. Such formalization may someday follow, but would require a full formal motivation of the transition from Bayesian probability models to quantum mechanical ones. Formal arguments would also require a justification of the mapping between non-classical portions of human emotional and thought spaces/processes and their quantum representation. The latter would include a description of the correspondent Hilbert space, including a proper basis, support, rules for unitary evolution, formal commutation and anti-commutation relations between observables as well as explanation of which aspects are subject to entanglement with each other and the environment (decoherence) and on what time scales (decoherence time).

Instead, the present invention takes a highly data-driven approach to modeling subject states with respect to underlying propositions using pragmatic qubit assignments. The availability of “big data” that documents the online life, and in particular the online (as well as real-life) responses of subjects to various propositions including simple “yes/no” type questions, has made extremely large amounts of subject data ubiquitous. Given that quantum mechanical tests require large numbers of identically or at least similarly prepared states to examine in order to ascertain any quantum effects, this practical development permits one to apply the tools of quantum mechanics to uncover such quantum aspects of subject behaviors. Specifically, it permits to set up a quantum mechanical model of subject states and test for signs of quantum mechanical relationships and quantum mechanical statistics in the context of certain propositions that both subjects perceive.

Thus, rather than postulating any a priori relationships between different states, e.g., the Jungian categories, we only assume that self-reported or otherwise obtained/derived data about subjects and their contextualization of underlying propositions of interest is reasonably accurate. In particular, we rely on the data to be sufficiently accurate to permit the assignment of qubits to the subjects. We also assume that the states suffer relatively limited perturbation and that they do not evolve quickly enough over time-frames of measurement(s) (long decoherence time) to affect the model. Additional qualifications as to the regimes of validity of the model will be presented below at appropriate locations.

No a priori relationship between different qubits representing internal states is presumed. Thus, the assignment of qubits in the present invention is performed in the most agnostic manner possible. Prior to testing for any complicated relationships. Preferably, the subject qubit assignments with respect to the underlying proposition are first tested empirically based on historical data available for the subjects. Curation of relevant metrics is performed to aid in the process of discovering quantum mechanical relationships in the data. The curation step preferably includes a final review by human experts that may have direct experience of relevant state as well as well as experience in being confronted by the underlying proposition under investigation and the various ways in which the underlying proposition may be contextualized.

### Basic Computer System, Method Steps and Qubit Assignments

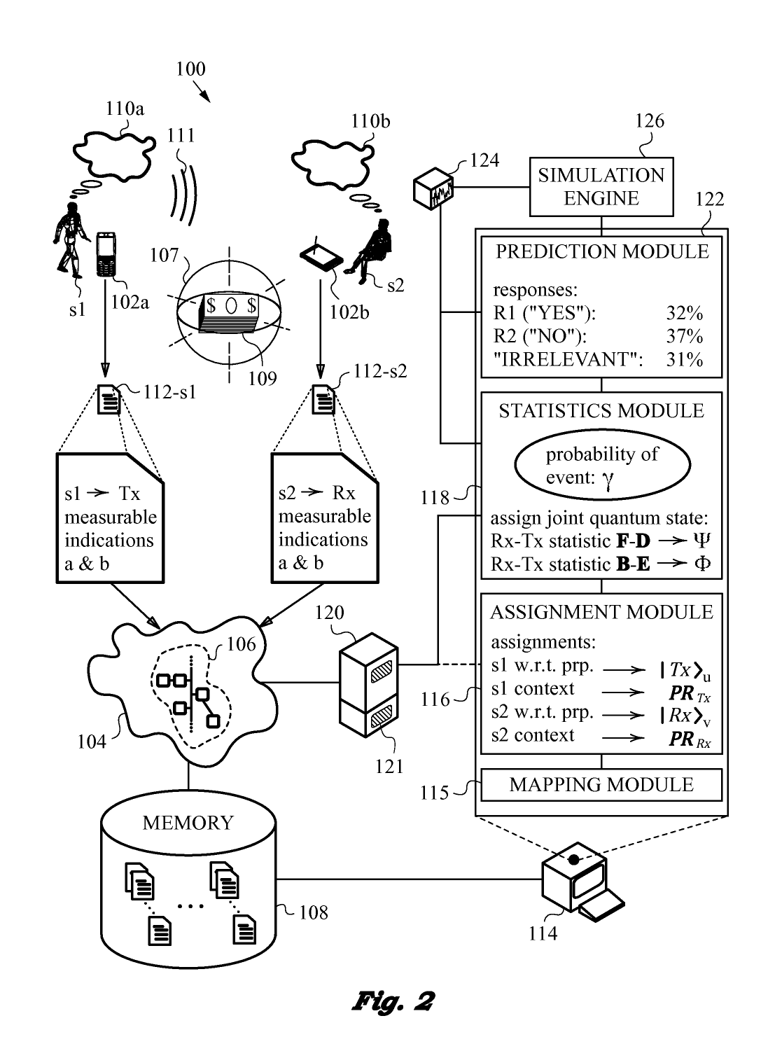

The main parts and modules of an apparatus embodied by a computer system 100 designed for predicting a joint quantum state modulo an underlying proposition involving an object, another subject or an experience are illustrated in FIG. 2. Subject s1 and subject s2 are human beings selected here from a group of many such subjects that are not expressly shown. In the subsequent description some of these additional subjects will be introduced with the same reference numeral convention—i.e., subjects s3, s4, . . . , and so forth. In principle, subjects s1, s2 can be embodied any sentient beings other than humans, e.g., animals. However, the efficacy in applying the methods of invention will usually be highest when dealing with human subjects.

Subject s1 has a networked device 102a, here embodied by a smartphone, to enable him or her to communicate data about them in a way that can be captured and processed. In this embodiment, smartphone 102a is connected to a network 104 that is highly efficient at capturing, classifying, sorting, storing and making the data available. Thus, although subject s1 could be known from their actions observed and reported in regular life, in the present case subject s1 is known from their online communications as documented on network 104.

Similarly, subject s2 has a networked device 102b, in this case a computer, and more precisely still a tablet computer with a stylus. Tablet computer 102b enables subject s2 to communicate personal data in a manner analogous to that of subject s1. For this reason, tablet computer 102b is connected to network 104 that captures the data generated by subject s2.

Network 104 can be the Internet, the World Wide Web or any other wide area network (WAN) or local area network (LAN) that is private or public. Furthermore, either one or both of subjects s1, s2 may be members of a social group 106 that is hosted on network 104. Social group or social network 106 can include any online community such as Facebook, LinkedIn, Google+, MySpace, Instagram, Tumblr, YouTube or any number of other groups or networks in which subjects s1, s2 are active or passive participants. Additionally, documented online presence of subjects s1, s2 includes relationships with product sites such as Amazon.com, Walmart.com, bestbuy.com as well as affinity groups such as Groupon.com and even with shopping sites specialized by media type and purchasing behavior, such as Netflix.com, iTunes, Pandora and Spotify. Relationships from network 106 that is erected around an explicit social graph or friend/follower model are preferred due to the richness of relationship data that augments documented online presence of subjects s1, s2.

Computer system 100 has a memory 108 for storing measurable indications a, b that correspond to a state 110a of subject s1 modulo an underlying proposition 107. In accordance with the present invention, measurable indications a, b are preferably chosen to be mutually exclusive indications, such that subject s1 cannot manifest both of them simultaneously. For example, measurable indications a, b correspond to “YES”/“NO” type responses or actions of which subject s1 can manifest just one at a time with respect to underlying proposition 107. Subject s1 also reports, either directly or indirectly about the response or action taken via their smartphone 102a.

In the first example, underlying proposition 107 is associated with a specific object 109. More precisely still, underlying proposition 107 revolves around object 109 being an apparently unclaimed stash of cash found by subject s1 under a bridge. The nature of measurable indications and contextualization of underlying proposition 107 by subject s1 will be discussed in much more detail below.

In the present embodiment, measurable indications a, b are captured in a data file 112-s1 that is generated by subject s1. Conveniently, following socially acceptable standards, data file 112-s1 is shared by subject s1 with network 104 by transmission via smartphone 102a. Network 104 either delivers data file 112-s1 to any authorized network requestor or channels it to memory 108 for archiving. Memory 108 can be a mass storage device for archiving all activities on network 104, or a dedicated device of smaller capacity for tracking just the activities of subjects of interest.

It should be pointed out that in principle any method or manner of obtaining the chosen measurable indication, i.e., either a or b, from subject s1 is acceptable. Thus, the measurable indication can be produced in response to a direct question posed to subject s1, a “push” of prompting message(s), or an externally unprovoked self-report. Preferably, however, the measurable indication is delivered in data file 112-s1 generated by subject s1. This mode enables its efficient collection, classification, sorting as well as reliable storage and retrieval from memory 108 of computer system 100. The advantage of the modern connected world is that large quantities of self-reported measurable indications of state 110a are generated by subject s1 and shared, frequently even in real time, with network 104. This represents a massive improvement in terms of data collection time, data freshness and, of course, sheer quantity of reported data.

In an analogous manner, subject s2 shares his or her choice from among two mutually exclusive measurable indications a, b of their state 110b modulo underlying proposition 107. In contrast to subject s1, however, the choice of subject s2 is made and received after subject s2 is exposed to the choice made by subject s1. As in the case of subject s1, it is preferable that subject s2 communicate their choice via tablet computer 102b by sending a corresponding data file 112-s2 to network 104. Just as in the case of the response from subject s1, the response from subject s2 may be solicited, unsolicited and either direct or indirect. In any event, data file 112-s2 is processed and stored in memory 108 to document the choice of subject s2 after exposure to the response of subject s1 to underlying proposition 107.

The exposure of subject s2 to the measurable indication chosen by subject s1 can take place in real life or online. For example, data file 112-s1 of subject s1 reporting of their choice can be sent to subject s2. This may happen upon request, e.g., because subject s2 is fiends with subject s1 in social network 106 and may have elected to be appraised of what subject s1 is up to, or it may be unsolicited. The nature of the communication can be one-to-one or one-to-many. In principle, any mode of communication between subject s1 and s2 is permissible including blind, one-directional transmission. For this reason, in the present situation subject s1 is referred to as the transmitting subject and subject s2 is referred to as the receiving subject. To more clearly indicate the direction of communication subject s1 is indicated as broadcasting their choice by a broadcast 111. Broadcast 111 need not be carried via network 104, but may occur via any medium, e.g., during a physical encounter between transmitting and receiving subjects s1, s2 or by the mere act of subject s2 observing the chosen action of subject s1.

Preferably, of course, the exposure of receiving subject s2 to broadcast 111 informing receiving subject s2 of transmitting subject's s1 response or choice of measurable indication vis-à-vis underlying proposition 107 takes place online. More preferably still, broadcast 111 is carried via network 104 or even within social network 106, if both transmitting and receiving subjects s1, s2 are members of network 106.

Computer system 100 is equipped with a separate computer or processor 114 for making a number of crucial assignments based on measurable indications a, b contained in data files 112-s1 and 112-s2. For this reason, computer 114 is either connected to network 104 directly, or, preferably, it is connected to memory 108 from where it can retrieve data files 112-s1, 112-s2 at its own convenience. It is noted that the quantum models underlying the present invention will perform best when large amounts of data are available. Therefore, it is preferred that computer 114 leave the task of storing and organizing data files 112-s1, 112-s2 as well as any relevant data files from other subjects to the resources of network 104 and memory 108, rather than deploying its own resources for this job.

Computer 114 has a mapping module 115 for finding a common internal space shared by transmitting and receiving subjects s1 and s2. Module 115 can be embodied by a simple non-quantum unit that compares records from network 104 and or social network 106 to ascertain that subjects s1, s2 are friends or otherwise in some relationship to one another. Based on this relationship and/or just propositions over which subjects s1 and s2 have interacted in the past, mapping module 115 can find the shared or common internal space. The common internal space corresponds to a realm of shared excitement, likes, dislikes and/or opinions over objects, subjects or experiences (e.g., activities). Just for the sake of a simple example, both subjects s1, s2 can be lovers of motorcycles, shoes, movie actors and making money on the stock market.

Further, computer 114 has an assignment module 116 designed for the task of making certain assignments based on the quantum representations adopted by the instant invention. Module 116 is indicated as residing in computer 114, but in many embodiments it can be located in a separate processing unit altogether. This is mainly due to the nature of the assignments being made and the processing required. More precisely, assignments related to quantum mechanical representations are very computationally intensive for central processing units (CPUs) of regular computers. In many cases, units with graphic processing units (GPUs) are more suitable for implementing the linear algebra instructions associated with assignments dictated by the quantum model that assignment module 116 has to effectuate.

Computer 114 also has a statistics module 118 designed for curating an event probability γ associated with subjects s1, s2 and for assigning a joint quantum state to subjects s1, s2. Since initial event probability γ will typically be derived from large numbers of statistical data about subjects s1, s2 from network 104 and/or adjusted by a skilled human curator, module 118 may in certain embodiments be a separate unit that is not even geographically collocated with computer 114. In many cases, statistics modules 118 that perform classical modeling of subject behaviors can be adapted for this purpose. On the other hand, the task of assigning the joint quantum state is not a part of classical modeling. It is again taxing on computational resources and thus indicates that implementation of module 118, whether remote or local, should preferably include one or more GPUs.

Event probability γ typically includes some “classical” probabilities for receiving subject s2 to receive and be influenced by broadcast 111 of transmitting subject s1. In other words, mere reception of broadcast 111 is not sufficient. Reception needs to be accompanied by a sufficient engagement to evoke a response in receiving subject s2. Hence, the form of broadcast 111, if transmitted through network 104 and within control of the designer of system 100, should be such as to increase event probability γ. Information on proper formulations, messaging and timing, usually complied by online marketing engines and other sources in conjunction with marketing campaigns and sending out of solicitations (sometimes referred to as “lures”) is thus very useful for the present invention. In fact, in a preferred embodiment, statistics module 118 is integrated with a classical online marketing engines and database to aid in the most effective and attractive formatting, presentation and delivery of broadcast 111.

Preferably, computer system 100 has a network behavior monitoring unit 120. Unit 120 monitors and tracks network behaviors and communications of subjects including transmitting and receiving subjects s1, s2 that are on network 104 or even members of specific social groups 106. Thus, unit 120 can process data from data files 112 of many subjects connected to network 104 and discern large-scale patterns. Advantageously, statistics module 118 is therefore connected to network behavior monitoring unit 120 to obtain from it information that can aid it in maintaining the best estimate of event probability γ.

Further, computer system 100 has a quantum exchange monitor 121. Monitor 121 is designed to provide an estimation of a quantum exchange energy or its analogue between transmitting subject s1 and receiving subject s2. This estimate depends on qubit assignments and expected joint quantum state as discussed in detail below. For now we note that the exchange energy is a general measure of the difference between the reactions of subjects s1, s2 under role reversal. Such information can be deduced or even computed from historical data of past responses to similar underlying propositions by subjects s1, s2. Because quantum-based assignments made by statistics module 118 may need to be adjusted based on the quantum exchange energy estimated by monitor 121, it is important that monitor 121 have a communication link to statistics module 118 and also to assignment module 116. It is for this reason that the designer of system 100 will find it advantageous to connect or even integrate monitor 121 with unit 120. In the embodiment shown in FIG. 2, unit 120 and monitor 121 are joined and both connected to statistics module 118 as well as assignment module 116, as indicated by the dashed connection.

Computer system 100 is further provisioned with a prediction module 122 for predicting a most probable response of receiving subject s2 based on the joint quantum state with transmitting subject s1 assigned by statistics module 118. Again, response is modulo underlying proposition 107. Hence, it has the two mutually exclusive responses labeled here as R1, R2 that go with measurable indications a, b. In practice, responses R1, R2 can be, for example, “YES” and “NO”. In some cases a null response or non-response generally indicated as “IRRELEVANT” can also be predicted.

Prediction module 122 can reside in computer 114 or it can be a separate unit. For reasons analogous to those affecting assignment module 116, prediction module 122 can benefit from being implemented in a GPU with associated hardware well known to those skilled in the art. Irrespective of its hardware implementation, module 122 is connected to both assignment module 116 and statistics module 118 in order to be able to generate its predictions.

Computer system 100 has a random event mechanism 124 connected to both statistics module 118 and prediction module 122. From those modules, random event mechanism can be seeded with certain estimated quantum probabilities as well as other statistical information, including classical probabilities that affect event probability γ to randomly generate events in accordance with those probabilities and statistical information. Advantageously, random event mechanism 124 is further connected to a simulation engine 126 to supply it with input data. In the present embodiment simulation engine 126 is also connected to prediction module 122 to be properly initialized in advance of any simulation runs. The output of simulation engine 126 can be delivered to other useful apparatus where it can serve as input to secondary applications such as large-scale prediction mechanisms for social or commercial purposes or to market analysis tools and online sales engines. Furthermore, simulation engine 126 is also connected to network behavior monitoring unit 120 in this embodiment in order to aid unit 120 in its task in discerning patterns affecting subjects s1, s2 or other subjects based on data passing through network 104.

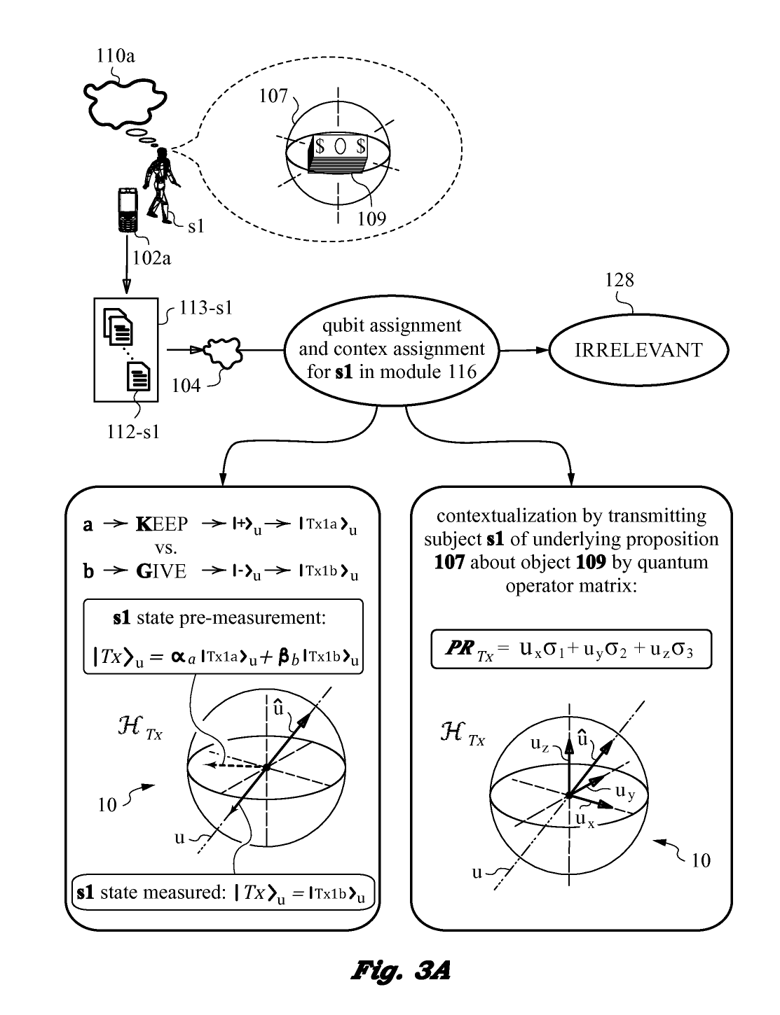

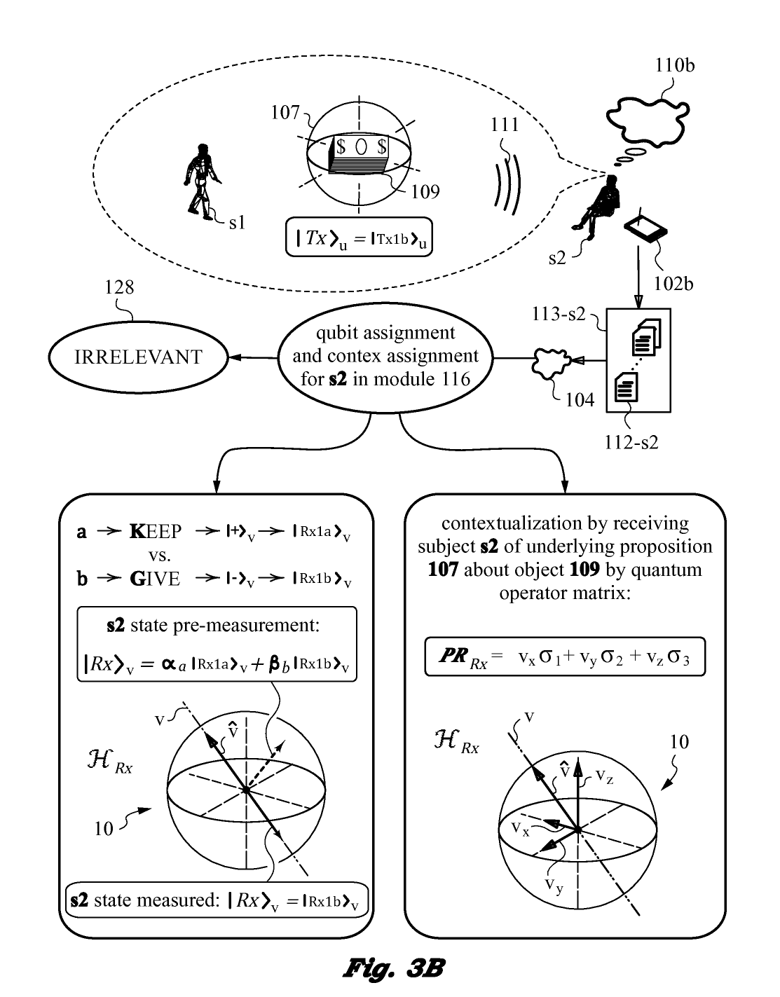

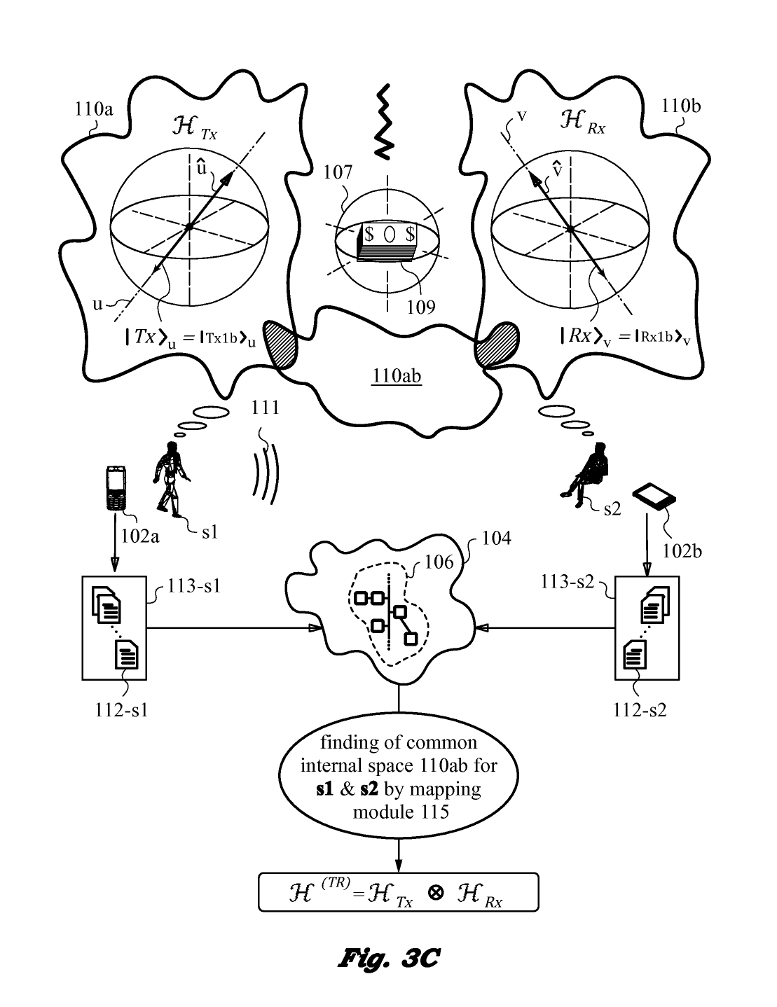

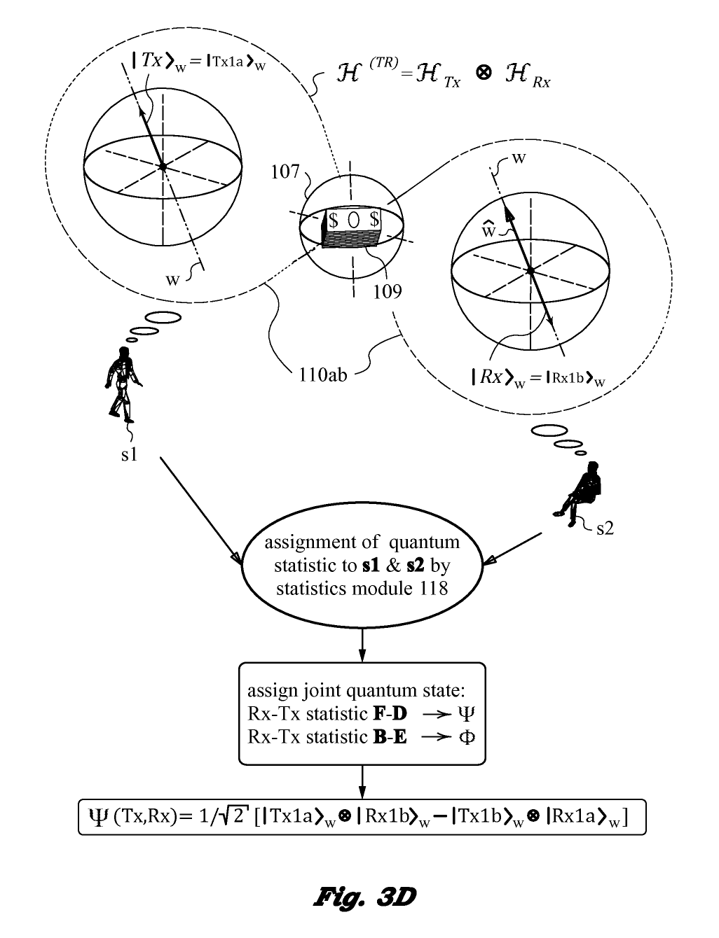

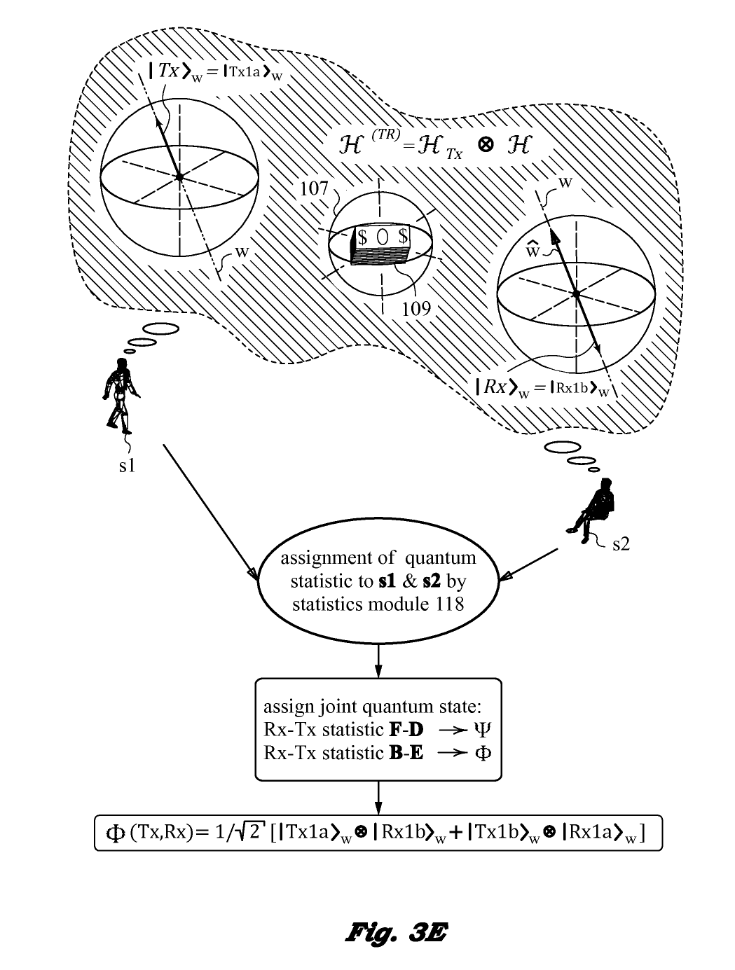

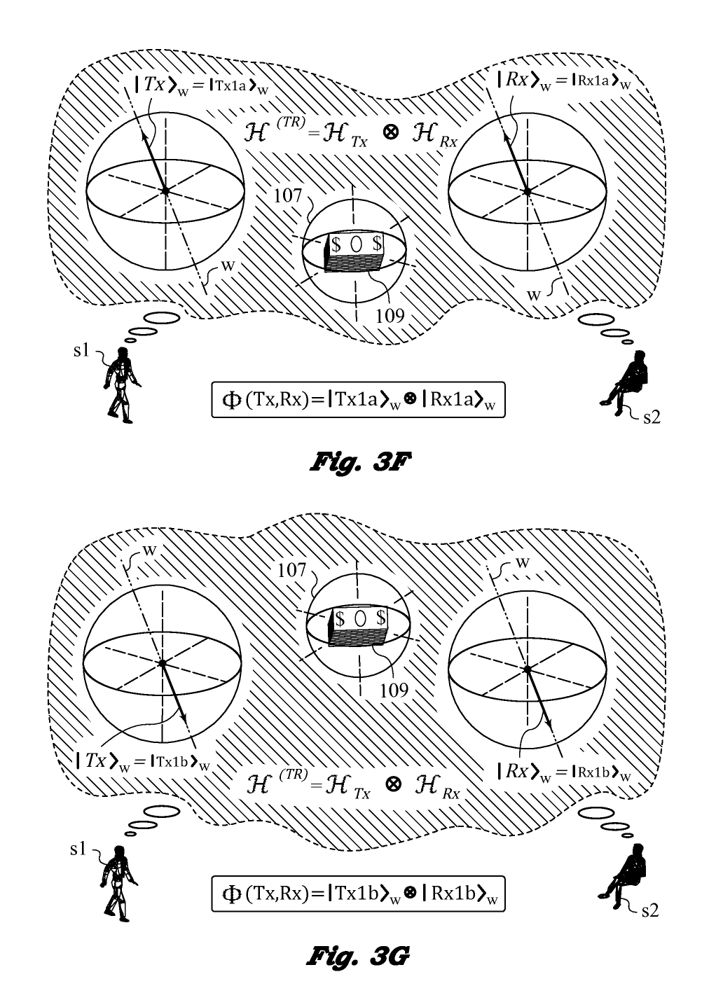

We will now examine the operation of computer system 100 based initially on the diagrams in FIG. 2 and FIGS. 3A-G. First, we consider data file 112-s1 from transmitting subject s1 and the measurable indications a, b it contains. It will be assumed that transmitting subject s1 and data file 112-s1 are representative of other situations in which another subject, say sx broadcasts to other receiving subjects and the broadcast is disseminated via data files. However, using a single transmitting subject s1 sending their broadcast 111 via their data file 112-s1 to a single receiving subject s2 is useful to consider first for pedagogical reasons.

Computer 114 typically procures data file 112-s1 from memory 108 after it has been time-stamped and archived there. In this way, computer 114 is not tasked with monitoring online activities of various subjects, including transmitting subject s1, which is the purview of network behavior monitoring unit 120.

Data file 112-s1 either contains actual values and choice of measurable indication from among measurable indications a, b or information from which measurable indications a, b and the choice can be derived or inferred. In the easier case, transmitting subject s1 has explicitly provided measurable indications a, b and their choice through unambiguous self-report, an answers to a direct question, a response to a questionnaire, a result from a tests, or through some other format of conscious or even unconscious self-report. To elucidate the latter, transmitting subject s1 may provide a chronological stream of data in multiple data files 112-s1. Such data files 112-s1 can be a series of postings on social network 106 (e.g., Facebook) where receiving subject s2 is a friend of transmitting subject s1. For example, since underlying proposition 107 is about money 109, the series of posts from transmitting subject s1 may read as follows:

1) “I can't believe the amount of cash I found under the bridge”;
2) “could do a lot of good with that money”;
3) “got to give it to my favorite charity”; and
4) “did it today—boy were they happy!”.

In this case, the sequence of posts actually corresponds to piece-wise broadcast 111 transmitted and received by receiving subject s2 through network 104 (and more particularly still, through social network 106).

For two opposite measurable indications such as a standing for “Take the money” and b standing for “Give the money away”, the stream of files 112-s1 with postings can clearly be used to infer the measurable indication. Namely, the measurable indication here is b, or “Give the money away” to a charity. In the preferred mode of operation, network behavior monitoring unit 120 reviews stream of broadcast data files 112-s1 from transmitting subject s1 self-reporting on social network 106 without involving computer 114. Unit 120 by itself determines the occurrence of measurable indications a, b. It can then attach metadata to files 112-s1 stored in memory 108 or otherwise communicate to computer 114 the measurable indication a or b, that was manifested by transmitting subject s1. In other words, computer 114 can obtain processed data files 112-s1 already indicating the measured indication (a or b).

Operating in this mode network behavior monitoring unit 120 can curate what we will consider herein to be estimated quantum probabilities pₐ, Pb for the corresponding measurable indications a or b. These are the probabilities of observing the transmitting subject s1 yield measurable indications a, b in response to a quantum measurement or an act of observation modulo underlying proposition 107. This information can be useful for better tuning and assignment of quantum descriptors, as will be discussed below. Of course, a human expert curator or other agent informed about the human meaning of the posts provided by transmitting subject s1 should be involved in setting the parameters on unit 120 and also verifying the measurement in case the derivation of the measurable indication actually generated is elusive or not clear from the posts. Such review by an expert human curator will ensure proper derivation of estimated quantum probabilities pₐ, p_{b}. Appropriate human experts may include psychiatrists, psychologists, counselors and social workers with relevant experience.

In simple cases, measurable indications a, b are such that they present unambiguously in data files 112-s1 and inference is not required. Under these conditions the use of unit 120 to curate estimated quantum probabilities pₐ, p_{b} may even be superfluous. Unambiguous data can be represented by direct answers or honest self-reports of measurable indications a, b by transmitting subject s1. Alternatively, such data can present as network behaviors of unambiguous meaning, reported real life behaviors as well as strongly held opinions, beliefs or mores that dictate responses or actions. Since relatively pure quantum states are presumed for internal subject states, it is important that self-reports be unaffected by 3^{rd} parties and untainted by processing that involves speculative assignments going beyond curation of estimated quantum probabilities pₐ, p_{b} for transmitting subject s1.

In some embodiments computer 114 may itself be connected to network 104 such that it has access to documented online presence and specifically broadcast 111 of transmitting subject s1 in real time. Computer 114 can then monitor the state and online actions of transmitting subject s1 without having to rely on archived data from memory 108. Of course, when computer 114 is a typical local device, this may only be practicable for tracking a few very specific subjects or when tracking subjects that are members of a relatively small social group 106 or other small subgroups of subjects of known affiliations.

We now turn to the diagram in FIG. 3A to gain an appreciation for the type of underlying proposition that qualifies in the sense of the present invention and is thus fit for processing by computer system 100. For explanatory purposes, FIG. 3A shows specific underlying proposition 107 that is about object 109, namely the stash of cash already introduced above. In this example, underlying proposition 107 about object 109 presents with a choice between at least two mutually exclusive measurable indications a, b namely “Keep” and “Give”. In most practical cases, these indications will be treated herein as mutually exclusive responses (which may from time to time be referred to as responses R1, R2) that transmitting subject s1 can make with respect to object 109 at the center of underlying proposition 107.

Measurable indications a, b may transcend the set of mutually exclusive responses that can be articulated in data files 112-s1 or otherwise transmitted by a medium carrying broadcast 111. Such indications can include actions, choices between non-communicable internal responses, as well as any other choices that transmitting subject s1 can make but is unable to communicate about externally. Because such choices are difficult to track, unless transmitting subject s1 is under direct observation by another human that understands them, they may not be of practical use in the present invention. On the other hand, mutually exclusive responses that can be easily articulated by transmitting subject s1 are suitable in the context of the present invention.

In the present example, proposition 107 has two of the more typical opposite indications a, b expressed by a “Keep” (or first response R1) and an opposite “Give” (or second response R2). In general, mutually exclusive measurable indications or responses can also be opposites such as “high” and “low”, “left” and “right”, “buy” and “sell”, “near” and “far”, and so on. Proposition 107 may evoke actions or feelings that cannot be manifested simultaneously, such as liking and disliking the same item at the same time, or performing and not performing some physical action, such as buying and not buying an item at the same time. Frequently, situations in which two or more mutually exclusive responses are considered to simultaneously exist lead to nonsensical or paradoxical conclusions. Thus, in a more general sense mutually exclusive responses in the sense of the invention are such that the postulation of their contemporaneous existence would lead to logical inconsistencies and/or disagreements with fact.

In addition to the at least two mutually exclusive responses the model adopted herein presumes the possibility of a null response 128. Null response 128 expresses an irrelevance of proposition 107 to transmitting subject s1 after his or her engagement with it or exposure thereto. In other words, null response 128 indicates a failure of engagement by transmitting subject s1 with proposition 107. Null response 128 is assigned a classical null response probability pₙᵤₗₗ. As already noted above, this probability does affect event probability γ monitored by statistics module 118. In the present case null response 128 corresponds to transmitting subject s1 leaving object 109 at center of proposition 107 alone.

More generally, null response 128 to proposition 107 can be any non-sequitur response or action. The irrelevance of proposition 107 may be attributable to any number of reasons including inattention, boredom, forgetfulness, deliberate disengagement and a host of other factors. Experienced online marketers sometimes refer to such situations in their jargon as “hovering and not clicking” by intended leads that have been steered to the intended advertising content but fail to click on any offers. Whenever after exposure to proposition 107 transmitting subject s1 reacts in an unanticipated way, no legitimate response can be obtained modulo proposition 107 and the model or any simulation using the model has to take these “non-results” into account with classical null response probability pₙᵤₗₗ.

FIG. 3A also shows the details of a quantum representation of state 110a of transmitting subject s1 in accordance with the invention. Since subject s1 experiences state 110a upon confrontation with underlying proposition 107 associated with unclaimed cash 109, this experience is considered to be an internal subject state. As such, the quantum mechanical representation of the present invention calls for the experience of state 110a to be assigned to a quantum mechanical bit or qubit. As indicated in the diagram, this is done by assignment module 116.

Assignment module 116 uses data from a stream 113-s1 of data files 112-s1 collected from transmitting subject s1 via network 104. Stream 113-s1 is transmitted by transmitting subject s1 using smartphone 102a and includes in this particular example the sequence of four posts listed above. It is based on these posts contained in stream 113-s1 that module 116 assigns a qubit to transmitting subject s1. It is important to review this step in two stages: pre-measurement and post-measurement or measured.

The first three posts from the series contained in stream 113-s1 indicate that transmitting subject s1 is making up their mind. In other words, initial three posts in stream 113-s1 reflect thoughts about underlying proposition 107. It is the fourth and last post in stream 113-s1 stating “did it today—boy were they happy!” that indicates the subject's choice. This choice to give the money to charity, which we presume for the time being is not fake, corresponds in accordance with the quantum representation chosen herein to a quantum measurement. Even though the present application will focus on the measured stage and consider it in predicting joint quantum states, it is important to first look at the pre-measurement stage.

During the pre-measurement stage state 110a is already represented by the qubit. That qubit is selected to model state 110a, which is an internal state of subject s1 that admits of two possible mutually exclusive responses Keep/Give. In other words, the measurable indications a, b of this internal state 110a are: a→Keep action or response, b→Give action or response. To further simplify matters, it will be assumed in this example that subject s1 honestly self-reported with each posting. Subject s1 then shared it on network 104 from their smartphone 102a in the form of stream 113-s1 which was processed and sent to archives in memory 108 by network monitoring unit 120 (also see FIG. 2).

Upon receipt of data files 112-s1 that make up stream 113-s1 from memory 108 or, in some cases directly via network 104, assignment module 116 assigns internal state 110a of subject s1 to transmit subject qubit |Tx [symbol] . Transmit subject qubit |Tx [symbol] is placed in a transmit subject Hilbert space [symbol] _{Tx} according to the conventions of quantum mechanics. For visualization purposes, transmit subject qubit |Tx [symbol] is shown on Bloch sphere 10 in the representation already reviewed in the background section. Transmit subject qubit |Tx [symbol] is conveniently expressed in a u-basis decomposition into two orthogonal subject state eigenvectors |Tx1a [symbol] ᵤ, |Tx1b [symbol] ᵤ with two corresponding subject state eigenvalues λₐ, λ_{b}. To indicate the chosen decomposition transmit subject qubit |Tx [symbol] ᵤ is affixed with subscript “u” in the drawing figure. By the rules of quantum mechanics, the eigenvalues λₐ, λ_{b} are taken to stand for measurable indications a, b, that are mapped to specific measurable indications of Keep, Give of primary internal state 110a of transmitting subject s1.

At this juncture it should be remarked, that we are using the two-level system because, despite its simplicity, it contains all of the important features of quantum mechanical models. However, this is not to be interpreted as limiting the applicability of the apparatus and methods of invention to two-state systems. In fact, if the human state space is determined to require representation in higher dimensional Hilbert spaces, then correspondent qubits based on three-, four- or still higher-level systems can be recruited. These types of system are available and well understood by skilled artisans practiced in the art of quantum mechanical modeling.

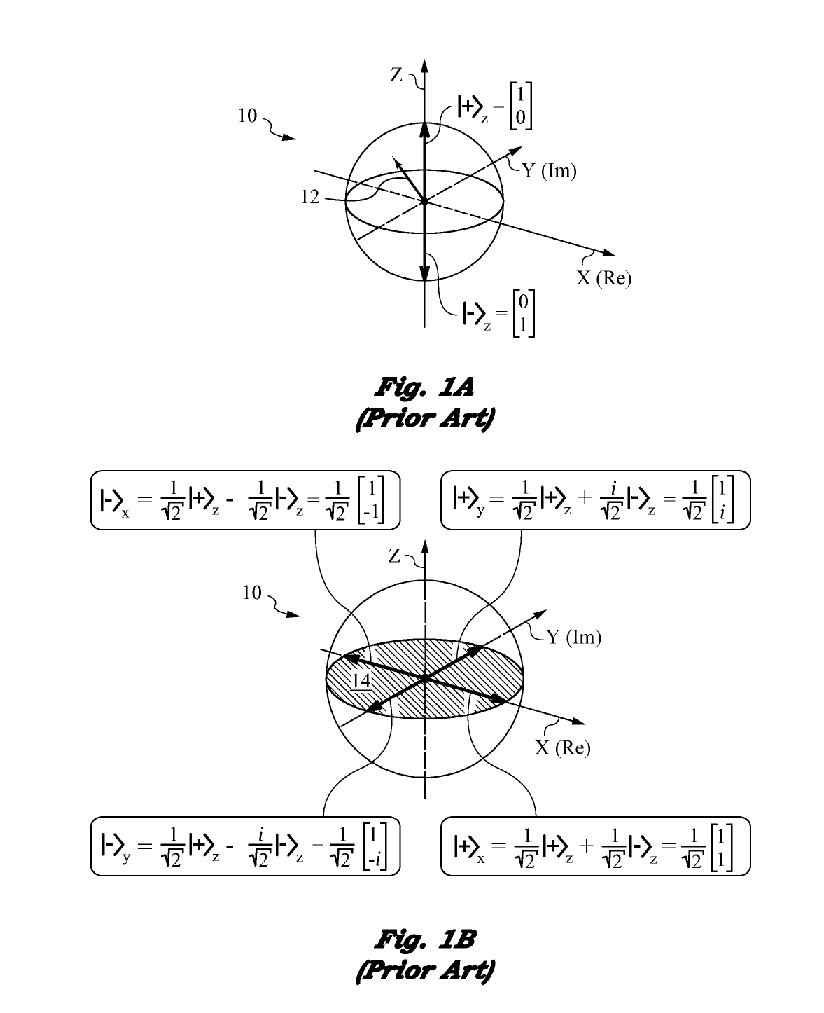

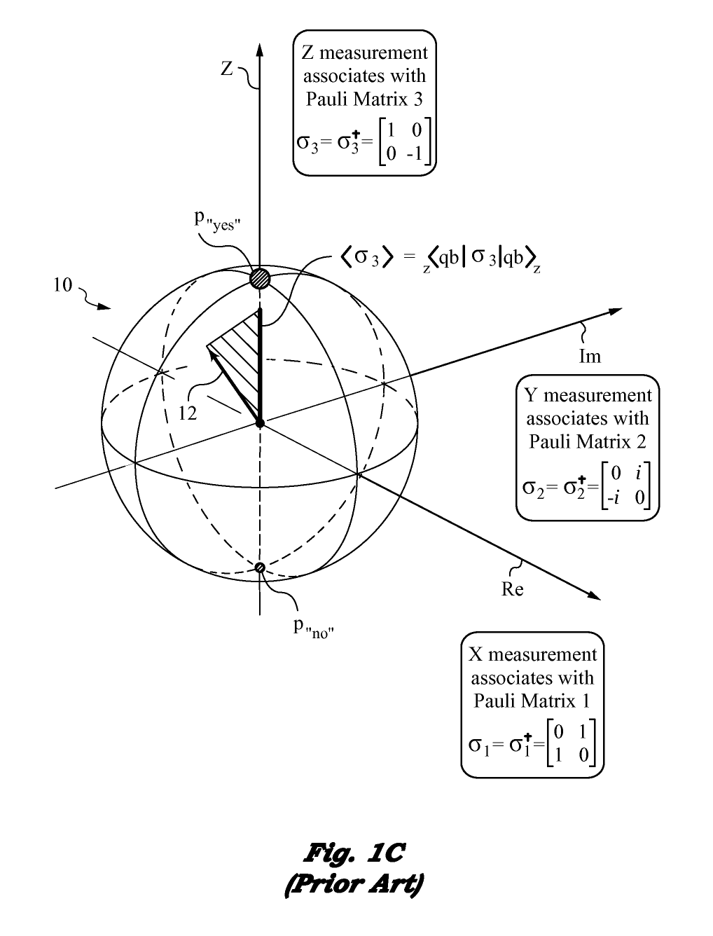

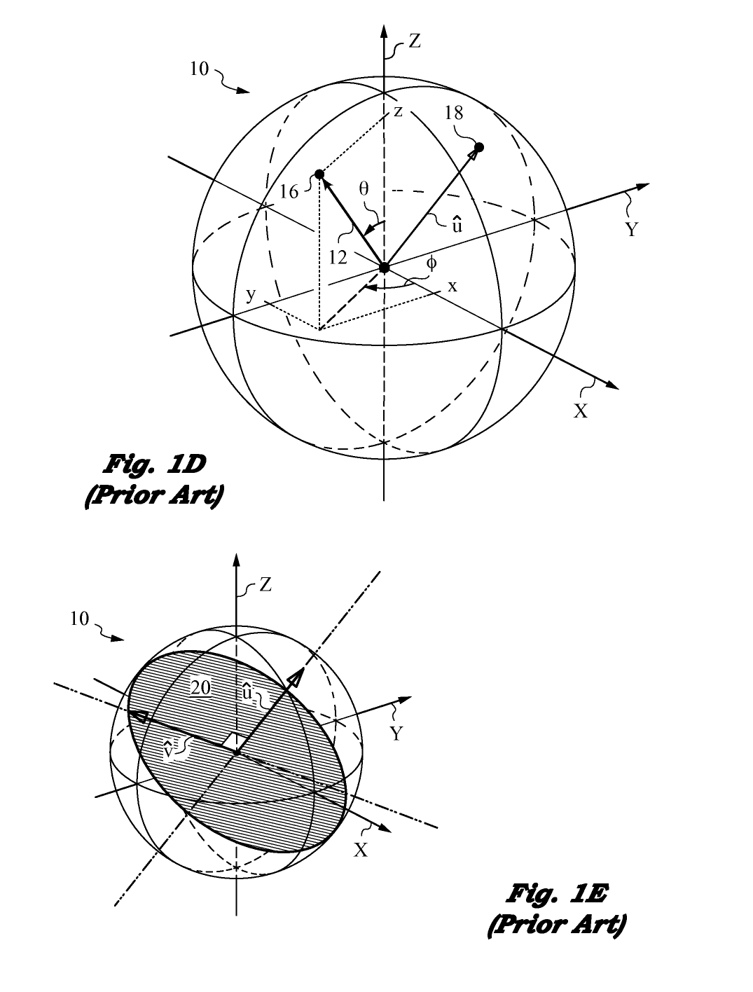

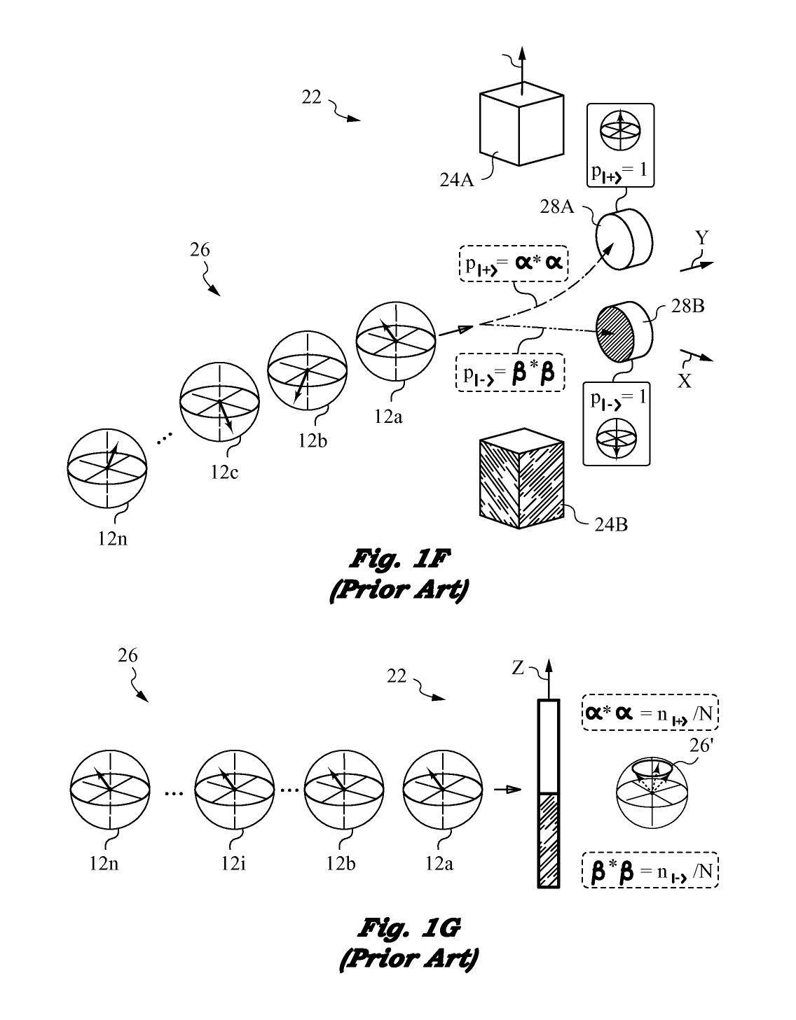

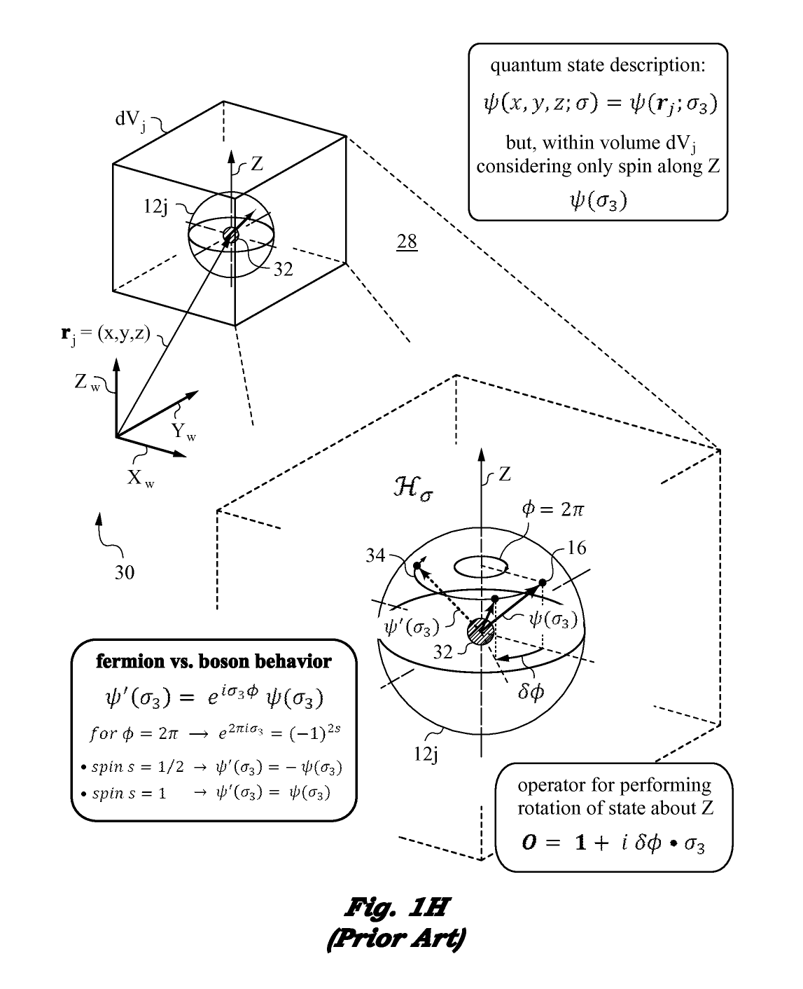

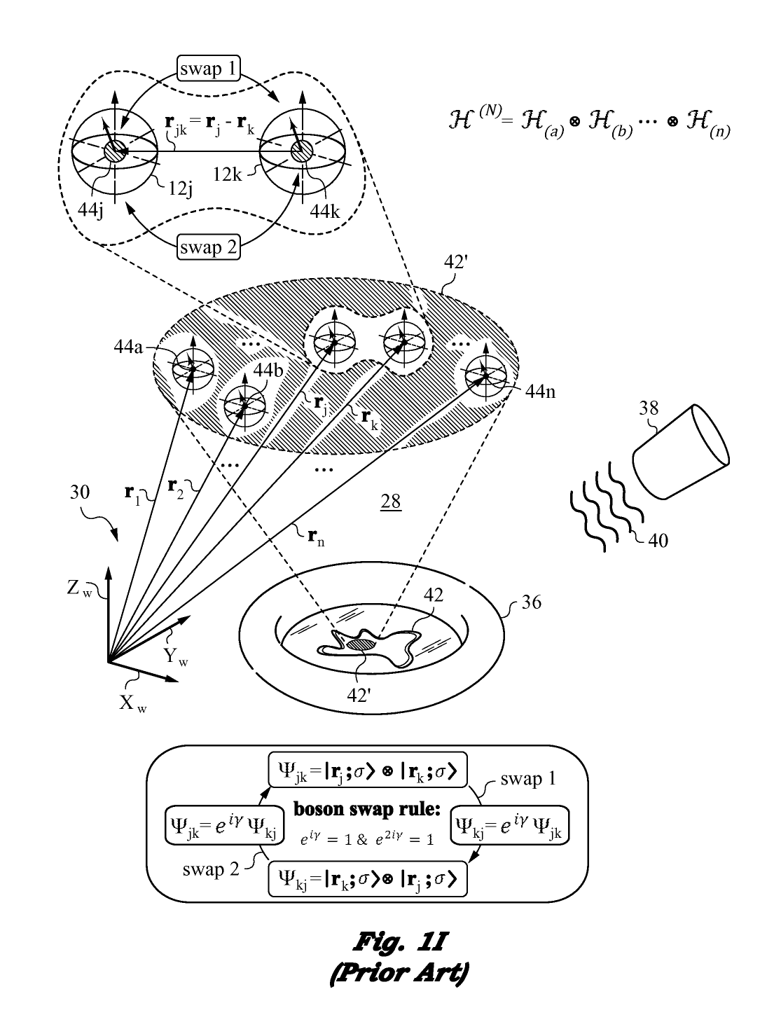

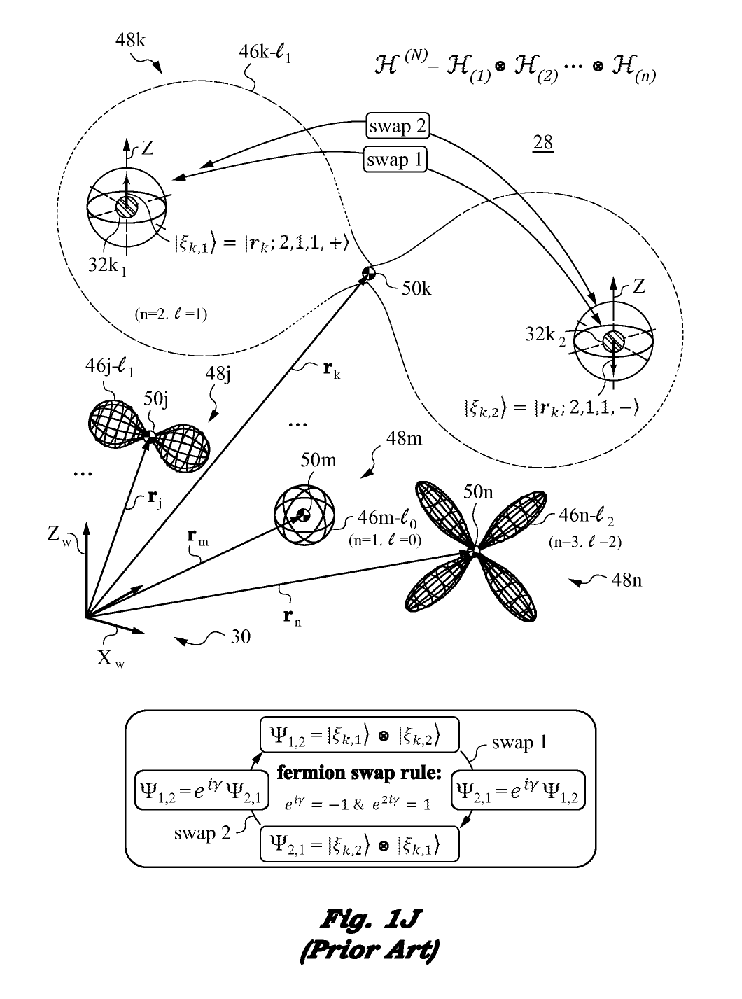

In our present practice, the chosen representation is a dyadic internal state 110a, where the two mutually exclusive parts of that state, namely Keeper and Giver, map to the mutually exclusive eigenvectors of spin-up and spin-down. In other words, states Keeper and Giver are mapped to the state vectors |+ [symbol] ᵤ and |− [symbol] ᵤ in the u-basis as defined by unit vector û in FIG. 1E. Here, Keeper is mapped to eigenvector |+ [symbol] ᵤ, while Giver is mapped to eigenvector |+ [symbol] ᵤ. To the extent that Bloch sphere 10 is used for representing qubit assignments and other aspects of the invention including “unit vectors”, the reader is again reminded that it serves for the purposes of better visualization (recall the limitations of quantum bit representations in real 3-dimensional space discussed in the background section).

The Bloch-sphere assisted representation of the assignment of transmit subject qubit |Tx [symbol] ᵤ in the u-basis is shown in detail in the lower left portion of FIG. 3A. Specifically, transmit subject qubit |Tx [symbol] ᵤ is visualized in Bloch sphere 10 and its decomposition over the eigenvector states |+ [symbol] ᵤ and |− [symbol] ᵤ is also indicated. The decomposition is similar to the decomposition of any qubit (see Eq. 7), but to properly reflect the fact that we are dealing with transmit subject qubit |Tx [symbol] ᵤ corresponding to internal subject state 110a of transmitting subject s1 the naming convention of the eigenvectors is changed to:

|Tx [symbol] ᵤ=αₐ|Tx1a [symbol] ᵤ+β_{b}|Tx1b [symbol] ᵤ. Eq. 25a

In adherence to the quantum mechanical model, the two subject state vectors |Tx1a [symbol] ᵤ, |Tx1b [symbol] ᵤ are accepted into the model along with their two corresponding subject state eigenvalues λₐ, λ_{b}.

Given the physical entity on which transmit subject qubit |Tx [symbol] ᵤ is based, namely either a fermion or a boson, the eigenvalues are either integral or half-integral. In the simplest case they are 1 and −1 or ½ and −½. Differently put, eigenvalue λₐ=1 (or ½) associates with Keeper internal state |Tx1a [symbol] ᵤ. Meanwhile, eigenvalue λ_{b}=−1 (or −½) associates with Giver internal state |Tx1b [symbol] ᵤ. Thus measurable indication a→Keep goes with spin-up along û (1) or state |Tx1a [symbol] ᵤ for human transmitting subject s1. Measureable indication b→Give goes with spin-down along û (−1) or state |Tx1b [symbol] ᵤ for human transmitting subject s1.

Internal state 110a expressed by transmit subject qubit |Tx [symbol] ᵤ indicated by the dashed arrow is not along either of the two eigenstates |Tx1a [symbol] ᵤ, |Tx1b [symbol] ᵤ. Still, measurable indications or responses a, b do correspond to “Keeper action or response” such as “Keep”, and “Giver action or response” such as “Give”. The reason for not simply equating measurable indications or responses a, b with internal states or eigenstates “Keeper”, “Giver” into which transmit subject qubit |Tx [symbol] ᵤ decomposes is because indications or responses are measurable quantities. These are in fact the physically observable actions or responses transmitting subject s1 exhibits; such as giving money 109 away to charity. Hence, actions or responses a, b must map to observable eigenvalues and not eigenvectors, which are not physically observable. The latter are assigned to unobservable quantum mechanical state vectors in the spectral decomposition of transmit subject qubit |Tx [symbol] ᵤ; i.e., subject states |Tx1a [symbol] ᵤ, |Tx1b [symbol] ᵤ.

In accordance with the projection postulate of quantum mechanics, measurement modulo proposition 107 will cause transmit subject qubit |Tx [symbol] ᵤ, to “collapse” to just one of the two states or eigenvectors |Tx1a [symbol] ᵤ, |Tx1b [symbol] ᵤ. Contemporaneously with the collapse, transmitting subject s1 will manifest the eigenvalue embodied by the measurable action or response, a or b, associated with the correspondent eigenvector to which transmit subject qubit |Tx [symbol] ᵤ collapsed. Under a test situation, such as the one posed before transmitting subject s1 by underlying proposition 107 about unclaimed cash 109, there is an unambiguous distinction between Keeper response and Giver response.

A typical Keeper indication or response a is to unambiguously, e.g., as defined by social norms and conventions, keep money 109 for themselves. This also means that at the time indication a of taking of money 109 by transmitting subject s1 were measured, the internal state of transmitting subject s1 would have “collapsed” to transmit subject state vector |Tx1a [symbol] ᵤ. Meanwhile, under the same test situation that unambiguously distinguishes between Keeper and Giver response, indication or response b of giving away money 109 corresponds clearly to the response of a Giver.

In our case, transmitting subject s1 chose the giver response b by giving money 109 to charity. In pursuing the explanation suggested by quantum mechanics, this means that at the time indication b was measured on the fourth post in stream 113-s1 of data files 112-s1, the internal space, awareness, thought or any ethical considerations, all of which are pragmatically reduced and assigned to internal state 110a of transmitting subject s1 in the present quantum representation, was “collapsed” to subject state vector |Tx1b [symbol] ᵤ. This projection means that the new state 110a after the fourth post is represented by measured transmit subject qubit |Tx [symbol] ᵤ containing just the subject state vector |Tx1b [symbol] ᵤ, or simply put:

|Tx [symbol] ᵤ=|Tx1b [symbol] ᵤ. Eq. 25b

By contrast, during the first three posts in stream 113-s1, internal state 110a of transmitting subject s1 was still represented by the full, “un-collapsed” state vector or transmit subject qubit |Tx [symbol] ᵤ as indicated by the dashed arrow and as described by Eq. 25a.

Despite the potential suggestive nature of the quantum mechanical representation for the internal states of the human mind, we reiterate here that the present invention does not presume to produce a formal mapping for those. Instead, the present invention is an agnostic application of the tools offered by quantum mechanical formalisms to produce a useful approach of practical value.

Since transmit subject qubit |Tx [symbol] _{y} is expressed in the chosen u-basis decomposition as |Tx [symbol] ᵤ=αₐ|Tx1a [symbol] ᵤ+β_{b}|Tx1b [symbol] ᵤ (see Eq. 25a) where αₐ and β_{b} are the complex coefficients characteristic of this spectral decomposition, it is easy to mathematically express quantum probabilities pₐ, p_{b} of the two outcomes. Specifically, referring back to Eq. 3, the quantum probabilities are just pₐ=αₐ*αₐ and p_{b}=β_{b}*β_{b}. In embodiments where network behavior monitoring unit 120 (see FIG. 2) is used for curating estimated quantum probabilities pₐ, p_{b}, these are now taken to be equal to the complex coefficient norms αₐ*αₐ and β_{b}*β_{b}. It is the norms that express the probabilities of observing internal state 110a of transmitting subject s1 yield measurable indications a, b (Keep, Give) in response to a quantum measurement or, more mundanely put, the act of observation of internal state 110a induced by confrontation with underlying proposition 107 about unclaimed money 109. (Although a rigorous approach might introduce a “hat” or other mathematical notation to differentiate between estimates of probabilities \hat{p}ₐ, \hat{p}_{b} and their actual values pₐ, p_{b}, this degree of sophistication will not be practiced herein. It is important, however, that a skilled practitioner keep the distinction in mind to avoid making common mistakes in implementing the apparatus and methods of the invention.)

We note here, that unlike the classical descriptions, the present quantum representation necessarily hides the complex phases of complex coefficients αₐ, β_{b}. In other words, an important aspect of the model remains obscured. Yet, we can confirm the values of the probabilities by observation. For example, by performing several measurements of the same measurable indications a, b on a number of subjects with the same measurable indications a, b as transmitting subject s1. In the language of quantum mechanics, we are just re-measuring quantum states |Tx1a [symbol] ᵤ, |Tx1b [symbol] ᵤ that are mapped to Keeper, Giver and yield measurable indications a, b with the quantum probabilities pₐ, p_{b}, respectively.

The hidden information contained in the complex phases of coefficients αₐ, β_{b} is a benign aspect of the quantum model for as long as we are considering the same internal state 110a from the same vantage point. In the language of quantum mechanics, complex phases will not become noticeable until we choose to look at subject s1 and their measurable indications of internal state 110a in a different basis (i.e., not in the u-basis shown in FIG. 3A but in some basis where the mutually exclusive states in terms of which internal state 110a is described are, say: Saver, Spender). The reader is invited to review FIG. 1G and associated description in the background section to appreciate the reasons for this. Further issues having to do with a change of basis with respect to the underlying proposition are treated below.

As depicted in FIG. 3A, assignment module 116 also performs another assignment dictated by the quantum model adopted herein by generating a transmit subject proposition matrix PR_{Tx}. Matrix PR_{Tx} is the quantum mechanical representation of underlying proposition 107 about cash 109 as it presents itself to transmitting subject s1. That means that matrix PR_{Tx} must account for the transmit subject context in which transmitting subject s1 views underlying proposition 107. This is done by ensuring that its two eigenvectors are just the two mutually exclusive states |Tx1a [symbol] ᵤ, |Tx1b [symbol] ᵤ in the u-basis.

In the quantum mechanical representation, it is the application of transmit subject proposition matrix PR_{Tx} to transmit subject qubit |Tx [symbol] ᵤ that causes the “collapse” to one of the eigenvectors |Tx1a [symbol] ᵤ, |Tx1b [symbol] ᵤ. The latter are paired with their eigenvalues that correspond to the two mutually exclusive measurable indications or responses a, b that subject s1 can manifest when confronted by proposition 107. Simply put, the quantum mechanical model adapted herein suggests that between post three and post four in stream 113-s1 transmit subject qubit |Tx [symbol] ᵤ that stands for transmitting subject s1 is acted upon by transmit subject proposition matrix PR_{Tx}. Under this action, transmit subject qubit |Tx [symbol] ᵤ collapses to state |Tx1b [symbol] ᵤ simultaneously yielding eigenvalue b which manifests in real life by transmitting subject s1 giving away money 109 that he or she found unclaimed under the bridge.

More formally, transmit subject proposition matrix PR_{Tx} is intended for application in transmit subject Hilbert space [symbol] _{Tx}. In the process of collapsing the wavepacket (see projection postulate in background section) the action of matrix PR_{Tx} will extract the real eigenvalue corresponding to the response eigenvector to which transmit subject qubit |Tx [symbol] ᵤ collapsed under measurement. Immediately after measurement response qubit |Tx [symbol] ᵤ will be composed of just the one response eigenvector to which it collapsed with quantum probability equal to one. In other words, immediately after measurement for a time period T during which no appreciable change can take place (i.e., no decoherence through interaction with the environment or unitary evolution) we can only have either |Tx [symbol] ᵤ=|Tx1a [symbol] ᵤ for sure, or |Tx [symbol] ᵤ=|Tx1b [symbol] ᵤ for sure.

The quantum mechanical prescription for deriving the proper operator or transmit subject proposition matrix PR_{Tx} has already been presented in the background section in Eq. 13. To accomplish this task, we require knowledge of the decomposition of unit vector û into its x-, y- and z-components as well as the three Pauli matrices σ₁, σ₂, σ₃. By standard procedure, we then derive proposition matrix PR as follows:

PR_{Tx}=û· σ̅=uₓσ₁+u_{y}σ₂+u_{z}σ₃, Eq. 26a

where the components of unit vector û (uₓ,u_{y},u_{z}) are shown in FIG. 3A for more clarity.

Armed with the quantum mechanical representation thus mapped, many computations and estimations can be undertaken. The reader is referred to the co-pending application Ser. No. 14/128,821 filed on 17 Feb. 2014 for further teachings about the extension of the present quantum representation to simple measurements. Those teachings also encompass computation of outcome probabilities in various bases with respect to different propositions typically presented to just one subject. The teachings partly rely on trying to minimize the effects from interactions between the environment and the qubit that stands in for the subject of interest. The present teachings, however, will now depart from the direction charted in the aforementioned co-pending application. Instead, we will now focus on the relationship and behavior of wave functions of two or more subjects vis-à-vis an underlying proposition.

The main thrust of the present invention is to take advantage of the existence of common or joint quantum states that extend to two or more subjects. More precisely, it is the goal of the present invention to estimate consensus and anti-consensus dynamics between subjects by utilizing Bose-Einstein and Fermi-Dirac statistics introduced in the background section to describe the joint quantum states of multiple subjects. These joint quantum states will be studied for subjects, such as pairs of transmitting and receiving subjects or even larger collections of subjects that share a common internal space.

To understand the foundations behind the construction of joint quantum states in the sense of the invention we first turn to the diagram in FIG. 3A. Here, the same underlying proposition 107 is presented to receiving subject s2 after transmitting subject s1 has made their choice and communicated it via broadcast 111. In other words, at this stage receiving subject s2 is aware of underlying proposition 107 about unclaimed money 109. Receiving subject s2 also knows about transmitting subject's s1 action modulo money 109. Just to recall, transmitting subject s1 manifested measurable action b of “Give” associated with state “Giver. This action was quantum mechanically represented by transmit subject qubit |Tx [symbol] ᵤ=αₐ|Tx1a [symbol] ᵤ+β_{b}|Tx1b [symbol] ᵤ being “collapsed” to the final or measured transmit subject qubit |Tx [symbol] ᵤ=|Tx1b [symbol] ᵤ (see Eqs. 25a-b). Just as a reminder, this result would have been expected with quantum probability p_{b}=β_{b}*β_{b}.

Broadcast 111 provided to receiving subject s2 preferably contains entire stream 113-s1 of data files 112-s1 generated by transmitting subject s1, but it may also just contain parts thereof. The manner of transmission is either via network 104, social network 106 or by any other medium including direct subject-to-subject communications in real life, as already mentioned above. What is important is that receiving subject s2 be correctly appraised of underlying proposition 107 and the measurable indication of action b manifested by transmitting subject s1. As pointed out above, measurable indication is broadly defined based on knowledge of human subjects, preferably vetted by a skilled curator, and it can include an action, a choice or a response made openly or even internally. In the present case the measurable indication is easy to spot, since it involves either giving money 109 away or keeping it.

It is not customary among human subjects to include as part of broadcast 111 their frame of mind or contextualization of underlying proposition 107. In other words, human subjects do not usually specify the context in which they are considering any given proposition. Especially among subjects who know each other, it is frequently assumed by social convention that the context will be apparent to the recipient. Vernacular expressions indicate this tacit understanding of context by sayings such as: “being on the same page”, “being synced”, “getting each other” and the like.

What this means in the present quantum representation of underlying proposition 107 is that the way that transmitting subject s1 contextualizes it, namely their choice of u-basis in our quantum representation, may be taken for granted and omitted from broadcast 111. If receiving subject s2 does not know transmitting subject s1 well enough, he or she may need to guess at the contextualization. In doing that, they will have a better chance of deciphering the context if stream 113-s1 is reasonably complete and includes divagations by transmitting subject s1 that drop clues about the contextualization they are using. For example, in the present case the framing of transmitting subject s1 in terms of “Keeper vs. Giver” frame of mind could be deduced from posts two and three: “could do a lot of good with that money”; and “got to give it to my favorite charity”.

Whether receiving subject s2 does or does not know the context, or equivalently the u-basis adopted by transmitting subject s1, it is likely that their own contextualization of underlying proposition 107 will differ from the one used by transmitting subject s1. Therefore, in accordance with the invention a v-basis that represents the contextualization adopted by receiving subject s2 is used by assignment module 116 in assigning a receive subject qubit |Rx [symbol] to receiving subject s2. In other words, receive subject qubit |Rx [symbol] is decomposed in a v-basis into eigenvectors of the v-basis rather than in the u-basis. Of course, it is possible that receiving subject s2 will adopt the same u-basis by choice or by necessity of circumstances. The results of such cases will be discussed below when we start considering joint quantum states.

Meanwhile, the Bloch-sphere assisted representation of the assignment of receive subject qubit |Rx [symbol] ᵥ by assignment module 116 in the v-basis is shown in detail in the lower right portion of FIG. 3B. Specifically, receive subject qubit |Rx [symbol] ᵥ is visualized in Bloch sphere 10 in its decomposition over the eigenvector states |+ [symbol] ᵥ and |− [symbol] ᵥ. Again, the decomposition is analogous to the decomposition of any qubit (see Eq. 7). To reflect that we are dealing here with receive subject qubit |Rx [symbol] [symbol] ᵥ corresponding to internal subject state 110b of receiving subject s2 the naming convention of the eigenvectors is changed to:

|Rx [symbol] ᵥ=αₐ|Rx1a [symbol] ᵥ+β_{b}|Rx1b [symbol] ᵥ. Eq. 25c

In adherence to the quantum mechanical model, the two subject state vectors |Rx1a [symbol] ᵥ, |Rx1b [symbol] ᵥ are accepted into the model along with their two corresponding subject state eigenvalues λₐ, λ_{b}. Furthermore, receive subject qubit |Rx [symbol] ᵥ is placed in a receive subject Hilbert space [symbol] _{Rx} in keeping with the treatment of transmit subject qubit |Tx [symbol] ᵤ.

Notice that just as in the case of transmit subject qubit |Tx [symbol] ᵤ in the u-basis, the representation of internal state 110b is dyadic. In other words, the representation postulates two mutually exclusive states that receive subject qubit |Rx [symbol] ᵥ can assume; there are represented by the two orthogonal eigenvectors |Rx1a [symbol] ᵥ, |Rx1b [symbol] ᵥ. Because receive subject s2 contextualizes money 109 contained in underlying proposition 107 differently from transmitting subject s1, the eigenvectors of the two qubit representations are different. However, the eigenvalues associated with either pair of eigenvectors are the same. In other words, the measurable indications or responses a, b that stand in for the eigenvalues λₐ, λ_{b} associated with the eigenvectors are identical for both receive subject qubit |Rx [symbol] ᵥ and for transmit subject qubit |Tx [symbol] ᵤ. Thus, both transmitting subject s1 and receiving subject s2 will yield as measurable or observable outcome either “Keep” money 109 or “Give” money 109. The ability to model such a complex situation yielding the same indications or responses a, b is due to the inherent richness of the quantum representation as adopted herein.

To elucidate why the quantum mechanical representation can accomplish this, we turn our attention to internal state 110b of receiving subject s2 prior to measurement. This state is expressed by receive subject qubit |Rx [symbol] ᵥ composed of two eigenstates |Rx1a [symbol] ᵥ, |Rx1b [symbol] ᵥ which associate with a different context and thus carry different meanings than eigenstates |Tx1a [symbol] ᵤ, |Tx1b [symbol] ᵤ. However, their measurable indications or responses a, b still correspond to “Keep” money 109 or “Give” money 109. A skilled human curator will recognize at this point that this situation is quite common. Different contexts frequently assign different meanings to the exact same actions.

In our example, the contextualization of receiving subject s2 in the v-basis corresponds to “Dishonest” being assigned to eigenstate |Rx1a [symbol] ᵥ. “Honest” is assigned to eigenstate |Rx1b [symbol] ᵥ. The actions or responses a, b still involve keeping or giving away found and unclaimed money 109 at center of underlying proposition 107. Here, “Dishonest action or response” eigenstate goes with measurable indication a→“Keep” money 109. Any subsequent actions, such as put in one's retirement account, spend on family vacation etc., are beyond the present measurement. “Honest action or response” eigenstate goes with measurable indication b→“Give” either to charity (as subject s1 did) or to entity that will attempt to locate rightful owner. Again, any subsequent actions are beyond the scope of the present measurement.

It is important that the assignment of qubits by assignment module 116 be reviewed to ensure that it properly reflects real experiences. Thus, a human curator should vet the initial choice of the qubits, their decompositions and the associated eigenvalues. As indicated above, contextualization in some spaces may require more than just two eigenvectors (in spaces that are higher-dimensional). It is further preferable to confirm the choices made as well as the human meanings of the bases (contexts) and of the possible actions (eigenvalues) by measurements over large numbers of subjects. Such confirmatory tests of the assignments should use commutator algebra to estimate relationships between different bases with respect to the same underlying proposition. The corresponding review of data to tune the assignment module's 116 assignment of qubits, their decompositions and eigenvalues can be performed by the network behavior monitoring unit 120. Several of these issues are discussed in the co-pending application Ser. No. 14/128,821 and the reader is invited to refer thereto for further information.

FIG. 3B shows “Dishonest” eigenstate |Rx1a [symbol] ᵥ mapped to the state vector |+ [symbol] ᵥ and “Honest” eigenstate |Rx1b [symbol] ᵥ mapped to the state vector |− [symbol] ₂ in the v-basis as defined here by unit vector \hat{v}. Further, given the physical entity on which receive subject qubit |Rx [symbol] ᵥ is based, namely either a fermion or a boson, the eigenvalues are either integral or half-integral (1 and −1 or ½ and −½). Measurable indication a→Keep goes with spin-up along \hat{v} or state |Rx1a [symbol] ᵥ of human receiving subject s2. Measureable indication b→Give goes with spin-down along \hat{v} or state |Rx1b [symbol] ᵥ for human receiving subject s2.

The quantum mechanical prescription for deriving receive subject proposition matrix PR_{Rx} has already been presented in the background section in Eq. 13. Moreover, transmit subject proposition matrix PR_{Tx} was derived above by following this prescription. Hence, given the decomposition of unit vector \hat{v} into its x-, y- and z-components as well as the three Pauli matrices σ₁, σ₂, σ₃ we obtain:

PR_{Rx}=\hat{v}· σ̅=vₓσ₁+v_{y}σ₂+v_{z}σ₃. Eq. 26b

The components of unit vector \hat{v} (vₓ,v_{y},v_{z}) are shown in FIG. 3B for clarity.

During the pre-measurement stage internal state 110b of receiving subject s2 is already represented by qubit |Rx [symbol] ₂. This is the same as in the case of internal state 110a of transmitting subject s1 prior to his or her measurement. The pre-measurement state is exactly the state we found described by receive subject qubit |Rx [symbol] ᵥ of Eq. 25c. Measurement, which corresponds to the application of receive subject proposition matrix PR_{Rx} to the state in Eq. 25c, will yield one of the two eigenvectors or eigenstates |Rx1a [symbol] ᵥ, |Rx1b [symbol] ᵥ with quantum probabilities as discussed above (also see Eq. 3). The measurement will further result in receive subject s2 manifesting the measurable indication a or b assigned to the eigenvalue that goes with the eigenstate into which qubit |Rx [symbol] ᵥ “collapsed”.

At some time, upon receipt of broadcast 111 from transmitting subject s1 measurement of receiving subject s2 will be provoked. Once again, however, there exists a certain probability, in addition to recording one of the two mutually exclusive measureable indications a, b (“Keep”, “Give”), of obtaining null response 128. As before, null response 128 expresses an irrelevance of proposition 107 and/or broadcast 111 from transmitting subject s1 to receiving subject s2. This irrelevance causes non-responsiveness of receiving subject s2. As before, null response 128 or non-response is assigned a classical null response probability pₙᵤₗₗ that affects event probability γ monitored by statistics module 118.

We are interested in cases where receiving subject s2 is provoked to measurement by the receipt of broadcast 111 of underlying proposition 107 and the choice of transmitting subject s1 (represented by final transmit subject qubit state |Tx [symbol] ᵤ=|Tx1b [symbol] ᵤ and measureable indication b→Give that was memorialized in their fourth post). In the present case broadcast 111 contains all data files 112-s1 that make up stream 113-s1 generated by transmitting subject s1. This complete broadcast 111 allows receiving subject s2 to ponder the entire situation and be “collapsed” to a measured internal state 110b.

The measurement of receiving subject s2 modulo proposition 107 as contextualized by receive subject s2 in the v-basis while aware of the choice (measurement) of transmitting subject s1 (and not necessarily being aware of transmitting subject's u-basis) is also modeled herein based on the quantum mechanical projection postulate. Specifically, measurement will cause receive subject qubit |Rx [symbol] ᵥ to “collapse” to just one of the two states or eigenvectors |Rx1a [symbol] ᵥ, |Rx1b [symbol] ᵥ (“Dishonest”, “Honest”). Contemporaneously with the collapse, receiving subject s2 will manifest the eigenvalue embodied by the response, a→Keep or b→Give, associated with the correspondent eigenvector to which receive subject qubit |Rx [symbol] ᵥ collapsed.

In contrast to the measurement on transmitting subject s1, measurement on receiving subject s2 usually cannot result in the exact same measurable indications. For example, it typically cannot involve disposal of money 109 at center of underlying proposition 107 by receiving subject s2. That is because the measurable indication b→Give embodied by the action of giving away of money 109 to a charity has already been performed. Transmitting subject s1 has already done that! The exact same action cannot be repeated now by receiving subject s2.

Thus, when receive subject qubit “collapses” to eigenstate |Rx1b [symbol] ᵥ or “Honest”, receiving subject s2 can only exhibit the same measurable indication b→Give embodied by a consonant action or response that is not identical to the action or response exhibited by transmitting subject s1. Such consonant response can be verbalized or enshrined in a message to transmitting subject s1 from receiving subject s2. Preferably the message is in the form of one or more data files 112-s2, or even an entire stream 113-s2, generated by receiving subject s2 on their tablet computer 102b.

Consonant response b→Give should be unambiguous, e.g., as defined by social norms and conventions. It should affirm that subject s2 would have given money 109 to charity (maybe after trying once more to return it first to rightful owner). Under ideal conditions, receiving subject s2 would actually find themselves in a position to manifest action b→Give. For example, subject s2 would give monies found independently (separate situation) to a charity following the example set by transmitting subject s1.

Of course, subject s2 can also collapse to eigenstate |Rx1a [symbol] ᵥ (“Dishonest”) and manifest measurable indication a→Take embodied by a disagreeing response or action. Indications a→Take and b→Give whether in the form or actions or responses are mutually exclusive. Again, response or action a→Take should be embodied in terms that are unequivocal by social norms. In order for computer system 100 to keep track of this response or action, it is desirable for subject s2 to communicate it by generating one or more data files 112-s2, or even stream 113-s2, and sharing them with network 104 and/or within social network 106.

In our case, receiving subject s2 chose the “Honest” internal state 110b that goes with measureable indication b→Give. Thus, their original internal state 110b represented by receive subject qubit |Rx [symbol] ᵥ was “collapsed” to subject state vector |Rx1b [symbol] ᵤ. This projection means that the new state 110b is represented by measured receive subject qubit |Rx [symbol] ᵥ containing just the subject state vector |Rx1b [symbol] ᵥ, or simply put:

|Rx [symbol] ᵥ=|Rx1b [symbol] ᵥ. Eq. 25d

Also, in the present case receive subject generated stream 113-s2 of data files 112-s2 including:

1) “You are such an honest person!”
2) “Way to go!—I would do the same with found money any day”.

Notice that from stream 113-s2 a good guess can be made as to the contextualization of underlying proposition 107 adopted by receiving subject s2. We see here that receiving subject s2 is taking underlying proposition 107 about money 109 to be about honesty versus dishonesty rather than about being a taker or a giver. It was transmitting subject s1 that contextualized underlying proposition 107 as a giver's choice versus a taker's choice. Yet, both subjects s1, s2 agreed as to the measurable indication being b→Give. Agreement was thus reached, even though there was no alignment of contexts or frames of mind between s1 and s2 about how exactly proposition 107 about found money 109 ought to be viewed.

We are very interested in situations where subjects interact and agree or disagree about underlying propositions. We are also interested in the ways in which subjects contextualize the underlying propositions centered about objects, other subjects or experiences. Further, we are interested in situations where subjects change contexts and even adopt the same context with respect to the proposition (possibly through mutual interaction such as an open conversation). The mutually adopted context could be that of either subject or a new context that may be arrived at through negotiation.

To develop the tools for addressing the above interests and their practical implications, we turn to the diagram in FIG. 3C. This drawing shows internal states 110a, 110b of subjects s1, s2 as well as their respective qubits |Tz [symbol] ᵤ=|Tx1b [symbol] ᵤ, |Rx [symbol] ᵥ=|Rx1b [symbol] ᵥ after the measurements discussed above. Their respective data files 112s-1, 112s-2 contained in streams 113-s1, 113-s2 that subjects s1, s2 share via network 104 from their networked devices 102a, 102b are also indicated here.

Broadcast 111, by which transmitting subject s1 communicated their measurable indication b→Give with respect to underlying proposition 107 about found money 109 is shown separately. This is done to remind us that, although it is possible for all communications between subjects to be mediated by network 104 (and any subset thereof, such as social network 106), a substantial portion of communications between subjects s1, s2 may take place beyond network 104.

Preferably, of course, all communications between subjects, including communications of important choices such as the one contained in broadcast 111 are mediated by network 104. That is because the resources of computer system 100 will be able to make better predictions when presented with more data. Indeed, the quantum mechanical representation adopted herein relies on the availability of data about subjects of interest and preferably in large quantities (e.g., “big data”).

In accordance with the invention, mapping module 115 is used to find a common internal space 110ab that is shared by transmitting subject s1 and receiving subject s2. Given that module 115 has access to streams 113-s1, 113-s2 it possesses the important information to allow it to discover common internal space 110ab. In the model adopted herein, common internal space 110ab is postulated to exist by module 115 between any two subjects that are known to communicate with each other if at least one of the following conditions is fulfilled:
1) subjects perceive underlying propositions about same object, subject or experience; or
2) subjects show independent interest in the same object, subject or experience; or
3) subjects are known to contextualize similar underlying propositions in a similar manner (similar bases) but not necessarily about same object, subject or experience.

Loosening of these conditions is possible for objects, subjects or experiences that are known to be of vital importance to any subject and thus necessarily require contextualization and interaction. For example, objects such as food, water, shelter and subjects such as parents, children, family members and experiences such as war, peace necessarily affect all subjects. Therefore, common internal spaces corresponding to contextualization of underlying propositions about these objects, subjects, experiences may be postulated a priori. Again, a human curator with requisite knowledge and experience should be involved in making decisions on how the above conditions can be relaxed in practice.

In the specific case of subjects s1, s2, they are known to communicate and we note that condition 1) is thus satisfied. Of course, they do not contextualize in the same manner as evidenced by the disparity in the u-basis and v-basis along which they break down underlying proposition 107 about found money 109. However, only one of the conditions has to be met, and thus mapping module 115 postulates common internal space 110ab between subjects s1, s2. In terms of its quantum representation, common internal space 110ab is taken here to be a tensor product space. Specifically, it is the tensor product of transmit subject Hilbert space [symbol] _{Tx} and receive subject Hilbert space [symbol] _{Rx} where the qubits were originally placed. Formally, the tensor product space [symbol] ^{(TR)} is written as:

[symbol]

^{(TR)}= [symbol] _{Tx} [symbol] [symbol] _{Rx}, Eq. 27

and it can be expanded in terms of tensor products of eigenvectors of the two component spaces, as is well-known to those skilled in the art.

Once mapping module 115 finds common internal space 110ab between subjects s1, s2 the quantum mechanical aspects of interaction between qubits |Tx [symbol] , |Rx [symbol] can be examined. Usually, one first represents them in shared tensor space [symbol] ^{(TR)} that is the quantum analogue of internal space 110ab. Now it is possible to examine the types of permissible joint quantum states involving both qubits |Tx [symbol] , |Rx [symbol] in shared state space [symbol] ^{(TR)}. From the background section we know that joint quantum mechanical wave functions, which certainly include the physical entities that represent qubits |Tx [symbol] , |Rx [symbol] , mostly fall into two types: symmetric and anti-symmetric. Although we will not expressly consider the more esoteric forms due to fractional statistics, i.e., anyons, a person skilled in the art will recognize that such solutions are also possible and known tools of quantum mechanics can be applied to study those as well.

Symmetric wave functions are associated with elementary and composite bosons. These have a tendency to occupy the same quantum state under suitable conditions (e.g., low enough temperature and appropriate confinement parameters). Anti-symmetric wave functions are associated with elementary and composite fermions. They do not occupy the same quantum state under any conditions and give rise to the Pauli Exclusion Principle introduced in the background section (see Eqs. 23 & 24).

The present invention extends the quantum representation of qubits |Tx [symbol] , |Rx [symbol] to include the possibility of their joint quantum states being governed by spin statistics. Such states can be represented by wave functions that are symmetric and thus obey Bose-Einstein (B-E) statistics, or anti-symmetric and thus obey (F-D) Fermi-Dirac statistics.

More precisely still, the invention extends to predicting such symmetric or anti-symmetric joint quantum states modulo the underlying proposition about an object, a subject or an experience. By extension of teachings from quantum mechanics and quantum field theory (spin-statistics theorem), the present invention predicts that within a realm of validity certain subjects may manifest joint quantum states that exhibit either B-E or F-D statistics with respect to underlying propositions about known objects, subjects, experiences.

By realms of validity we mean joint contexts that do not probe or test the bosons or fermions that qubits |Tx [symbol] , |Rx [symbol] represent for their composite nature. This is in analogy to the situation encountered in physics, where moving beyond certain scales or energies changed the conditions and tested the component nature of the composite entities forcing abandonment of their description by the composite wave function (also see background section). In terms of the invention, this means that the way in which the underlying proposition about the object, subject or experience is posed may not produce duress or induce the perception of different underlying propositions that are potentially about different objects, subjects or experiences than what was intended prima facie. At this point, a practical example will help elucidate the prediction of joint quantum states in accordance with the invention and within the realms of validity.

FIG. 3D shows us in a pictorial representation common internal space 110ab, quantum mechanically represented by shared state space [symbol] ^{(TR)}, of transmitting subject s1 and receiving subject s2, with whom we are already familiar. Note that this common internal space 110ab is justified modulo underlying proposition 107 where the object in question is found cash 109. The justification is due to the clear interest of both subjects s1, s2 in dealing with money 109, as evidenced by their streams 113-s1, 113-s2 and measurements we have already reviewed. Note that the fact that subjects s1, s2 have different modes of contextualization, as represented quantum mechanically by u- and v-bases, is expressly permitted by the conditions imposed in mapping module 115 (see above).

Assignment module 116 had previously assigned to subjects s1, s2 qubits |Tx [symbol] , |Rx [symbol] , respectively. We saw how these qubits behaved separately under measurement induced by underlying proposition 107 about unclaimed money 109 in their own u- and v-bases (where their decomposition was denoted by the subscripts |Tx [symbol] ᵤ, |Rx [symbol] ᵥ). Specifically, the measurements precipitated these wave functions to collapse to one of the eigenvectors of their respective proposition matrices PR_{Tx} and PR_{Rx}. What is now new, is that since mapping module 115 has found that these two subjects s1, s2 share common internal space 110ab, it is possible for qubits |Tx [symbol] , |Rx [symbol] that represent them to form joint quantum states in shared state space [symbol] ^{(TR)}.

In practice, the best opportunity for the formation of such joint quantum states modulo underlying proposition 107 occurs when both subjects s1, s2 are in close communication or even physically together. Ideally, they are both undergoing measurement under virtually the same conditions. In other words, in contrast to the measurements above, where transmitting subject s1 actually made their choice in a live situation and receiving subject s2 merely assented and showed solidarity, the situation where joint quantum states are most likely to be seen are when both subjects s1, s2 are present. For example, in the instant case they both find unclaimed money 109 together under the bridge and have to decide what to do with it together. Of course, joint quantum states can also manifest while subjects s1, s2 are not physically together. They could instead interact online or more directly by a voice call at the time of measurement. It is likely, however, that very large separation and sparse communication between subjects s1, s2 will tend to attenuate or even eliminate any evidence of joint quantum states.

Turning back to FIG. 3D we see subjects s1, s2 being confronted by underlying proposition 107 about found cash 109. Transmitting subject s1 and receiving subject s2 are weakly interacting, e.g., by a polite conversation, to determine what to do with money 109. (Note that from the point of view of applicability of the quantum model, a weak interaction level is ideal.) Recall that the u-basis spanned by opposites “Taker” vs. “Giver” and the v-basis spanned by opposites “Dishonest” vs. “Honest” were determined by the human curator to not be very well aligned (e.g., see FIG. 3C). Therefore, the fact that measured indications for subject s1 and s2 coincided, namely they both manifested b→Give, does not mean that they will agree on the same measurable indication when confronted by proposition 107 jointly. When trying to reach mutual agreement the disparity in frames or misalignment of u- and v-bases will present a problem.

As noted above, subjects s1, s2 can either both adopt one of their contexts or arrive at a new context. In the first case, either subject s1 agrees to a measurement in the context represented by the v-basis of subject s2 (“Dishonest” vs. “Honest” context) or vice versa (i.e., the u-basis (“Taker” vs. “Giver” context) of subject s1 is assented to by subject s2). The present example shows the second case, where a new context denoted by a w-basis is adopted by subjects s1, s2. The w-basis context with respect to proposition 107 is an intermediate choice somewhere between the u- and v-bases. It was arrived at through a civil and amicable negotiation conducted by subjects s1, s2. In other words, the interaction was not a strong interaction as might have occurred if one of the subjects took the “my way or the highway” stance with respect to proposition 107 or forced the choice of basis “at gun point”.

The w-basis breaks down into opposite states of “Irresponsible” vs. “Responsible”. The eigenvectors corresponding to these states for each subject are |Tx1a [symbol] _{w}, |Rx1a [symbol] _{w} and |Tx1b [symbol] _{w}, |Rx1b [symbol] _{w}. The eigenvalues standing for measurable indications that go with “Irresponsible” eigenstates |Tx1a [symbol] _{w}, |Rx1b [symbol] _{w} are the same, namely a→Take. Similarly, the measurable indications that go with “Responsible” eigenstates |Tx1b [symbol] _{w}, |Rx1b [symbol] _{w} are the same: b→Give.

Before proceeding, the designer of computer system 100 is cautioned that the choice of bases and the meaning of eigenvectors along with the eigenvalues they manifest under measurement are preferably first vetted by a skilled human curator familiar with the circumstances of subjects s1, s2. Subsequent tuning, e.g., by deploying the tools of commutator algebra on sufficiently large sets of data available about subjects s1, s2 or about similar subjects, or by still other means well known to those skilled in the art of quantum measurements, should be used to corroborate the initial choices made by the curator. The reasons are, among other, that different subjects and, indeed, different groups of subjects (such as social classes, sub-cultures, cultures, nations, etc.) may attach different meanings to these quantities. Corresponding teachings about the use of commutators to explore the internal spaces of subjects can be found in the co-pending application Ser. No. 14/128,821 and the details about the mathematical tools are contained in the many excellent references on quantum mechanics cited in the background section.

Returning now to FIG. 3D, we see that qubit |Tx [symbol] _{w} representing the internal state of transmitting subject s1 was measured to “collapse” to eigenvector |Tx1a [symbol] _{w}. Meanwhile, qubit |Rx [symbol] _{w} representing the internal state of receiving subject s2 was measured to “collapse” to eigenvector |Rx1b [symbol] _{w}. Further, subjects s1, s2 are firm in their decisions and would not consider changing them on their own accord. In other words, an exchange of subjects s1, s2 which would correspond to them swapping their positions of their own free will is associated with an “exchange energy”. We thus obtain in common space 110ab a situation of anti-consensus between subjects s1, s2. Subject s1 manifests measureable indication a→Take while subject s2 manifests measureable indication b→Give and they are not willing to change their choices. Clearly, in such situations it may come to blows and other antagonistic situations that human beings experience under disagreements.

In the present invention, we take such anti-consensus joint quantum states of subjects in shared internal space or state space [symbol] ^{(TR)} to represent fermionic behavior. Thus, the quantum statistic assigned to both subjects s1, s2 by statistics module 118 modulo underlying proposition 107 will be an anti-consensus statistic F-D. In other words, with respect to proposition 107 about found money 109 or similar circumstances subjects s1, s2 exhibit fermionic behavior. They will thus not agree to a common measurable indication. This closely parallels the teachings of quantum mechanics that we have reviewed in the background section. Specifically, fermions obeying F-D statistics are subject to the Pauli Exclusion Principle and cannot occupy the same quantum state. The situation between subjects s1, s2 in FIG. 3D is taken as the human realm analogy to that famous principle.

Consequently, any joint quantum state assigned to receiving subject s1 and transmitting subject s2 needs to be represented by an anti-symmetric wave function. The assignment is made by statistics module 118 using the standard quantum notation in which the anti-symmetric joint quantum state is designated by the capital Greek letter Ψ. The actual anti-symmetric fermion wave function for two entities has already been introduced in the background section (see Eq. 24). Rewritten and simplified to reflect the present notation used for subjects s1, s2, the anti-symmetric joint quantum state becomes:

Ψ(Tx,Rx)=1/\sqrt{2}[|Tx1a [symbol] _{w}|Rx1b [symbol] _{w}|Tx1b [symbol] _{w}|Rx1a [symbol] _{w}]. Eq. 27

For any simulation or prediction later made by prediction module 122 or simulation engine 126 of computer system 100, the knowledge that subjects s1, s2 will exhibit anti-consensus statistic F-D modulo proposition 107 and likely any similar proposition will be invaluable for producing a high-quality prediction or simulation.

The designer of computer system 100 is here also advised that many quantum mechanical tools exist for determining quantities such as “exchange energy”, also sometimes called “exchange coupling”, to confirm that subjects s1, s2 would indeed not swap their positions willingly. Furthermore, singlet states, of which the anti-symmetric fermion wave function of Eq. 27 is clearly a member, can be confirmed by tests devised in the prior art many decades ago. Several of these are based on the famous insight captured by Bell's Inequality. Any such tests are within the purview of those skilled in the art and can be brought to bear herein.

FIG. 3E shows same subjects s1, s2 falling into the other possible category, namely that of exhibiting a consensus statistic B-E modulo proposition 107 or any similar proposition. Here, we again see that qubit |Tx [symbol] _{w} representing the internal state of transmitting subject s1 was measured to “collapse” to eigenvector |Tx1a [symbol] _{w}. Meanwhile, qubit |Rx [symbol] _{w} representing the internal state of receiving subject s2 was measured to “collapse” to eigenvector |Rx1b [symbol] _{w}. However, subjects s1, s2 are not firm in their decisions and would easily change them of their own accord. In other words, an exchange of subjects s1, s2 which would correspond to them swapping their positions willingly would not require any “exchange energy”. We thus obtain in common space 110ab a situation of consensus between subjects s1, s2. Subject s1 manifests measureable indication a→Take while subject s2 manifests measureable indication b→Give and they are willing to change their choices or even make the same choice.

In the present invention, we take such consensus joint quantum states of subjects in shared internal space or state space [symbol] ^{(TR)} to represent bosonic behavior. Thus, the quantum statistic assigned to both subjects s1, s2 by statistics module 118 modulo underlying proposition 107 will be a consensus statistic B-E. In other words, with respect to found money 109 or similar circumstances subjects s1, s2 exhibit bosonic behavior. This behavior results in a number of choices available to subjects s1, s2, of which the first one is shown in FIG. 3E while the other two are shown in FIGS. 3F-G. A person skilled in the art will notice that upon the novel mapping of these human behaviors as taught herein, the mathematical representations parallel closely the teachings of quantum mechanics that we have reviewed in the background section.

For bosons, any joint quantum state assigned to receiving subject s1 and transmitting subject s2 needs to be represented by a symmetric wave function. The assignment is made by statistics module 118 using the standard quantum notation in which such symmetric joint quantum state is designated by the capital Greek letter Φ. The actual symmetric boson wave function for two entities has already been introduced in the background section (see Eq. 22). Rewritten and simplified to reflect the present notation used for subjects s1, s2, the symmetric joint quantum state becomes:

Φ(Tx,Rx)=1/\sqrt{2}[|Tx1a [symbol] _{w}|Rx1b [symbol] _{w}+|Tx1b [symbol] _{w}|Rx1a [symbol] _{w}]. Eq. 28

There are, of course, two other possibilities for joint quantum states Φ that can be occupied by qubits standing in for subjects s1, s2 that obey the consensus statistic B-E.

The first option, namely both subject s1 and subject s2 collapse to the eigenstate of “Irresponsible” and manifest measurable a→Take is depicted in FIG. 3F. The corresponding wave function Φ for such symmetrical joint quantum state is shown in the drawing figure. The second option, namely both subject s1 and subject s2 collapse to the eigenstate of “Responsible” and manifest measurable b→Give is illustrated by FIG. 3G. The corresponding symmetrical joint quantum state wave function is also shown.

Returning now to FIG. 2 we note a few other details that require attention prior to placing computer system 100 into action. In the present invention it is the function of statistics module 118 to curate event probability γ. It is therefore the function of module 118 to evaluate empirical data concerning the likelihood of measurable events based on classical probabilities, namely null response probability pₙᵤₗₗ associated with responses 128 (see FIGS. 3A-B), non-engagement probability pₙₑ, as well as any other factors such as quantum mechanical interaction probability pᵢₙₜ.

Event probability γ is based on the subjects confronting proposition 107 and engaging therewith to yield a proper quantum measurement. Of course, as the reader has no doubt already surmised from some of the above examples, this will not always happen. Therefore, event probability γ is typically expected to be less than unity (i.e., the event is less than 100% likely. When proposition 107 is about very sensitive subject-object, subject-subject or subject-experience interactions or relationships, event probability γ is expected to be correspondingly low. For additional teachings on computing event probability the reader is referred to the co-pending application Ser. No. 14/128,821.

As is apparent from the above considerations, it is also very important to determine upfront (before making any predictions or simulations) whether a joint wave function obeys F-D or B-E statistics. This is the function of quantum exchange monitor 121 designed to provide an estimation of a quantum exchange energy or its analogue encountered under a swap of transmitting subject s1 and receiving subject s2. To the extent that such information can be deduced by the human curator, it can be pre-set. However, since network 104, and more precisely memory 108 may contain records indicating what happened under role reversal to the subjects of interest in the past, the original pre-sets can be tuned.

In practice, no exchange energy is reported by monitor 121 when a swap has occurred without incidents or signs of strife in recent past with respect to a very similar or virtually the same underlying proposition. An exchange energy is reported by monitor 121 when role reversal has lead to confrontation (termination of relationship, or even more grave happenings) between the subjects of interest. The relevant information can be deduced, but is more preferably directly obtained (e.g. from monitoring streams of relevant data files in network 104) or computed from historical data of past responses to similar underlying propositions by subjects of interest (e.g., s1, s2 in the present example).

Once the overall event probability γ is properly estimated, and preferably confirmed in empirical tests on many subjects similar to subjects s1, s2, or else form initial estimates provided by skilled human curators with experience in the corresponding domains of human behaviors (e.g., psychology or sociology) system 100 is ready to operate. Computer system 100 now deploys its prediction module 122 to compute expected measurable indications from subjects s1, s2 modulo proposition 107. In FIG. 2 the measurable indications, which are mutually exclusive actions or responses according to the conventions practiced herein, are more generally indicated by responses R1, R2 in this drawing. The possibility of non-events is also tracked and designated by “IRRELEVANT”. Obviously, in making the forecasts, prediction module 122 also predicts the nature of the joint quantum state of transmit subject qubit |Tx [symbol] and receive subject qubit |Rx [symbol] in state space [symbol] ^{(TR)} based on the quantum statistics assigned by statistics module 118.

When the assignment is not 100% certain, prediction module 122 should weight the choice of wave function type symmetric or anti-symmetric—correspondingly. Note that as additional information becomes available about quantum exchange energy from quantum exchange monitor 121, the assignments by statistics module 118 will be adjusted to reflect this. Therefore, prediction module 122 should always consult with statistics module 118 for the latest consensus and anti-consensus assignments.

Advantageously, random event mechanism 124 that is connected to simulation engine 126 supplies it with input data that is in agreement with the predicted probabilities computed by prediction module 122 and informed by the type of joint quantum states accessible to the subjects in question. In the present embodiment, simulation engine 126 is also connected to prediction module 122 to be properly initialized in advance of any simulation runs. As already mentioned, the output of simulation engine 126 can be delivered to other useful apparatus where it can serve as input to secondary applications such as large-scale prediction mechanisms for social or commercial purposes or to market analysis tools and online sales engines. In any simulation generated by simulation engine 126 or prediction later made by prediction module 122, the knowledge that subjects s1, s2 will exhibit anti-consensus statistic F-D modulo proposition 107 and likely any similar proposition will be invaluable for producing high-quality prediction and/or simulation results.

The general idea of exploring and using the knowledge of the type of symmetry exhibited by joint quantum states between subjects of interest modulo an underlying proposition can be applied in many ways. Preferably, because of the availability of “big data” and access to resources, the apparatus and method of invention are practiced in the context of network 104 and/or social network 106. The fact that subjects of interest are interconnected and communicating freely in such online settings is very helpful. Under such conditions subjects are producing electronic records (e.g., streams of data files) that can be collected and evaluated. This is key to efficient implementations of the insights of the present invention. It is preferred that the apparatus of invention, namely computer system 100, be implemented with the aid of a computer cluster. In such embodiments, the functions of the modules and units may be developed to corresponding nodes that are appropriately provisioned with storage and computing resources.

Purely off-line interactions between subjects can also be included. This is done provided that sufficient data about off-line activities is available to execute the necessary steps by the corresponding modules and units of the apparatus of invention. Clearly, at least information about the content of broadcast 111 and the measurable indications chosen by the subjects has to be made available to computer system 100 in some manner.

We will now review several embodiments that will shed more light on the applications of the quantum representation as taught herein. The same reference numerals will be deployed whenever practical to indicate the same or analogous parts and concepts.

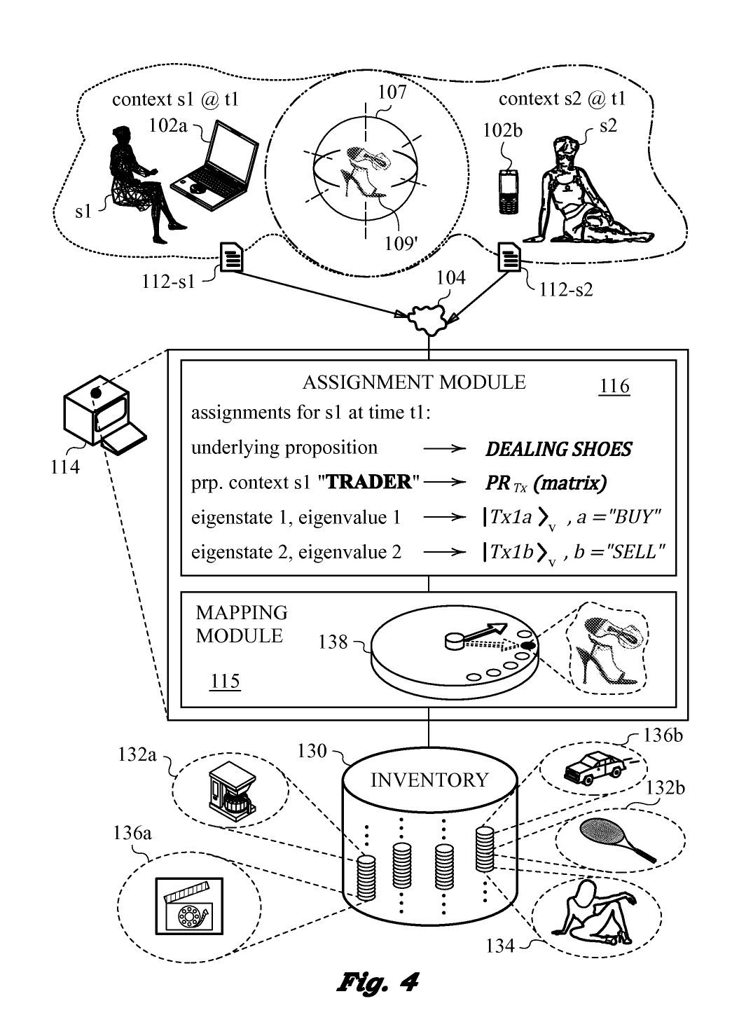

FIG. 4 illustrates a portion of computer system 100 designed to test many different underlying propositions 107 about different objects, subjects and experiences. An inventory store 130 containing a large number of possible objects, subjects and experiences that may be put at the center of underlying proposition 107 is provided for this purpose. Inventory store 130 contains thousands of items. For example, select objects 132a and 132b from store 130 are embodied by a coffee maker and by a tennis racket. A subject 134 embodied by a possible romantic interest to a subject to be confronted by proposition 107 is also shown. Further, store 130 contains many experience goods of which two are shown. These are experiences 136a, 136b embodied by watching a movie or taking a ride in a sports car, respectively. Numerous other objects, subjects and experiences are kept within store 130 for building different types of propositions 107.

Store 130 is connected to mapping module 115. Module 115 knows the various shared common spaces between two subjects s1, s2 of interest that are embodied by different persons but playing the same roles as in the previously discussed embodiment. Module 115 has obtained knowledge about subjects s1, s2 from network monitoring unit 120 (see FIG. 2). It could also have obtained the knowledge from any other appropriate sources that delivered relevant information about subjects s1, s2 to network 104. Module 115 uses the knowledge it has gained to select from store 130 items for which it knows that two subjects s1, s2 in question have a shared common space. More specifically, module 115 has a selection mechanism 138 that makes the corresponding informed selection from store 130. In the present example, the item chosen by mechanisms 138 is an object 109′ embodied by a pair of shoes.

Once mapping module 115 presents its choice of shoes 109′ for underlying proposition 107 that subjects s1, s2 will confront, assignment module 116 can make the appropriate assignments. These include the designation of the underlying proposition 107, which is about dealing with shoes 109′, and the contextualization of proposition 107 by subjects s1, s2. Only the contextualization by subject s1 at a certain time t1 is shown here for clarity.

The contextualization of proposition 107 by subject s1 at the time of interest is from the point of view of a trader. Possibly, subject s1 is a trader in shoes (professionally or as a hobby). The trader context goes with the corresponding transmit subject proposition matrix PR_{Tx} inclusive of the choice of basis. The basis here is the v-basis and the corresponding eigenvectors and eigenvalues. The eigenvalues map to the measurable indications of “BUY” and “SELL” in this example. (The v-basis here is not the same as in the previous example.) Specifically, it may go with mutually exclusive states such as “Good financial deal” vs. “Bad financial deal”.

Assignment module 116 also produces the assignments for receiving subject s2 as dictated by our quantum representation. Like in the above example, it is not expected that the contexts regarding underlying proposition 107 about shoes 109′ will match. However, receive subject s2 will also have a way of contextualizing proposition 107 that will either result in buying or selling them. To relax the rather formal notation used previously, we simply refer to the contexts as context s1 and context s2 in FIG. 4. Of course, the same context would obtain if both subjects s1 and s2 were traders and operating in the same frame of mind at time t1 (context s1=context s2 also implies the same v-basis choice).

An important issue should now be addressed about interchanging transmitting subject s1 with receiving subject s2. Although one usually does take the “lead” in addressing proposition 107 or in some other manner engaging with it first, the choice of first and second only matters when subjects s1, s2 are fermionic modulo proposition 107 rather than bosonic. This fact can be accounted for by not expressly dealing with the order when statistics module 118 is already informed of the fact that the joint quantum state will be symmetric and thus obey B-E statistics. On the other hand, when subjects s1, s2 obey anti-consensus F-D statistics of fermions, the second one to make the choice will not be able to make the same choice as the first one. Thus, order will make a difference here, at least to subjects s1, s2 personally, if not to the overall prediction or simulation. The latter would be affected if the predictions or simulations were designed to yield answers at the level of granularity of individual subjects and their personal outcomes. Overall behavior patterns of groups consisting of many subjects would be unaffected by which individual got which choice. What matters here is whether their behavior is governed by the Pauli Exclusion Principle or exhibits bosonic “bunching”.

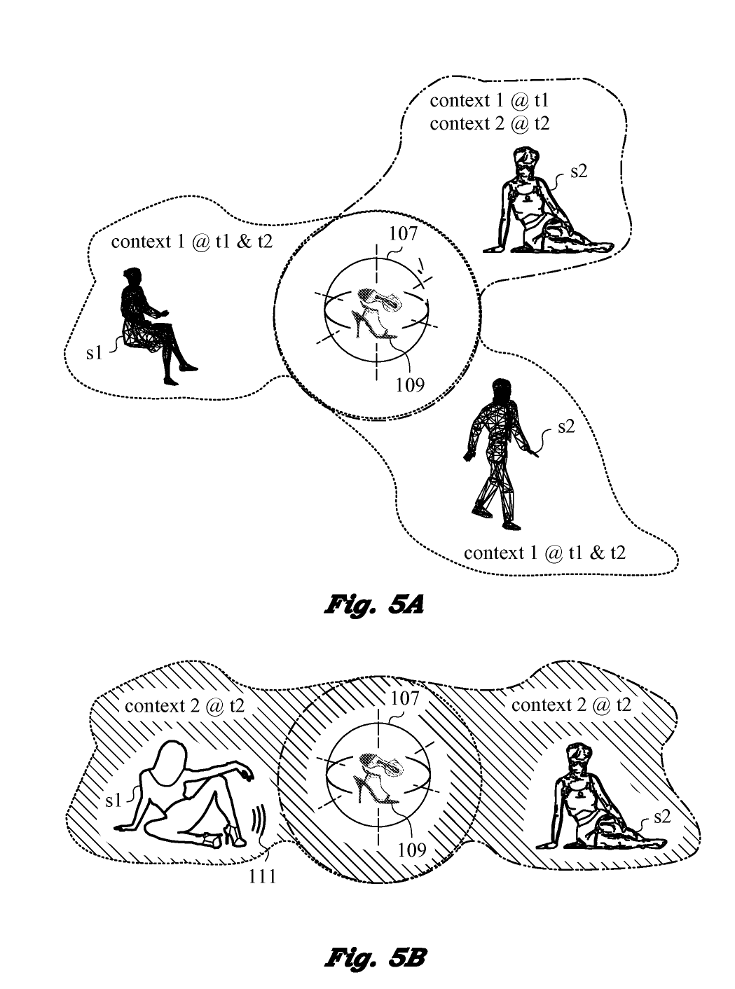

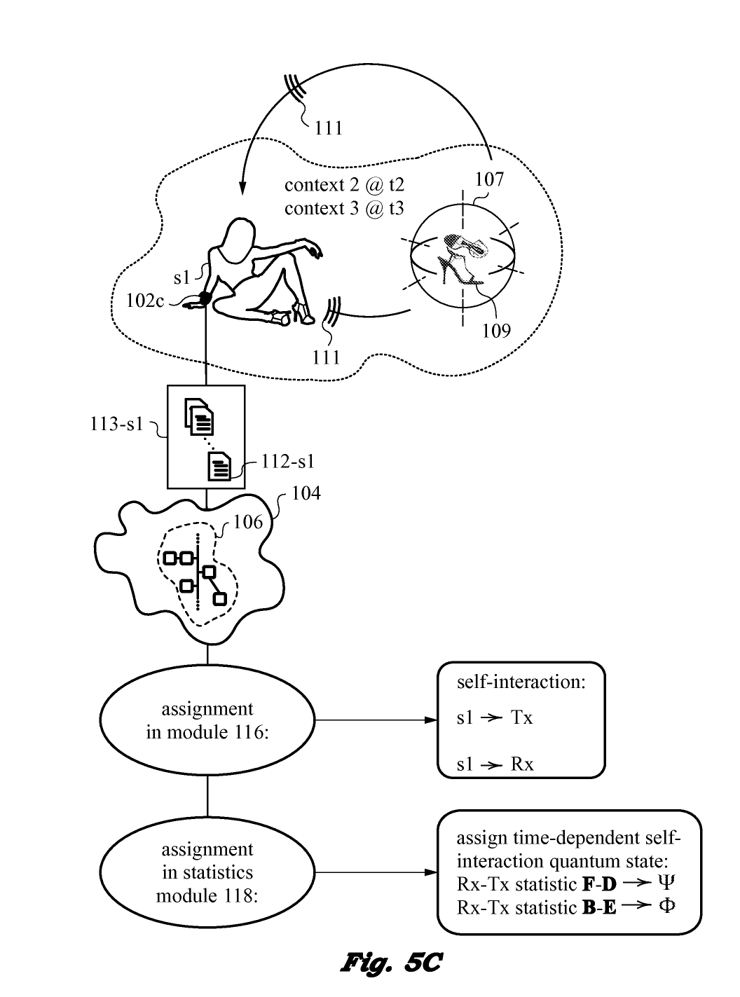

As illustrated in FIG. 5A, the quantum representation including F-D and B-E statistics can be extended to more than two subjects. In FIG. 5A three subjects s1, s2, s3 are confronted by proposition 107 about shoes 109′. If all subjects s1, s2, s3 exhibit B-E statistics modulo proposition 107 then the issue of picking who is the first or transmitting subject is not important. In the present case, we are indeed dealing with subjects s1, s2, s3 that demonstrate consensus statistic B-E rather than anti-consensus statistic F-D vis-à-vis proposition 107.

The consensus B-E statistics between subjects s1, s2, s3 hold at two different times t1 and t2. At time t1 subject s1 is contextualizing proposition 107 in context 1. The same is true of subjects s2 and s3. At time t2, however, subject s2 changes their contextualization modulo proposition 107 to context 2. It is possible, according to the quantum representation of the present invention that at this later time t2 the personality of subject s2 has undergone a sufficiently drastic change to induce their consensus statistic B-E to change to anti-consensus statistic F-D. In other words, context switching by any subject and their change of statistic have to be taken into account to obtain good results.

This is why it is important in practicing the present invention to allow for time to be a variable. Tracking the contextualization practiced by each subject as a function of some cycle can reduce the timekeeping burden. In other words, times of day (month, year or still some other appropriate cycle or timing parameter) when a subject exhibits consensus B-E and anti-consensus F-D statistics modulo proposition 107 can be stored and used by assignment module 116 and statistics module 118 in making their assignments. Also, any subject or subjects can become parts of the proposition from the point of view of a subject in question. Thus, tracking of the composition of the subject group as a function of time needs to be implemented as well when considering changes in context and statistics.

FIG. 5B illustrates another interesting condition that may be created between transmitting subject s1 and receiving subject s2 that exhibit consensus B-E statistics with respect to proposition 107 about shoes 109′. Consider the case where both subjects are exposed to the proposition, but transmitting subject s1 is first. Given this opportunity, at time t2 while acting in context 2 subject s1 procures shoes 109′. For example, subject s1 purchases them before receiving subject s2 has a chance to do so.

In fact, broadcast 111 from transmitting subject s1 carries a clear indication that subject s1 has acted and purchased shoes 109′. Subject s1 is wearing them and subject s2 can even see that, either in real life or online (e.g., in a photo). Subjects s1, s2 exhibit consensus B-E statistics modulo proposition 107 and are both in context 2 about shoes 109′. Hence, their symmetric joint quantum state predicted by statistics module 118 indicates that subject s2 could easily jump into the same state modulo proposition 107 as subject s1 and want to wear shoes 109′, too.

Consider the situation where a second pair of shoes 109′ is not immediately available to subject s2. Given this material limitation, subject s2 may feel the urge to go out and purchase shoes 109′. Indeed, knowledge of this state of affairs could be very useful to online marketers of shoes, especially if they have shoes similar to shoes 109′ in stock. Here, once again, the time-sensitive aspect becomes crucial. At some later time t3 subject s2 may stop contextualizing in context 2 and change their consensus statistic with respect to proposition 107. At that time, subject s2 may not care for shoes 109′ anymore.

The technical concepts developed for this type of need to emulate or duplicate the measurable indications of others while under the spell of consensus B-E statistics has been termed mimetic desire. In the case of anti-consensus F-D statistics, the same situation can give rise to mimetic rivalry. For additional information about these concepts in the prior art, the diligent reader may wish to consult the work Rene Girard who coined the terms.

FIG. 5C brings out yet another important aspect that flows from the quantum representation and the temporal variability of consensus type and contextualization experienced by a single subject. In this drawing we see the possibility for a self-interaction in subject s1 of FIG. 5B. Self-interaction possibility is kept track of by assignment module 116 in permitting the same subject the transmitter and receiver of their own broadcast 111.

From the point of view of the present invention, any potential self-interaction is best observed by following stream 113-s1 of data files 112-s1 generated by subject s1. Here, subject s1 uses a smart watch as their networked device 102c to communicate their stream 113-s1 to network 104.

At time t2 subject s1 is in context 2 where she is consensus B-E type with respect to proposition 107 and thus shoes 109′. Data files 112-s1 in stream 113-s1 at time t2 may thus reflect happiness, enjoyment, satisfaction and/or other positive emotions with possible mention of shoes 109′. At the same time, broadcast 111 generated by subject s1 is also in the awareness or internal space of subject s1. This situation may produce additional self-created reinforcement of state. Unfortunately, self-affirmation type messages that would corroborate such state are not very common. Still, self-referential messages of the type “I am awesome” may occasionally be sent out by subjects to network 104 or entire groups of friends and these should be kept track of by the present method to corroborate the quantum model of subject s1.

At time t3 subject s1 has undergone a change in contextualization modulo proposition 107. Now subject s1 contextualizes proposition 107 about shoes 109′ in context 3. It is possible that context 3 is incompatible with context 2 in the quantum sense (also see the teachings in co-pending application Ser. No. 14/128,821). It is also possible that in contest 3 proposition 107 becomes irrelevant. However, it is also plausible that in context 3 subject s1 exhibits anti-consensus F-D statistic modulo proposition 107. Such change may manifest in an internal struggle of subject s1 with themselves. Data files 112-s1 generated by subject s1 during time period t3 in context 3 may thus differ markedly from those emitted during time t2. For example, in time period t3 files 112-s1 may reflect emotions of regret over money spent, self-reproach and other negative emotions with possible mention of shoes 109′. Self-referential messages of the type “I am despicable”, if generated by subject s1, would again be useful for corroboration of quantum state.

Statistics module 118 is preferably equipped to handle context changes. Specifically, it is programmed to alter the assignment of joint quantum state with respect to a renewed presentation of proposition 107 to subject s1. Thus, prior to the self-interaction at time t2 module ascribes to subject s1 and s2 a symmetric wave function Φ. Later, as a result of self-interaction, at time t3 module 118 changes the predicted joint quantum state for subjects s1, s2 to be described by an anti-symmetric wave function Ψ. Its prediction will revert to symmetric wave function Φ at time t2, if this time represents a period in the life of subject s1 that recurs cyclically.

A person skilled in the art will note that quantum exchange energy monitoring by monitor 121 can also be deployed in the case of the same subject at different times. Such monitoring and estimation of quantum exchange energy may give an indication of the internally conflicting contexts assumed by subject s1 at different times with respect to proposition 107.

A person skilled in the art will also realize at this juncture, that the quantum representation and the tools provided herein are intended for practical use and exploration. The vast subject of quantum mechanics and quantum field theory has barely been outlined here. However, the spin-statistics theorem underpinning the present assignments and its implications for composite states can be systematically explored with the tools offered by the apparatus and method of invention. For example, strictly speaking, consensus B-E and anti-consensus F-D statistics should be more rigorously considered for describing agreement and disagreement with regards to states contextualized in the same manner (same basis). Further, it should be expected that fractional statistics may play a significant role in dictating emergent interaction patterns among numerous subjects. Derivation of a mapping between quantum mechanics, quantum field theory and the understanding of interactions in the human realm is thus deemed a desirable practical goal from the point of view of the present invention.

In a practical extension of the present apparatus and method, it is advantageous to prepare computer system 100 with additional quantum information to be able to better understand the surroundings within which the joint quantum states between subjects arise. It is therefore useful for network behavior monitoring unit 120 to determine a set of available quantum states for subjects in general. In other words, it is valuable to have at least an estimate of how many other states besides the joint quantum states of interest are available to transmit and receive subjects. These other states may be due to the attention of either or both subject being recruited by other items and/or issues pertinent to their lives.

Knowledge of other items and issues that the subjects may be attracted to may be available to network 104 from any online information that the subjects share and from well-founded inferences. Such other states are intrinsically permitted by the relatively large “bandwidth” of human attention. This “bandwidth” allows a person to concentrate on one or more items or issues at a time, including the proposition(s) of interest.

In specifying other available quantum states available due to this attention “bandwidth”, network behavior monitoring unit 120 preferably communicates with assignment module 116 and statistics module 118 (see FIG. 2). Correspondingly, transmit subject qubit |Tx [symbol] and receive subject qubit |Rx [symbol] associated with subjects s1, s2 of interest can be assigned to corresponding quantum states, which may be individual or joint by modules 116, 118. In the case of joint quantum states, the teachings of the present invention can be used to effectuate the proper assignment of bases and wave functions. In case of separable and individualistic states, the teachings contained in the co-pending application Ser. No. 14/128,821 may be applied to achieve this goal.

Under many circumstances, even when joint quantum states are permissible and correctly set up, no coupling between subjects will be observed. The reason for no coupling could be due to the issues already addressed in conjunction with the classical null response probability pₙᵤₗₗ. However, other effects beyond the scope of the present invention may be in play. It is therefore convenient, in addition to any adjustments to event probability γ in statistics module 118, to expressly assign a nil coupling [symbol] ₀ between the transmit and receive subjects in question. In practice, this means that nil coupling [symbol] ₀ is assigned to transmit subject qubit |Tx [symbol] and receive subject qubit |Rx [symbol] . Correspondingly, any broadcast 111 is not expected to bridge the gap between the transmitting and receiving subjects and even though they may share a common internal space, as captured by state space [symbol] ^{(TR)}, they will fail to establish any connection that can be legitimately represented by a joint quantum state.

The specific designation of nil coupling [symbol] ₀ in addition to transmit and receive relationships between different subjects can be very conveniently expressed with the tools of linear algebra. These tools are compatible with modern day methods of applied mathematics as well as the way in which computer networks operate. Over and above that, the underlying data structures (e.g., hash tables and hash lists) are also inherently compatible with matrix representation of relationships encoded in accordance with the quantum representation of the present invention.

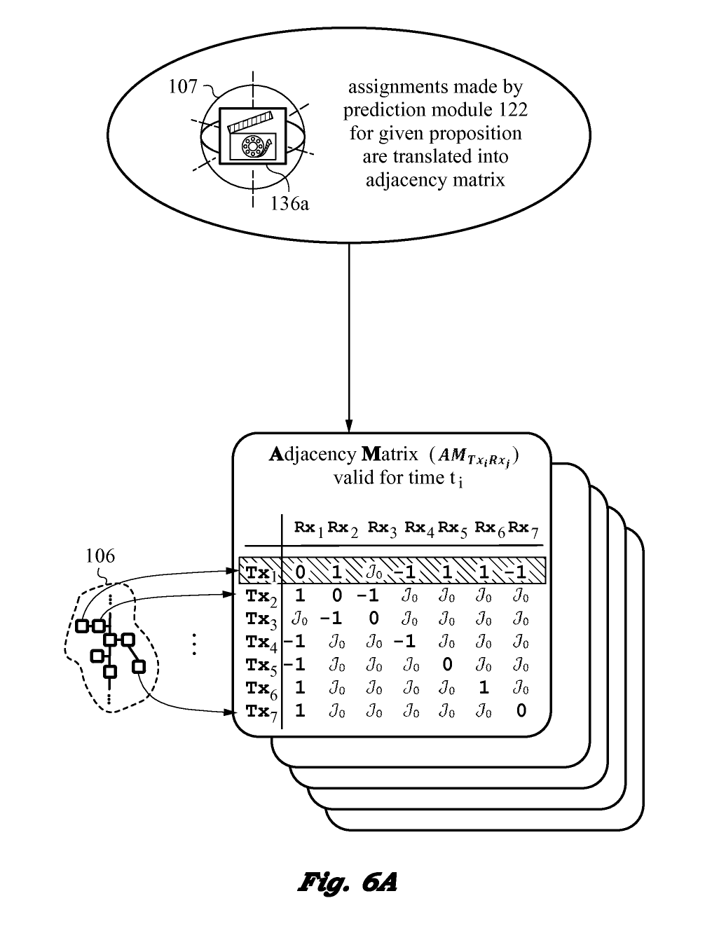

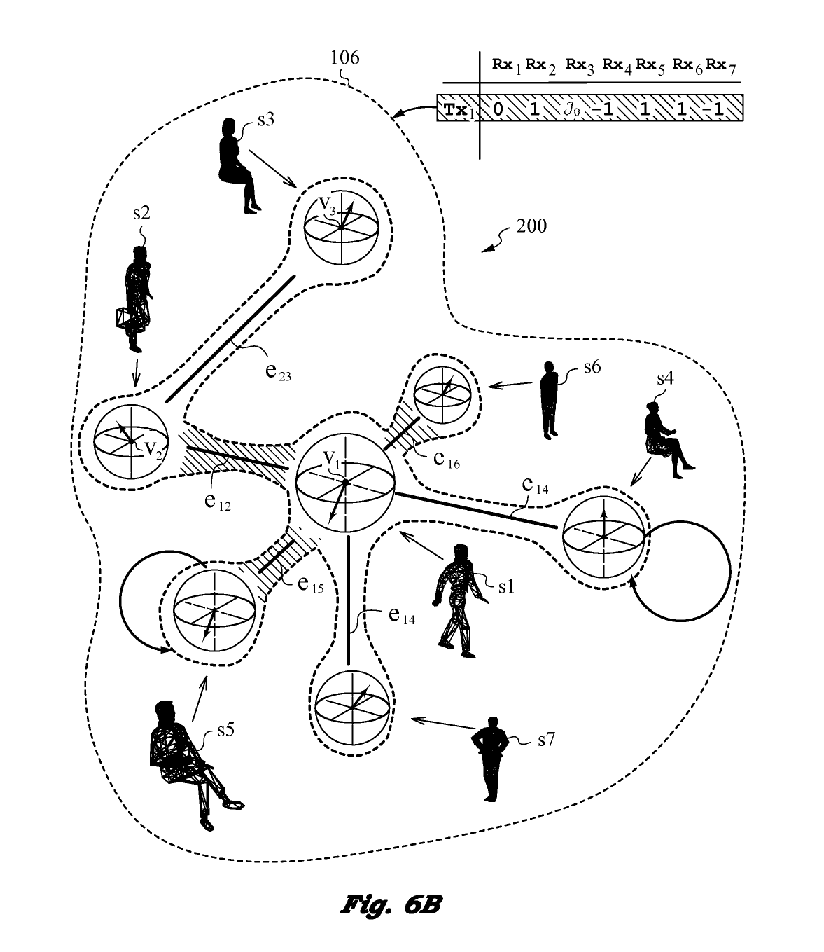

FIG. 6A illustrates a very advantageous data structure embodied by an adjacency matrix AM_{Tx}_{ᵢ}_{Rx}_{ⱼ} that accounts for seven (7) subjects belonging to social network 106 (subjects not expressly shown). In this example, underlying proposition 107 is about the experience of watching movie 136a. Movie 136a was selected for presentation by selection mechanism 138 of mapping module 115. The choice of movie 136a was based on trained knowledge of the potential common internal spaces of the seven subjects in question.

Initially, subjects are identified and assigned their respective qubits and B-E/F-D statistics by assignment and statistics modules 116, 118. Thereafter, prediction module 122 is tasked with predicting joint quantum states under consensus and anti-consensus statistics, as taught above. In this embodiment, module 122 also keeps track of nil couplings [symbol] ₀ and any self-couplings modulo proposition 107.

To simplify its work, module 122 introduces adjacency matrix AM_{Tx}_{ᵢ}_{RX}_{ⱼ} whose rows are assigned sequentially to the seven subjects from social network 106, as illustrated with the arrows in FIG. 6A. Specifically, the first row, indicated with additional cross-hatching for clarity, corresponds to subject number 1 being the transmitting subject Tx₁. The second row corresponds to subject number 2 being the transmitting subject Tx₂. The same is true for the remaining rows, with the seventh and last row encoding the situation when subject number 7 is the transmitting subject Tx₇. The first subscript in adjacency matrix AM_{Tx}_{ᵢ}_{RX}_{ⱼ}, namely Txᵢ, thus corresponds to these subjects being transmitters.

Meanwhile, each column of adjacency matrix AM_{Tx}_{ᵢ}_{RX}_{ⱼ} describes the situation of the same seven subjects acting as receivers Rxⱼ. Once again, there are seven possible receivers so the matrix has seven columns indicated by the second subscript. Because some subjects are known to exhibit self-coupling, the diagonal matrix elements are not always zero. The fourth subject negatively self-reinforces and the sixth subject positively self-reinforces. These types of self-reinforcements are encoded by positive ones (+1) for consensus B-E statistic and by negative ones (−1) for anti-consensus F-D statistic, just as in the case of inter-subject statistics. Situations of nil couplings [symbol] ₀ modulo underlying proposition 107 are also indicated.

It is important to note that adjacency matrix AM_{Tx}_{ᵢ}_{Rx}_{ⱼ} need not be symmetric. In other words, the situation is not necessarily the same among the seven subjects when the assignment of transmitter and receiver reverses. This is clearly seen in the present case for exchanging the position of subjects 1 and 5. When subject 1 is in transmit mode (see first row) the coupling with subject 5 is consensus type (1). Meanwhile, when subject 5 is the transmitter (see fifth row) the coupling with subject 1 is anti-consensus type (−1). Of course, a person skilled in the art will recognize that in the physics that underlies the model such reversal will not change coupling type among, say elementary bosons or fermions. However, in the realm of human interactions, although often the situation will also be symmetric, our matrix representation expressly makes an allowance for this difference in statistic as a function of transmitter and receiver ordering.

FIG. 6B shows a graph 200 connecting the seven subjects of social network 106 encoded in the adjacency matrix AM_{Tx}_{ᵢ}_{Rx}_{ⱼ} of FIG. 6A for the situation in which subject number 1 is the transmitter. Note that this situation corresponds to the first row of matrix AM_{Tx}_{ᵢ}_{Rx}_{ⱼ}, as indicated in this drawing for clarity of explanation. Conveniently, when dealing with an entire social group that is expected to respond to movie 136a, graph 200 should be expanded to create an adjacency matrix AM_{Tx}_{ᵢ}_{Rx}_{ⱼ} between all susceptible transmitting subject members Txᵢ and receiving subject members Rxⱼ of social network 106. As hinted at above, bidirectional communications can be included in any bidirectional representations of the graph edges between subjects s1 s2, s3, . . . , s7.

Here, transmit subject s1 is assigned to its transmit subject qubit |Tx [symbol] , which is embedded at a first vertex v₁ at the center of graph 200. The second subject's s2 receive subject qubit |Rx [symbol] is embedded at a second vertex v₂ in graph 200. The same is done for the remaining vertices (not all expressly indicated). The edges are labeled with direction out from transmitting subject s1. They are thus: e₁₂, e₂₃, e₁₄, e₁₅, . . . , e₁₇. To encode directed edges in graph 200 the adjacency matrix AM_{Tx}_{ᵢ}_{Rx}_{ⱼ} is preferably translated into its close relative, the incidence matrix. The corresponding techniques are well known to those skilled in the art.

The quantum statistic modulo underlying proposition 107, i.e., consensus B-E or anti-consensus F-D statistic, is assigned to the edges of graph 200. For example, edge e₁₂ that joins first and second vertices v₁, v₂ encodes for the consensus B-E statistic and is thus shown with hatching. The same is done for the remaining vertices and edges, as shown in the drawing. No hatching indicates anti-consensus F-D statistic. No connection exists between subjects s1 and s3 due to nil coupling [symbol] ₀. However, there is an edge e₂₃ between subject s2 and subject s3 in graph 200. This means that although transmitting subject s1 cannot “reach” subject s3 with their broadcast 111, subject s2 could reach subject s3 modulo underlying proposition 107 in a separate communication.

Graph 200 also indicates the self-coupling that exists for subjects s4 and s6. Although, strictly speaking and as indicated in the matrix the self-coupling occurs when these subjects are in the role of transmitting subject, the effect should also be accounted for, if it exists, when they are not the transmitting subjects.

The adjacency matrix AM_{Tx}_{ᵢ}_{Rx}_{ᵢ} is clearly subject to changes. First, it will change based on context of underlying proposition 107. It will also change as a function of time when proposition 107 is presented and broadcast. Therefore, matrix AM_{Tx}_{ᵢ}_{Rx}_{ⱼ} should be re-computed under change of context/framing of underlying proposition as presented to the members of social network 116 and as a function of time.

Any adjacency matrix can be presented as an adjacency list and is also sometimes referred to as a hash table. In more formal structuring of the data, any object oriented incidence list should be transitioned to an incidence matrix. Such matrix should be used for representing graph 200 between all subjects in network 116. Preferably, the supervision of the matrix representation of the interactions among the member subjects of social network 106 is delegated to network behavior monitoring unit 120. The reason for this choice is the exposure of unit 120 to all relevant activity on network 104 and within social network 106. Thus, unit 120 may keep a copy of the current version of the adjacency/incidence matrix that encodes the interactions and keep comparing it with actually observed interactions and outcomes (measurements). These results can be used for future tuning operations and adjustments to any of the assignments dictated by the quantum representation.

In another useful embodiment, the inventory store 130 introduced in FIG. 4 is further expanded to serve as a non-volatile memory for storing subject responses in the transmit subject context. For example, store 130 associates with all objects, subjects and experiences that it has stored within it the mutually exclusive responses a, b that it has observed modulo underlying propositions 107. This allows to further tune system 100 to all possible contextualization modes that could in principle be observed.

The non-volatile memory represented by store 130 can also be used for storing the coupling statistics including nil couplings observed for all subjects of interest. This would enable store 130 to present well-informed propositions targeted at specific sub-sets of subjects on network 104. Such targeting is desirable, for example, in direct marketing campaigns and other targeted advertising.

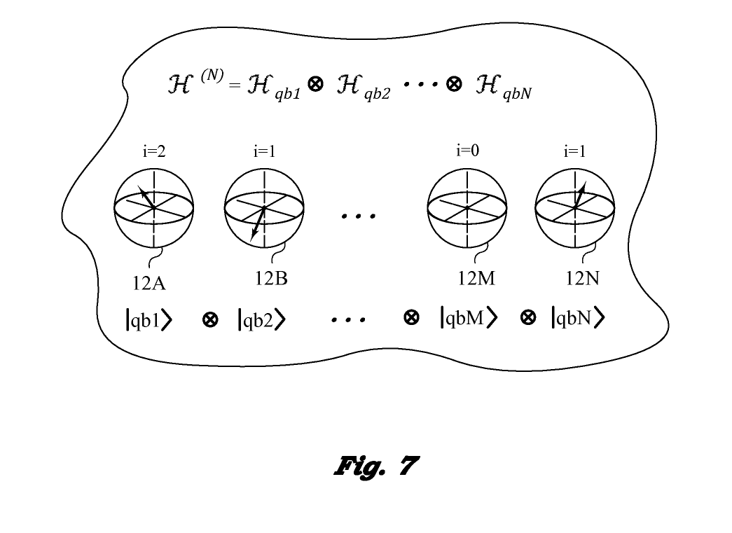

FIG. 7 is a diagram showing the application of large scale B-E statistics to crowds of subjects here already assigned to qubits 12A through 12N. In this case the common state space [symbol] ^{(N)} is a very large tensor products space. It includes not only the transmitting and receiving subjects, as in the previous embodiments, but many subjects that can transmit and receive contemporaneously.

Because the nature of statistics is B-E, qubits 12A through 12N can be multiply occupied. In other words, many subjects can develop states of mutual consensus and agree exactly on their responses to certain propositions. This fact is accounted for by index i that keeps track of the exact number of subjects whose qubits occupy the same quantum state. What is interesting to track, according to the invention, is the change in these statistics and state occupations under the introduction of subjects whose coupling statistics are anti-consensus F-D. It is recommended that empirical data from experiments conducted under progressive introduction one at a time of subjects carrying anti-consensus F-D qubits be undertaken as an additional calibration step prior to deploying computer system 100 on the scale of network 104. The results will allow the system designer to estimate when errors in assignment of statistics will have large consequences and when they will be negligible. Furthermore, this will allow to test for expected behavioral differences between individual subjects in different external situations. Thus, for example, fermionic behavior may be expected of a certain subject in private modulo certain proposition, while bosonic behavior may be expected of the same subject in a crowd modulo the same proposition. The mathematical tools for recording the results of such trials are well known to those skilled in the art.

It will be evident to a person skilled in the art that the present invention admits of various other embodiments. Therefore, its scope should be judged by the claims and their legal equivalents.

1. A computer implemented method for predicting a joint quantum state modulo an underlying proposition of a transmitting subject that broadcasts a measurable indication modulo said underlying proposition and a receiving subject capable of receiving said measurable indication, said method comprising:
a) finding by a mapping module a common internal space shared by said transmitting subject and said receiving subject;
b) assigning by an assignment module a transmit subject qubit |Tx [symbol] to said transmitting subject and a receive subject qubit |Rx [symbol] to said receiving subject, said transmit subject qubit |Tx [symbol] and said receive subject qubit |Rx [symbol] sharing a state space [symbol] ^{(TR)} associated with said common internal space;
c) assigning by a statistics module a quantum statistic modulo said underlying proposition to said transmit subject qubit |Tx [symbol] and to said receive subject qubit |Rx [symbol] , said quantum statistic comprising one of at least a consensus statistic B-E and an anti-consensus statistic F-D;
d) predicting by a prediction module said joint quantum state of said transmit subject qubit |Tx [symbol] and said receive subject qubit |Rx [symbol] in said state space [symbol] ^{(TR)} based on said quantum statistics.

2. The method of claim 1, wherein said measurable indication comprises one of at least two mutually exclusive responses with respect to said underlying proposition presented in a transmit subject context associated with a transmit subject proposition matrix PR_{Tx}.

3. The method of claim 2, further comprising representing said underlying proposition in a receive subject context associated with a receive subject proposition matrix PR_{Rx}.

4. The method of claim 3, further comprising determining by a network behavior monitoring unit a set of available quantum states for said transmit subject qubit |Tx [symbol] and said receive subject qubit |Rx [symbol] .

5. The method of claim 1, wherein said joint quantum state is a symmetric joint quantum state Φ.

6. The method of claim 1, wherein said joint quantum state is an anti-symmetric joint quantum state Ψ.

7. The method of claim 1, wherein said transmit subject qubit |Tx [symbol] and said receive subject qubit |Rx [symbol] experience a nil coupling [symbol] ₀.

8. The method of claim 1, further comprising:
a) estimating a quantum exchange energy between said transmit subject qubit |Tx [symbol] and said receive subject qubit |Rx [symbol] by a quantum exchange monitor;
b) adjusting said assignments made by said statistics module based on said quantum exchange energy.

9. The method of claim 1, further comprising:
a) embedding said transmit subject qubit |Tx [symbol] at a first vertex in a graph;
b) embedding said receive subject qubit |Rx [symbol] at a second vertex in said graph; and
c) assigning said quantum statistic modulo said underlying proposition to an edge of said graph between said first vertex and said second vertex.

10. The method of claim 9, wherein said graph represents a social network and said transmitting subject is a member of a group of transmitting subject members Txᵢ and said receive subject is a member of receiving subject members Rxⱼ of said social network.

11. The method of claim 10, wherein said quantum statistic modulo said underlying proposition further comprises a nil coupling [symbol] ₀ and said method further comprises constructing an adjacency matrix AM_{Tx}_{ᵢ}_{RX}_{ⱼ} between said transmitting subject members Txᵢ and said receiving subject members Rxⱼ of said social network.

12. The method of claim 11, wherein said adjacency matrix AM_{Tx}_{ᵢ}_{RX}_{ⱼ} is based on a context in which said underlying proposition is presented.

13. The method of claim 1, wherein said transmitting subject and said receiving subject are members of a social network and said method further comprises monitoring of interactions between a number of subject members of said social network with a network behavior monitoring unit.

14. The method of claim 13, further comprising updating said quantum statistic modulo said underlying proposition based on said monitoring step.

15. A computer system for predicting an joint quantum state modulo an underlying proposition of a transmitting subject that broadcasts a measurable indication modulo said underlying proposition and a receiving subject capable of receiving said measurable indication, said computer system comprising:
a) a mapping module for finding a common internal space shared by said transmitting subject and said receiving subject;
b) an assignment module for assigning a transmit subject qubit |Tx [symbol] to said transmitting subject and a receive subject qubit |Rx [symbol] to said receiving subject, said transmit subject qubit |Tx [symbol] and said receive subject qubit |Rx [symbol] sharing a state space [symbol] ^{(TR)} associated with said common internal space; and
c) a network behavior monitoring unit for monitoring interactions between said transmiting subject and said receiving subject, said network behavior monitoring unit being in communication with said assignment module to inform said assignment module's assignment of a quantum statistic modulo said underlying proposition to said transmit subject qubit |Tx [symbol] and to said receive subject qubit |Rx [symbol] , said quantum statistic comprising one of at least a consensus statistic B-E and an anti-consensus statistic F-D.

16. The computer system of claim 15, further comprising a prediction module for predicting said joint quantum state of said transmit subject qubit |Tx [symbol] and said receive subject qubit |Rx [symbol] in said state space [symbol] ^{(TR)} based on said quantum statistics.

17. The computer system of claim 15, wherein said assignment module is further configured to assign said measurable indication to one of at least two mutually exclusive responses a, b with respect to said underlying proposition presented in a transmit subject context associated with a transmit subject proposition matrix PR_{Tx}.

18. The computer system of claim 17, wherein said underlying proposition is associated with a subject and said computer system further comprises a non-volatile memory for storing said subject and said at least two mutually exclusive responses a, b with respect to said underlying proposition presented in said transmit subject context, and with respect to said underlying proposition presented in a receive subject context associated with a receive subject proposition matrix PR_{Rx} admitting of said at least two mutually exclusive responses a, b.

19. The computer system of claim 17, wherein said underlying proposition is associated with an object and said computer system further comprises a non-volatile memory for storing said object and said at least two mutually exclusive responses a, b with respect to said underlying proposition presented in said transmit subject context, and with respect to said underlying proposition presented in a receive subject context associated with a receive subject proposition matrix PR_{Rx} admitting of said at least two mutually exclusive responses a, b.

20. The computer system of claim 17, wherein said underlying proposition is associated with an experience and said computer system further comprises a non-volatile memory for storing said experience and said at least two mutually exclusive responses a, b with respect to said underlying proposition presented in said transmit subject context, and with respect to said underlying proposition presented in a receive subject context associated with a receive subject proposition matrix PR_{Rx} admitting of said at least two mutually exclusive responses a, b.

21. The computer system of claim 15, further comprising a quantum exchange monitor for estimating a quantum exchange energy between said transmit subject qubit |Tx [symbol] and said receive subject qubit |Rx [symbol] .

22. The computer system of claim 15, wherein said transmitting subject and said receiving subject are members of a social network comprising transmitting subject members Txᵢ and receiving subject members Rxⱼ, and said network behavior monitoring unit is further configured for monitoring interactions among said members of said social network.

23. The computer system of claim 22, further comprising a non-volatile memory for storing said coupling statistics including said consensus statistic B-E, said anti-consensus statistic F-D and a nil coupling [symbol] ₀ for said transmitting subject members Txᵢ and for said receiving subject members Rxⱼ of said social network.

24. The computer system of claim 23, further comprising a prediction module configured to construct an adjacency matrix AM_{Tx}_{ᵢ}_{Rx}_{ⱼ} between said transmitting subject members Txᵢ and said receiving subject members Rxⱼ of said social network, said adjacency matrix AM_{Tx}_{ᵢ}_{RX}_{ⱼ} being based on a context in which said underlying proposition is presented.

25. The computer system of claim 15, wherein said modules and said unit are implemented in nodes of a computer cluster.
